(19) United States
(12) Patent Application Publication
(10) Pub. No.: US 2007/0279352 A1
(43) Pub. Date: Dec. 6, 2007

(54) PLANE LIGHT SOURCE APPARATUS AND PRISM SHEET AND LIQUID CRYSTAL DISPLAY APPARATUS

(76) Inventor: Sakae Tanaka, Mito City (JP)

Correspondence Address: SCHMEISER, OLSEN & WATTS, 22 CENTURY HILL DRIVE, SUITE 302, LATHAM, NY, 12110, US

(21) Appl. No.: 11/739,196

(22) Filed: Apr. 24, 2007

(30) Foreign Application Priority Data
Jun. 6, 2006 (JP) JP 2006-193405

(51) Int. Cl. G09G 3/36; G02F 1/13357

(52) U.S. Cl. 345/87; 349/64; 349/67

(57) ABSTRACT

The present invention provides a LCD panel with an isosceles triangular cross-section having a base angle of 50 to 55 degrees, and an incident angle equal to 10 to 24 degrees. Several triangular prisms are installed downwardly on a prism sheet by using the base angle as a vertex angle for controlling the light to be travel in a parallel direction, and incident in a direction perpendicular to an oblique surface of a smaller surface of the prism. The oblique surface of a larger surface of the prism reflects the incident light completely and projects the light perpendicular to the bottom of the prism. An optical system provides a backlight for a liquid crystal display apparatus and an anisotropic diffuser installed at an orthogonal direction of a prism has a diffusion function such that the light can be diffused by the LCD panel and the two orthogonally installed polarizers.

### FIELD OF THE INVENTION

The present invention relates to a plane light source apparatus of a backlight system for a super large liquid crystal display television (LCD TV), and a prism sheet having a light diffraction function used in the plane light source apparatus, and more particularly to a method of using a row of linear light sources or a point light source to control the light emitting direction precisely and a light with a precise emitting direction for installing a light deflection component to an LCD TV panel and enhancing an incident direction with a maximum ratio.

### BACKGROUND OF THE INVENTION

Basically, a plane light source apparatus used in a backlight system of a liquid crystal display apparatus can be divided into two types: a straight-below type plane light source apparatus that installs a light source directly below an LCD panel and a lateral edge-light type plane light source apparatus that installs a light source at a lateral side of an LCD panel and adopts a light guide plate. The efficiency of using a lateral edge-light type plane light source apparatus to provide a light source is very high, and thus liquid crystal display apparatuses capable of reducing power consumption drastically over other display apparatuses becomes popular. However, the weight of the light guide plate must be taken into consideration, since super large LCD TVs generally adopt a display apparatus with a lateral edge-light type plane light source, and thus the straight-below type light source apparatus becomes a mainstream product of the market.

The liquid crystal display apparatus of a mobile phone or a notebook computer does not use the straight-below type plane light source at all for the purposes of low power consumption and thin thickness, but uses the lateral edge-light type plane light source instead. Basically, the lateral edge-light type plane light source. can be divided into the following two types: a light source whose light is reflected from a light guide plate and converted into a directionless diffused light, and a prism sheet installed upwardly with a vertex angle of 90 degrees condenses the diffused light again, and reflects the light in a direction perpendicular to an LCD panel; and a light source whose directional diffused light is reflected from a light guide plate, and a prism sheet installed upwardly with a vertex angle of 67 degrees, and an oblique surface of the prism sheet reflects the light completely, and changes the direction of the directional diffused light, and adjusts the reflection in a direction perpendicular to the LCD panel based on the extent of diffusion of a diffuser.
[Patent Literature 1] Japan Laid Open Patent No. 2-84618
[Patent Literature 2] Japan Laid Open Patent No. 8-262441
[Patent Literature 3] Japan Laid Open Patent No. 6-18879
[Patent Literature 4] Japan Laid Open Patent No. 8-304631
[Patent Literature 5] Japan Laid Open Patent No. 9-160024
[Patent Literature 6] Japan Laid Open Patent No. 10-254371
[Patent Literature 7] Japan Laid Open Patent No. 11-329030
[Patent Literature 8] Japan Patent No. 2001-166116
[Patent Literature 9] Japan Patent No. 2003-302508
[Patent Literature 10] Japan Patent No. 2004-46076
[Patent Literature 11] Japan Patent No. 2004-233938
[Patent Literature 12] Japan Patent No. 2005-49857
[Patent Literature 13] Japan Patent No. 2006-106592

### SUMMARY OF THE INVENTION

In view of the shortcomings of the prior art, the inventor of the present invention based on years of experience in the related industry to conduct researches and experiments, and finally developed a plane light source apparatus, a prism sheet and a liquid crystal display apparatus in accordance with the present invention to overcome the foregoing shortcomings.

To maintain a uniform light intensity of a light source, the straight-below type light source apparatus has to use a diffuser with a high diffusion effect, and thus it cannot improve the efficiency of using the light emitted from a light source. To improve the efficiency as shown in FIG. 1, an upward prism sheet with a vertex angle of 90 degrees is used, so that the diffuser can condense the diffused light completely. Therefore, a method of superimposing an area of the lowest brightness with an area of the highest brightness is adopted to make the diffused light even. Theoretically, the straight-below type light source apparatus changes the light coming from a light source into a diffused light, and an optical system using a prism sheet for condensing the light cannot achieve the low power consumption effect.

In a lateral edge-light type light source apparatus as shown in FIG. 2, a light guide plate is used, so that if an LCD TV display apparatus increases the size of its panel but not the thickness of its light guide plate, then an even brightness of the whole screen cannot be maintained. When the size of the panel is increased, the weight of the light guide plate becomes very heavy and loses the advantage of a light-weighted the liquid crystal display apparatus. Since the light source can be built at the four edges of the panel, therefore the larger the panel, the drastically larger is the quantity of light coming from the light source. If the aforementioned cold cathode fluorescent lamp (CCFL) is within 30 inches, such method can give a very limited effect. If a downward prism sheet with better light efficiency is used and its light source is built on the two long sides of the panel only, then the brightness cannot be improved as well as the straight-below type light source apparatus.

To provide a field order driven large LCD TV display apparatus, the lateral edge-light type light source apparatus divides the screen into blocks, but it is difficult to control the light emitting area precisely. Therefore, all order field driven backlight systems adopt the straight-below type light source apparatus to develop large panels. If the straight-below type plane light source apparatus uses the point light source of the LED for the manufacture, the optical system as shown in FIG. 1 will require many LEDs that will increase the power consumption and will not be able to lower the installation cost.

Therefore, it is a primary objective of the present invention employs a downward prism sheet as shown in FIG. 2 to use the light emitted from a linear light source or a point light source effectively to produce a plane light source for a large LCD TV, and achieve the effects of lowering the power consumption, reducing the thickness, and providing a field order driving function.

To achieve the foregoing objective of the invention and overcome the shortcomings of the prior art, the measures taken by the present invention are described as follows:

Measure 1 uses an optical system that installs a plurality of optical units, comprising: a linear light source or a row of point light sources, and a plurality of semi-cylindrical lenses corresponding to an optical axis (or z-axis), for controlling the divergent angle of a strip light produced in the direction of an optical axis (Z-axis) within a range from 2 degrees to 8 degrees range, and arranging the refection direction of a plurality of strip lights in a same direction, and a prism sheet installed parallelly on an LCD panel and comprised of a plurality of rows of prisms having a light deflection function, such that a strip light with an incident angle of ranging from 10 degrees to 24 degrees measured from a plane of the LCD panel is incident, and the incident strip light is reflected completely by an oblique plane of a prism of the prism sheet, and substantially in a direction perpendicular to a plane of the LCD panel.

Measure 2 uses an optical system that reflects lights coming from a curved reflective condensing lens in the same direction and installs a plurality of optical units, comprising: a linear light source or a row of point light sources, one or more semi-cylindrical lens of the same optical axis (or z-axis), and a curved reflective condensing lens of an optical axis error for producing a strip light capable of restricting the divergent angle within a range from 2 degrees to 8 degrees for the control, such that a strip light with an incident angle of ranging from 10 degrees to 24 degrees measured from a plane of the LCD panel can be incident by a prism sheet comprised of a plurality of rows of prisms and installed parallelly at an LCD panel and having a light deflection function, and the strip light is reflected substantially in a direction perpendicular to a plane of the LCD panel.

Measure 3 uses an optical system that reflects lights in opposite directions alternately, and installs a plurality of optical units in opposite sides, comprising: a linear light source or a row of point light sources, and a plurality of semi-cylindrical lenses of the same optical axis (or z-axis), for producing a strip light capable of restricting the divergent angle of a light in the direction of an optical axis (z-axis) within a range from 2 degrees to 8 degrees, such that a strip light at an end with an incident angle ranging from +10 degrees to +24 degrees measured from a plane of the LCD panel and a strip light at another end with an incident angle ranging from −10 degrees to −24 degrees can be incident, and the strip light can be reflected completely by the oblique planes of the prisms at both ends of the prism sheet, and the strip light is reflected substantially in a direction perpendicular to a plane of the LCD panel.

Measure 4 uses an optical system that reflects lights in opposite directions alternately, and installs a plurality of optical units in opposite sides, comprising: a linear light source or a row of point light sources, one or more semi-cylindrical lens of the same optical axis (or z-axis), and a curved reflective condensing lens of an optical axis error, for producing a strip light capable of restricting the divergent angle within a range from 2 degrees to 8 degrees, such that a strip light at an end with an incident angle ranging from +10 degrees to +24 degrees measured from a plane of the LCD panel and a strip light at another end with an incident angle ranging from −10 degrees to −24 degrees can be incident separately, and the strip lights in opposite directions can be reflected completely by the oblique planes of the prisms at both ends of the prism sheet, and the strip light is reflected substantially in a direction perpendicular to a plane of the LCD panel.

Measure 5 uses an optical system that installs a plurality of optical units alternately, comprising: two opposite linear light sources or two opposite rows of point light sources, two semi-cylindrical lenses correspond to each light source respectively and one cylindrical lens, for producing two strip lights intersected at a cylindrical lens area that can control the divergent angle of a light in the direction of an optical axis (or z-axis) of the semi-cylindrical lens to pass through the cylindrical lens, and restrict the divergent angle within a range from 2 degrees to 8 degrees range, such that a strip light at an end with an incident angle ranging from +10 degrees to +24 degrees measured from a plane of the LCD panel and a strip light at another end with an incident angle ranging from −10 degrees to −24 degrees can be incident separately, and the strip lights in opposite directions can be reflected completely by the oblique planes of the prisms at both ends of the prism sheet, and the strip light is reflected substantially in a direction perpendicular to a plane of the LCD panel.

Measure 6 uses an optical system similar to those of Measures 1, 2, 3, 4 or 5, wherein a linear light source or a row of point light sources is comprised of an LED or EL that emits white light or three primary colors (R, G, B) lights, and a light emitting portion is in a strip-like shape, and a direction perpendicular to the optical axis (or z-axis) of a semi-cylindrical lens is parallel to lengthwise direction (or x-axis) of the semi-cylindrical lens.

Measure 7 installs a row of point light sources (LED) as used in Measure 6 for emitting white light or three primary color (R, G, B) lights and having a light emitting portion with an aspect ratio of over 1:3 in a direction parallel to the lengthwise direction (or x-axis) of the semi-cylindrical lens.

Measure 8 uses an optical system of Measure 1, 2, 3, 4 or 5, wherein an anisotropic diffusion function is implemented at a plane of a semi-cylindrical lens where a light of a linear light source or a row of point light sources is incident for diffusing the light along the lengthwise direction (or x-axis) of the semi-cylindrical lens only.

Measure 9 uses an optical system of Measure 2, wherein a curved reflective condensing lens is integrated with a cooling device for cooling a light source of a linear light source or a row of point light sources.

Measure 10 uses an optical system of Measure 2, wherein a curved reflective condensing lens, a cooling device for cooling a light source of a linear light source or a row of point light sources and a semi-cylindrical lens for producing a strip light are integrated with each other.

Measure 11 uses an optical system of Measures 1 or 3, wherein a plurality of semi-cylindrical lenses is integrated with a cooling device for cooling a light source of a linear light source or a row of point light sources, and a lateral side of a semi-cylindrical lens keeper used for providing a same optical axis (or z-axis) for a plurality of semi-cylindrical lenses is connected to a frame of a backlight to determine the central axis (or z-axis) of a strip light reflected from the semi-cylindrical lenses and the incident angle of a prism sheet.

Measure 12 uses an optical system of Measures 1, 2, 3, 4 or 5, wherein a row of prisms is formed on a lateral surface of a light source of a prism sheet comprised of a plurality of rows of prisms and having a light deflection function, and a prism with a vertex angle Θ falling within a range from 60 degrees to 70 degrees is used, and the vertex angle of an isosceles triangular prism is divided into two divided angles Θa, Θb, such that |Θa−Θb|=0 degree.

Measure 13 uses an optical system of Measure 1 or 2, wherein a prism sheet comprised of a plurality of rows of prisms and having a light deflection function forms a row of prisms on a lateral surface of a light source, and the vertex angle Θ of the prisms falls within a range from 50 degrees to 55 degrees, and the vertex angle of the isosceles triangular prism is divided into two divided angles Θa, Θb, such that the absolute value of the divided angles falls within a range from 15 degrees to 30 degrees.

Measure 14 uses an optical system of Measures 1, 2, 3, 4 or 5, wherein a prism sheet comprised of a plurality of rows of prisms and having a light deflection function forms a row of prisms on a lateral surface of a light source, and alternately installs an isosceles triangular prism with a vertex angle Θ ranging from 60 degrees to 70 degrees, and the vertex angle is divided into two divided angles Θa, Θb such that |Θa−Θb|=0 degree, and an isosceles triangular prism with a vertex angle Θ ranging from 90 degrees to 110 degrees, and the vertex of the vertex angle Θ ranging from 90 degrees to 110 degrees of the isosceles triangular prism is lower than the vertex of the vertex angle Θ ranging 60 degrees to 70 degrees of isosceles triangular prism of a prism sheet.

Measure 15 uses an optical system of Measure 1 or 2, wherein a prism sheet comprised of a plurality of different rows of prisms and having a light deflection function forms a row of prisms on a lateral surface of a light source, and alternately installs an isosceles triangular prism with a vertex angle Θ ranging from 50 degrees to 55 degrees, and the vertex angle is divided into two divided angles Θa, Θb such that |Θa−Θb|=0 degree, and an isosceles triangular prism with a vertex angle Θ ranging from 90 degrees to 110 degrees, and the vertex of the vertex angle Θ ranging from 90 degrees to 110 degrees of the isosceles triangular prism is lower than the vertex of the vertex angle Θ ranging 50 degrees to 55 degrees of isosceles triangular prism of a prism sheet.

Measure 16 uses an optical system of Measures 1, 2, 3, 4 or 5, wherein a prism sheet comprised of a plurality of different rows of prisms and having a light deflection function forms a row of prisms on a lateral surface of a light source, and adds an anisotropic diffusion function to the backside of the LCD panel for diffusing lights along an orthogonal direction extended from a prism of the row of prisms.

Measure 17 uses an optical system of Measures 1, 2, 3, 4 or 5, wherein a linear light source or a row of point light sources is arranged in the same direction and parallel to the lengthwise direction of a scan line (or a gate electrode) of an LCD panel.

Measure 18 uses an optical system of Measures 1, 2, 3, 4 or 5, wherein a linear light source or a row of point light sources is arranged parallelly in the same direction of the lengthwise direction of a scan line (or a gate electrode) of an LCD panel, and a prism sheet comprised of a plurality of rows of prisms and having a light deflection function is also arranged substantially in the same direction of the lengthwise direction of a scan line (or a gate electrode) of an LCD panel, such that the vertex of the vertex angle of the prism can be extended.

Measure 19 uses an optical system of Measures 1, 2, 3, 4 or 5, wherein a linear light source or a row of point light sources is arranged parallelly in the same direction of an absorption axis or a transmission axis of a polarizer of an LCD panel.

Measure 20 uses an optical system of Measures 1, 2, 3, 4 or 5, wherein a linear light source or a row of point light sources is arranged parallelly in the same direction of an absorption axis or a transmission axis of a polarizer of an LCD panel, and a prism sheet comprised of a plurality of rows of prisms and having a light deflection function is also arranged parallelly in the same direction of an x-axis direction of the linear light source or row of point light sources, such that the vertex of the vertex angle of the prism can be extended.

Measure 21 uses an optical system of Measures 1, 2, 3, 4 or 5, wherein a linear light source or a row of point light sources is arranged parallelly in the same direction of a transmission axis or a reflection axis of a polarization conversion and separation plate.

Measure 22 uses an optical system of Measures 1, 2, 3, 4 or 5 that installs a linear light source or a row of point light sources parallelly in the same direction of a transmission axis or a reflection axis of a polarization conversion and separation plate, and a prism sheet comprised of a plurality of rows of prisms and having a light deflection function is also arranged parallelly in the same direction of an x-axis direction of the linear light source or row of point light sources, such that the vertex of the vertex angle of the prism can be extended.

Measure 23 uses an optical system of Measures 1, 2, 3, 4 or 5, installed at a protective plate of a polarizer on the surface of an LCD panel for forming a light in an intersecting direction with an anisotropic diffused surface, such that the vertex of an vertex angle of a prism of a plurality of rows of prisms having a light deflection function can be extended.

Measure 24 uses an optical system of Measures 1, 2, 3, 4 or 5, wherein a method for scrolling, partially lighting up and driving method is used for turning on a scan line (or a gate electrode) of an LCD panel, such that light can be emitted from a backlight area at the position of the scan line after new data is written in a pixel and a liquid crystal response delay time is passed counting from the time when the scan line is off, and reflected from a corresponding position of the scan line, and a basic unit is a unit of the light emitting optical system that partially lights up a linear light source or a row of point light sources, and turns on the scan line (or gate electrode) at the same position. After new data is written into a pixel of the LCD panel, and the scan line is off, and a liquid crystal response delay time is passed counting from the time when the linear light source or the row of point light sources of a backlight at the position of the scan line, light is emitted from a backlight area at the position of the corresponding scan line, and a basic unit is a unit of the light emitting optical system that partially lights up the linear light source or the row of point light sources.

Measure 25 uses an optical system of Measures 1, 2, 3, 4 or 5, wherein a driving method for scrolling and partially lighting up the light sources firstly selects a color from the three primary colors (R, G, B) of the light of a linear light source or a row of point light sources, such that after the scan line (or gate electrode) of the LCD panel is turned on, and new data is written into a pixel of the LCD panel, and a liquid crystal response delay time is passed counting from the time when the scan line is off, the light of the selected color is emitted from a backlight area at a position corresponding to the scan line, and a basic unit is a unit of the light emitting optical system that partially selects and lights up the three primary color (R, G, B) linear light source or row of point light sources, such that after the scan line (or gate electrode) at the same position is turned on, and new data is written into a pixel of the LCD panel, and the scan line is turned off, the light of the selected color is emitted continuously from the backlight area at a position corresponding to the scan line position, and a basic unit is a unit of the light emitting optical system that partially selects to turn off the three primary color (R, G, B) linear light source or row of point light sources. Secondly, after the scan line is turned off, and a liquid crystal response delay time is passed, a color other than the previously selected on is selected from the three primary color (R, G, B) linear light source or row of point light sources at a position corresponding to the scan line, and the light of the selected color is emitted from a backlight area at a position corresponding to the scan line, and a basic unit is a unit of the light emitting optical system that partially selects and lights up the three primary color (R, G, B) linear light source or row of point light sources. Therefore, different colors of the three primary colors (R, G, B) are emitted sequentially by repeating the foregoing procedure.

With a light emitting portion of a backlight light source formed by a linear light source of a row of point light sources, the light traveling direction can be controlled precisely at an optical axis (or z-axis) of the semi-cylindrical lens to improve the efficiency of light significantly, so as to achieve the effect of low power consumption. With optical components having an anisotropic diffusion function, the density of a light source can be maintained constant to achieve an even brightness, and thus the present invention can reduce lots of point light sources compared with the straight-below type light source apparatus. As a result, the present invention can overcome the long-needed problem and lower the installation cost of the backlight of an LED.

Since the present invention does not use a light guide plate, but it uses a semi-cylindrical lens and a curved reflective condensing lens instead, therefore an increase of weight of the backlight of a large liquid crystal display apparatus will not cause a serious problem. Since the semi-cylindrical lens is substituted by the semi-cylindrical Fresnel lens, the weight can be reduced greatly. Further, the incident angle of a light deflection of a prism sheet approaches 10 degrees and is incident with a slight inclination, and thus the overall thickness can be reduced by 30 mm, even for the straight-below type LED backlight.

The present invention adopts two different types of prism arranged alternately, and a downward composite prism sheet, for reflecting a light from a polarization separating optical component and then reflecting the light at the polarization separating optical component to improve the efficiency of the light and lowering the low power consumption.

In the backlight system of the optical system applied in the present invention, the diffused light is emitted from the direction of a polarization axis of a polarizer that intersects with the direction of the LCD panel. Compared with the foregoing diffused backlight, the light diffusion along the direction of ±45 degrees of the polarization axis can be reduced, such that when an IPS or a FFS horizontal field LCD panel uses a backlight of the present invention, it is not necessary to use the expensive optical compensation film to lower the cost significantly and enhance the contrast.

### BRIEF DESCRIPTION OF THE DRAWINGS

FIG. 1 shows an upward backlight system with a vertex angle substantially equal to 90 degrees for condensing a diffused light completely;

FIG. 2 shows an optical system installing a downward triangular prism with a vertex angle substantially equal to 63 degrees for changing the direction of a directional diffused light;

FIG. 3 shows an optical path length of a linear light being incident perpendicular to an oblique surface of an isosceles triangular prism having a vertex angle of 45 degrees in accordance with the present invention;

FIG. 4 shows an optical path length of a linear light being incident perpendicular to an oblique surface of an isosceles triangular prism having a vertex angle of 45 to 60 degrees in accordance with the present invention;

FIG. 5 shows an optical path length of a linear light being incident perpendicular to an oblique surface of a right triangular prism having a vertex angle of 60 degrees in accordance with the present invention;

FIG. 6 shows an optical path length of a linear light being incident perpendicular to an oblique surface of an isosceles triangular prism having a vertex angle of 50 to 55 degrees in accordance with the present invention;

FIG. 7 shows an optical path length of a linear light being incident perpendicular to an oblique surface of a tetrahedral prism having a vertex angle of 50 to 55 degrees in accordance with the present invention;

FIG. 8 shows an optical path length of a linear light being incident perpendicular to an oblique surface of a tetrahedral prism having a vertex angle of 50 to 55 degrees in accordance with the present invention;

FIG. 9 shows an optical path length of a linear light being incident perpendicular to an oblique surface of a pentagonal prism having a vertex angle of 50 to 55 degrees in accordance with the present invention;

FIG. 10 shows a composite prism sheet having an isosceles triangular prism with a vertex angle of 50 to 55 degrees and an isosceles triangular prism with a vertex angle of 90 degrees in accordance with the present invention;

FIG. 11 shows a composite prism sheet having an isosceles triangular prism with a vertex angle of 50 to 55 degrees and an isosceles triangular prism with a vertex angle of 90 degrees in accordance with the present invention;

FIG. 12 is a cross-sectional view of a backlight system installed in a structure of a liquid crystal display apparatus in accordance with the present invention;

FIG. 13 is a cross-sectional view of a light source optical system that combines a semi-cylindrical lens and a semi-cylindrical Fresnel lens in accordance with the present invention;

FIG. 14 a cross-sectional view of a light source optical system that combines a semi-cylindrical lens and a semi-cylindrical Fresnel lens and a prism sheet with a vertex angle of 58 to 62 degrees in accordance with the present invention;

FIG. 15 is a cross-sectional view of a light source optical system that combines two types of semi-cylindrical lenses and the vertex angle of a prism sheet equals to 58 to 62 degrees in accordance with the present invention;

FIG. 16 is a cross-sectional view of a light source optical system that combines a semi-cylindrical lens and a semi-cylindrical reflective lens, and the vertex angle of a prism sheet equals to 50 to 55 degrees in accordance with the present invention;

FIG. 17 is a cross-sectional view of a light source optical system that combines a semi-cylindrical lens and a reflective lens, and the vertex angle of a prism sheet equals to 58 to 62 degrees in accordance with the present invention;

FIG. 18 is a cross-sectional view of a light source optical system that combines an anisotropic diffuser and a semi-cylindrical Fresnel lens in accordance with the present invention;

FIG. 19 is a cross-sectional view of a light source optical system that combines an anisotropic diffuser and a semi-cylindrical Fresnel lens in accordance with the present invention;

FIG. 20 is a cross-sectional view of a light source optical system that combines a semi-cylindrical lens, an anisotropic diffuser and a semi-cylindrical Fresnel lens in accordance with the present invention;

FIG. 21 is a cross-sectional view of a light source optical system that combines a semi-cylindrical lens, an anisotropic diffuser and a semi-cylindrical Fresnel lens in accordance with the present invention;

FIG. 22 is a cross-sectional view of a light source optical system that combines a semi-cylindrical lens, an anisotropic diffuser and a semi-cylindrical Fresnel lens in accordance with the present invention;

FIG. 23 is a cross-sectional view of a light source optical system that combines a semi-cylindrical lens, an anisotropic diffuser and a semi-cylindrical Fresnel lens and a prism sheet in accordance with the present invention;

FIG. 24 is a cross-sectional view of a light source optical system that combines an anisotropic diffuser, a semi-cylindrical lens, and a semi-cylindrical reflective Lens and a prism sheet in accordance with the present invention;

FIG. 25 is a cross-sectional view of a light source optical system that combines a row of point light sources of LED and a semi-cylindrical lens in accordance with the present invention;

FIG. 26 is a cross-sectional view of a light source optical system that combines a row of point light sources of LED and a semi-cylindrical lens having anisotropic diffusion function in accordance with the present invention;

FIG. 27 shows an orientation of a light in the directions of x-axis and y-axis when a semi-cylindrical lens of an optical system and an LED point light source are combined in accordance with the present invention;

FIG. 28 shows a composite prism sheet comprised of a right triangular prism and an isosceles triangular prism with a vertex angle of 50 to 55 degrees in accordance with the present invention;

FIG. 29 shows a composite prism sheet comprised of two different types of isosceles triangular prisms with a vertex angle of 50 to 55 degrees in accordance with the present invention;

FIG. 30 is a cross-sectional view of a light source optical system that combines a semi-cylindrical lens with an anisotropic diffused surface and a semi-cylindrical lens and a prism sheet in accordance with the present invention;

FIG. 31 is a cross-sectional view of a light source optical unit that combines a row of point light sources (LED) and two different types of semi-cylindrical lens in accordance with the present invention;

FIG. 32 shows a polarizer with an anisotropic diffused surface formed on a protective layer of the polarizer by using a UV curing transparent resin;

FIG. 33 shows a model of an anisotropic diffused surface formed on a protective layer of a polarizer by applying a casting method on a mask;

FIG. 34 shows a backlight system that can be scrolled, lighted up and driven by a light source optical system in accordance with the present invention;

FIG. 35 is a cross-sectional view of a structure of a liquid crystal display apparatus installed by a backlight system in accordance with the present invention;

FIG. 36 shows a polarized reflective light reflected from a triangular prism with a vertex angle of 90 degrees and a DBEF;

FIG. 37 shows a composite prism sheet comprised of an isosceles triangular prism with a vertex angle of 50 to 55 degrees and a tetrahedral prism with a vertex angle of 50 to 55 degrees in accordance with the present invention;

FIG. 38 shows an LED cooling device that integrates a row of point light sources (LED), a semi-cylindrical lens and a reflective lens in accordance with the present invention;

FIG. 39 is a cross-sectional view of a light source optical system that combines a semi-cylindrical lens and a semi-transparent lens and a prism sheet with a vertex angle of 50 to 55 degrees in accordance with the present invention;

FIG. 40 shows an optical path length of a linear light incident perpendicular to an oblique surface of an isosceles triangular prism with a vertex angle of 50 to 55 degrees in accordance with the present invention;

FIG. 41 shows an optical path length of a linear light incident with an angle of 12 degrees at the bottom of an isosceles triangular prism with a vertex angle of 70 degrees in accordance with the present invention;

FIG. 42 shows an optical path length of a liner light incident with an angle of 19 degrees at the bottom of an isosceles triangular prism with a vertex angle of 66 degrees in accordance with the present invention;

FIG. 43 shows an optical path length of a liner light incident with an angle of 16 degrees at the bottom of an isosceles triangular prism with a vertex angle of 68 degrees in accordance with the present invention;

FIG. 44 shows a composite prism sheet comprised of an isosceles triangular prism with a vertex angle of 70 degrees and an isosceles triangular prism with a vertex angle of 90 degrees in accordance with the present invention;

FIG. 45 shows a composite prism sheet comprised of an isosceles triangular prism with a vertex angle of 68 degrees and an isosceles triangular prism with a vertex angle of 90 degrees in accordance with the present invention;

FIG. 46 shows a composite prism sheet comprised of an isosceles triangular prism with a vertex angle of 66 degrees and an isosceles triangular prism with a vertex angle of 90 degrees in accordance with the present invention;

FIG. 47 shows a row of white color point light sources in accordance with the present invention;

FIG. 48 shows a row of three-color (R, G, B) point light sources in accordance with the present invention;

FIG. 49 shows a row of three-color (R, G, B) point light sources in accordance with the present invention;

FIG. 50 shows a row of mixed point light sources that mixes a white color (R, G, B) point light source and a three-color (R, G, B) point light source in accordance with the present invention;

FIG. 51 shows a composite prism sheet comprised of an isosceles triangular prism with a vertex angle of 70 degrees and an isosceles triangular prism with a vertex angle of 108 degrees in accordance with the present invention;

FIG. 52 shows a white color linear light source in accordance with the present invention;

FIG. 53 shows a row of three-color (R, G, B) linear light sources in accordance with the present invention;

FIG. 54 shows an LED chip having a light emitting portion with an aspect ratio of 1:3 and arranging a row of white color LED linear light sources in accordance with the present invention;

FIG. 55 shows the light emitting characteristics of a completely diffused backlight;

FIG. 56 shows an orientation of implementing an anisotropic diffusion function at a backside of a prism sheet having a downward light deflection function in accordance with the present invention;

FIG. 57 shows an orientation of implementing a weak diffusion function to a polarizer at a surface of an LCD panel by using an anisotropic diffused backlight in accordance with the present invention;

FIG. 58 shows an LED cooling device that integrates a row of point light sources (LED), a semi-cylindrical lens keeper and a curved reflective lens together in accordance with the present invention;

FIG. 59 shows an orientation of a backlight that uses a prism sheet having a downward light deflection function in accordance with the present invention;

FIG. 60 is a cross-sectional view of adding an anisotropic diffusion function implemented at the backside of a prism sheet comprised of a plurality of downward isosceles triangular prisms with a vertex angle of 68 degrees in accordance with the present invention;

FIG. 61 is a cross-sectional view of adding anisotropic diffusion function implemented at the backside of a downward composite prism sheet in accordance with the present invention;

FIG. 62 is a cross-sectional view of adding anisotropic diffusion function implemented at the backside of a prism sheet comprised of seven downward isosceles triangular prisms with a vertex angle of 53 degrees in accordance with the present invention;

FIG. 63 is a cross-sectional view of an anisotropic diffusion function implemented at the backside of a downward composite prism sheet in accordance with the present invention;

FIG. 64 shows an optical path length of a linear light incident at an oblique surface of a pentagonal prism with a vertex angle of 53 degrees in accordance with the present invention;

FIG. 65 shows a method of driving two different scan lines alternately in a ½H period within a horizontal scan period and writing the data of each color in two pixels;

FIG. 66 shows a method of driving two different scan lines alternately in a ⅓H period within a horizontal scan period and writing the data of each color in three pixels;

FIG. 67 shows a driving method of dividing a screen into upper and lower screens, and writing data from the center of the screen to the upper or lower screen;

FIG. 68 shows a driving method of dividing a screen into upper and lower screens, and writing data from the center of the screen to the upper or lower screen;

FIG. 69 shows a driving method of dividing a screen into upper and lower screens, and writing data from the upper or lower screen to the center of the screen;

FIG. 70 shows a driving method of dividing a screen into upper and lower screens, and writing data from the center of the screen to the upper or lower screen;

FIG. 71 shows a prism sheet comprised of a plurality of pentagonal prisms with a vertex angle of 68 degrees in accordance with the present invention;

FIG. 72 shows a display apparatus that installs a Fresnel lens at the front end of the display apparatus for condensing aligned diffused lights at the central position of the display apparatus;

FIG. 73 is a cross-sectional view of a position proximate to the center of a backlight optical system used for an LCD TV in accordance with the present invention;

FIG. 74 is a cross-sectional view of a position proximate to the center of a backlight optical system used for an LCD TV in accordance with the present invention;

FIG. 75 is a diagram of a driving method for dividing a screen into upper and lower screens and writing data from the upper or lower screen to the center of the screen center; and

FIG. 76 is a diagram of a driving method for dividing a screen into upper and lower screens and writing data from the upper screen to the lower screen.

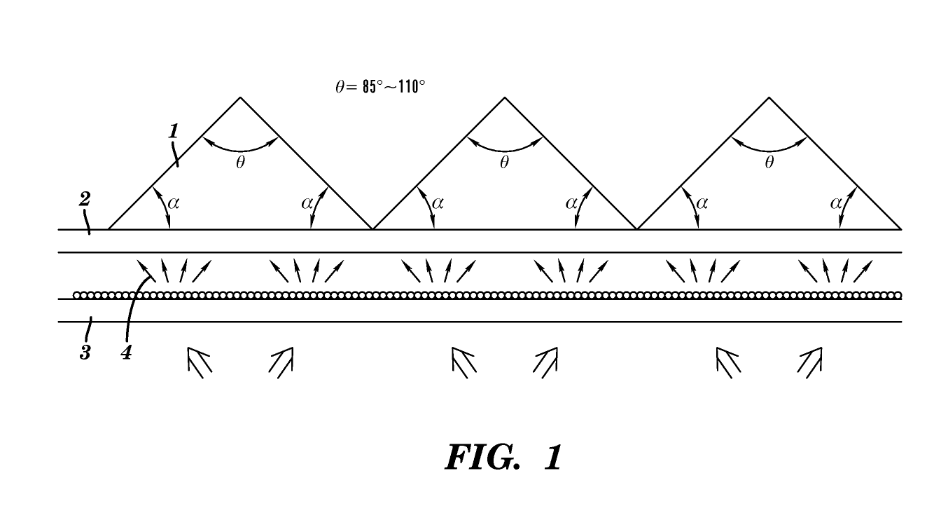

### DETAILED DESCRIPTION OF THE PREFERRED EMBODIMENTS

To make it easier for our examiner to understand the objective, innovative features and performance of the present invention, we use preferred embodiments and the accompanying drawings for a detailed description of the present invention.

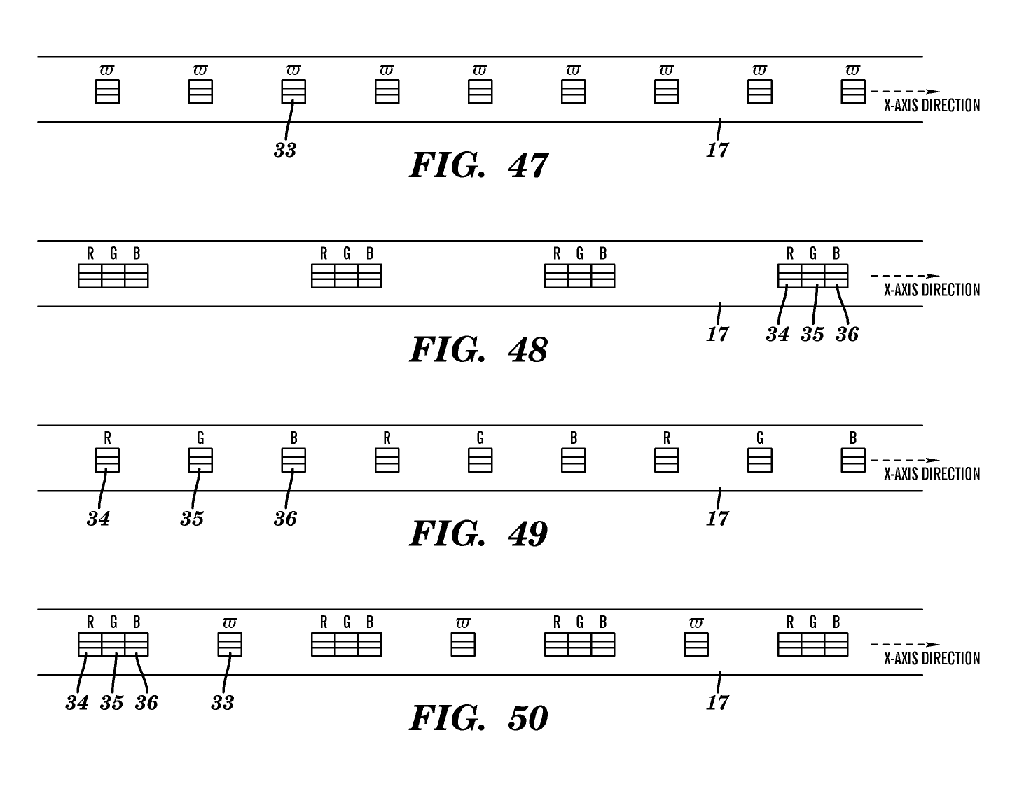

Referring to FIGS. 47 to 50 and 52 to 54 for a planar view of a linear light source or a row of point light sources in accordance with Embodiment 1 of the present invention, all types of light sources are arranged into a row at the x-axis direction of a light emitting portion for emitting a strip light precisely. The smaller the light emitting portion, the more accurate is the emitting angle. Therefore, the shape of the emitting portion is different from the light emitting portion of the foregoing LED chip. For white color LEDs, the required quantity of rectangular chips as shown in FIG. 54 can be less than the quantity of square chips as shown in FIG. 47, and thus the installation cost can be lowered. Since the precision of installing a rectangular chip at a cooling substrate can be improved, therefore it is preferably to use the rectangular chip for the LED in the present invention.

The field order driving method adopted by a linear light source or row of point light sources as shown in FIGS. 48, 49 and 53 is characterized in that: the light emitting portions of the three primary color (R, G, B) LEDs are installed in a row along the direction of the x-axis direction. Since the optical system of the present invention uses a semi-cylindrical lens or a semi-cylindrical Fresnel Lens, and has no light condensing function along the direction of x-axis, therefore an even brightness can be achieved, due to the large divergent angle at the x-axis, even for the three primary color (R, G, B) light emitting portion with the three colors separated completely as shown in FIG. 49. In FIG. 53, the three primary colors are arranged in a row as shown by a dotted line in the figure, which can control a light direction more accurately than the method of arranging the three primary colors (R, G, B) into three rows. The cooling substrate is integrated with a wiring circuit for supply power to the light source and a thin film resistor for precisely adjusting the light intensity.

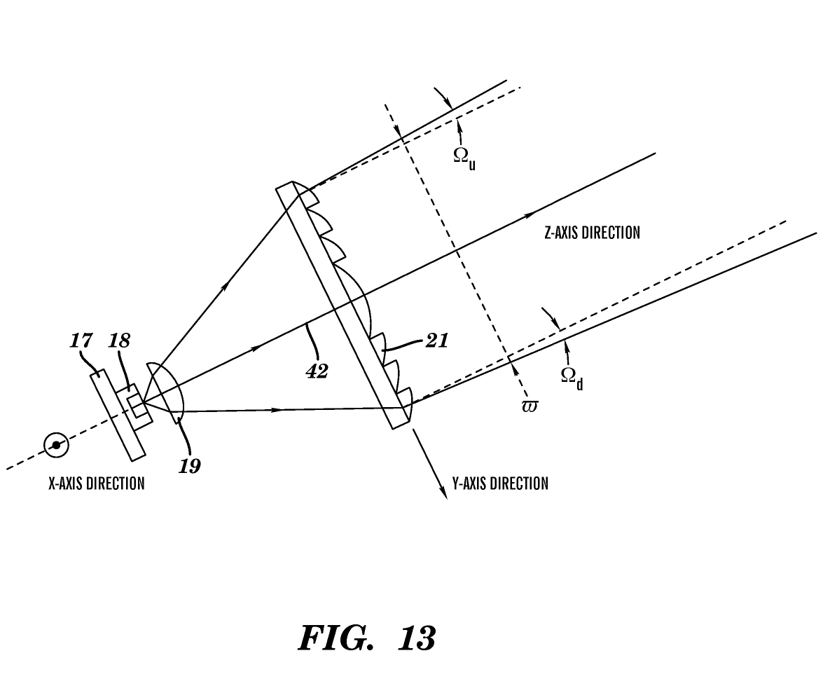

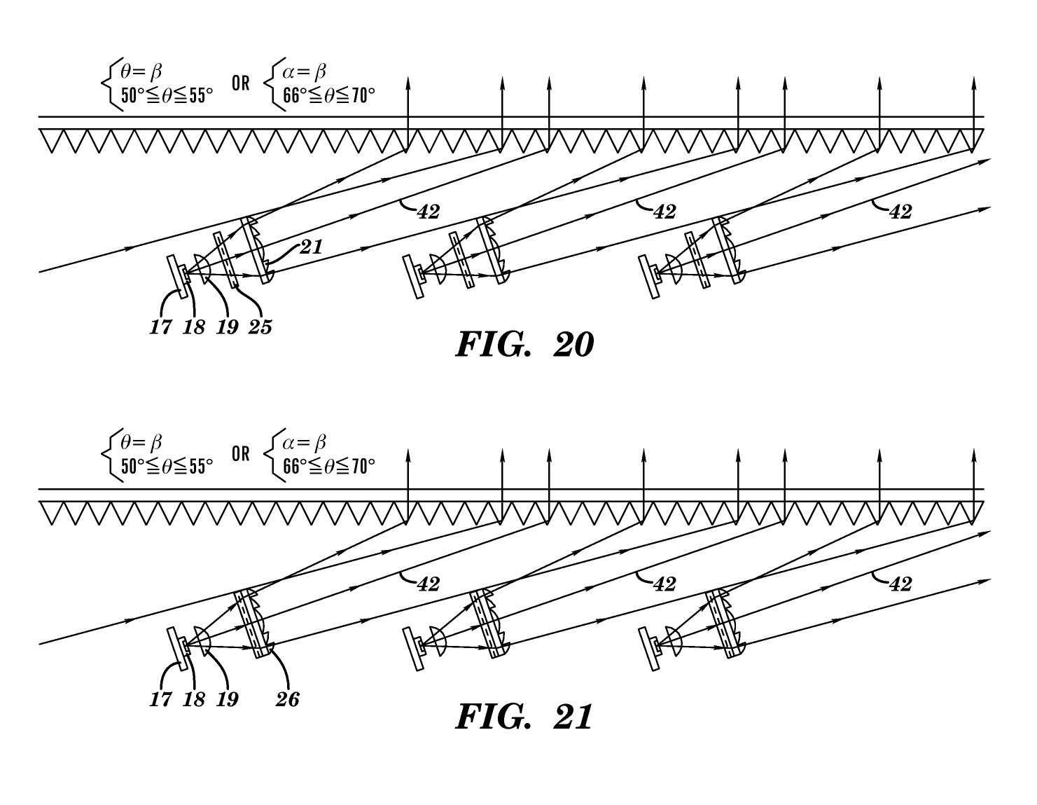

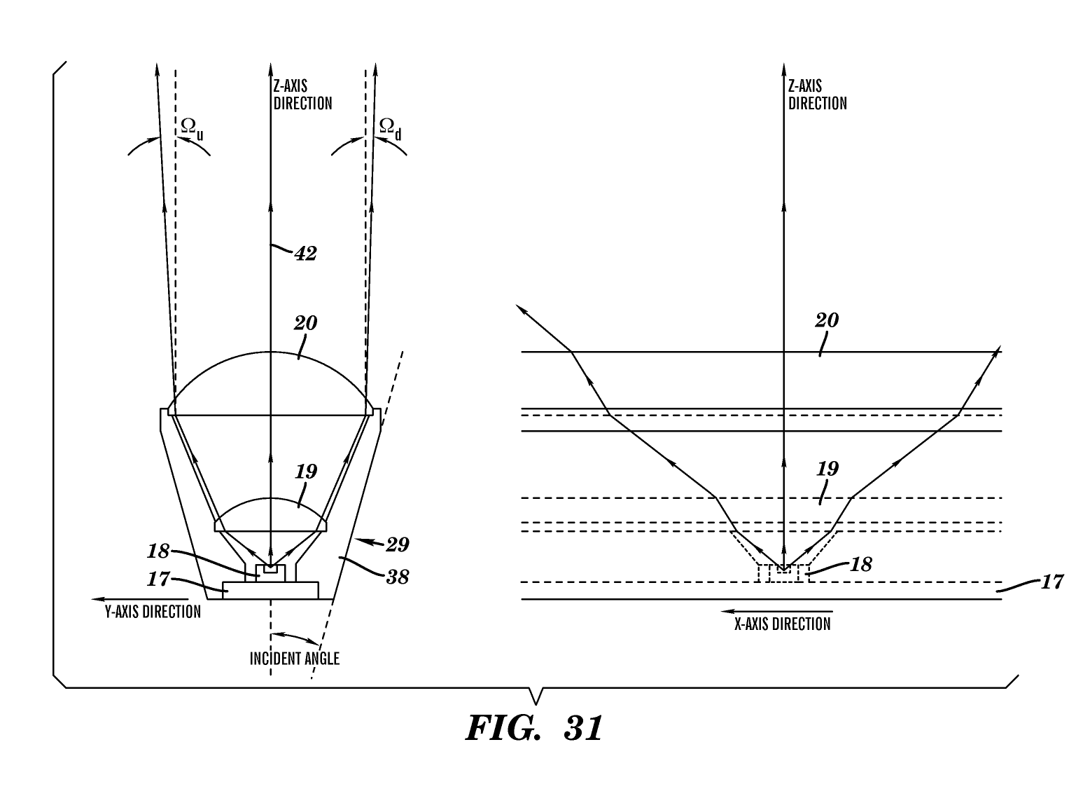

Referring to FIGS. 13, 18 to 23, 30 and 31 for Embodiment 2 of the present invention, the strip light of a plurality of semi-cylindrical lenses or a semi-cylindrical Fresnel lens is used for producing an optical unit. This embodiment of the present invention uses two semi-cylindrical lenses or three semi-cylindrical lenses, but there are cost and weight issues, and thus it is preferably to use two semi-cylindrical lenses for the invention. To provide two semi-cylindrical lenses with the same optical axis (or z-axis), a light emitting portion of a linear light source or a light emitting portion of a row of point light sources is set along the z-axis. In this embodiment as shown in FIGS. 20 to 23 and 30, a plurality of downward prisms is arranged on a prism sheet for projecting a strip light in one direction. If the strip lights are parallel with each other, each strip light cannot be superimposed, and thus the invention as shown in FIGS. 13 and 31 is characterized in that the strip light maintains a small divergent angle. A divergent angle (Ωu) at the upper side of the optical axis (or z-axis) and a divergent angle (Ωd) at the lower side of the optical axis are arranged in a direction other than the direction of the z-axis. Each value Ωu, Ωd falls within 5 degrees, and the sum of Ωu and Ωd is restricted within a range of 2 degrees to 8 degrees. If the two semi-cylindrical lenses are installed, each strip light can be superimposed properly. If the value Ωu is set to be greater than the value Ωd, each strip light can be connected properly. Further, a non-cylindrical lens can be used for changing the values of Ωu and Ωd to deviate the optical axes of the first semi-cylindrical lens and second semi-cylindrical lens to tilt one of the semi-cylindrical lenses.

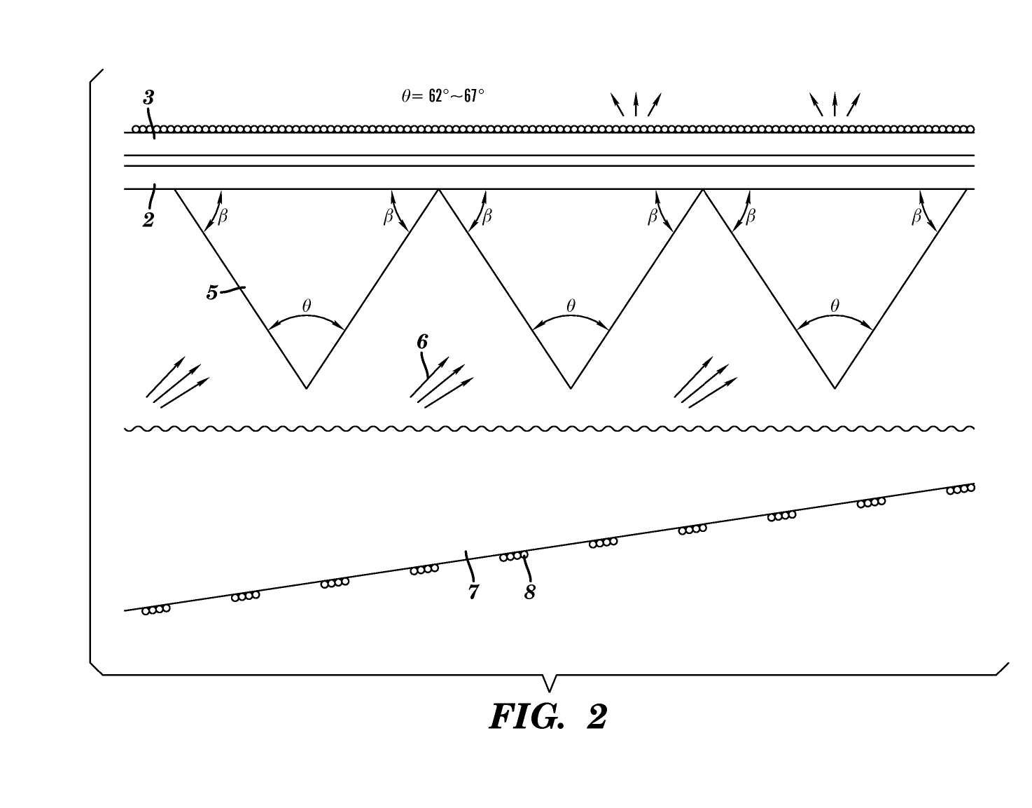

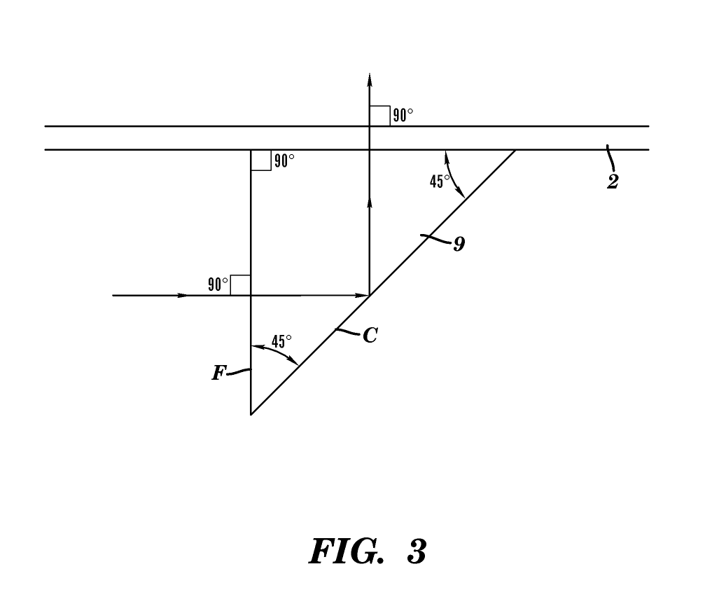

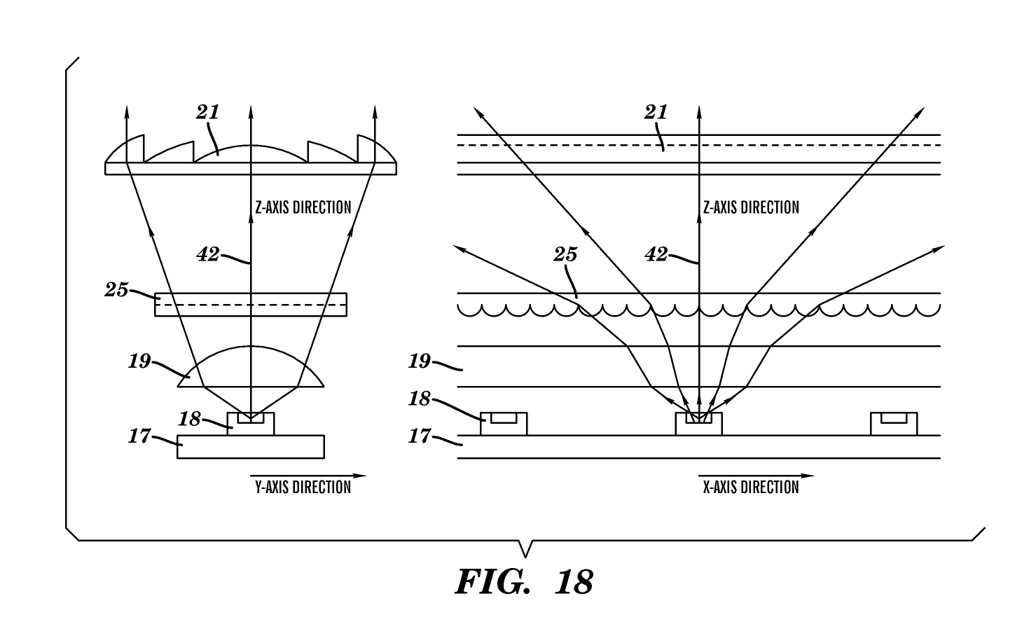

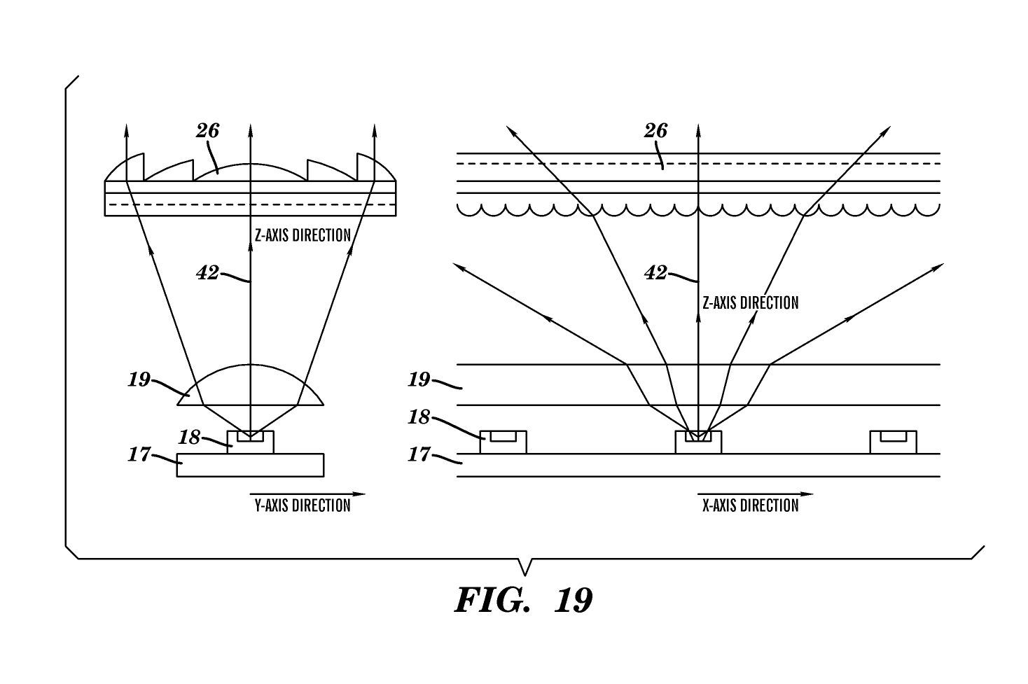

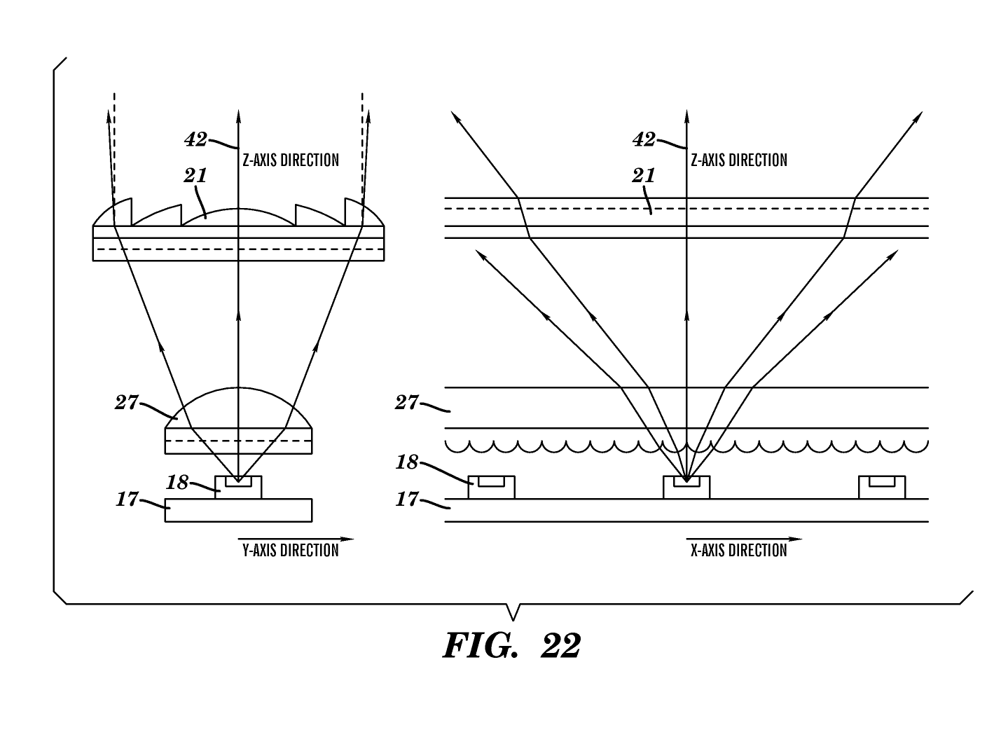

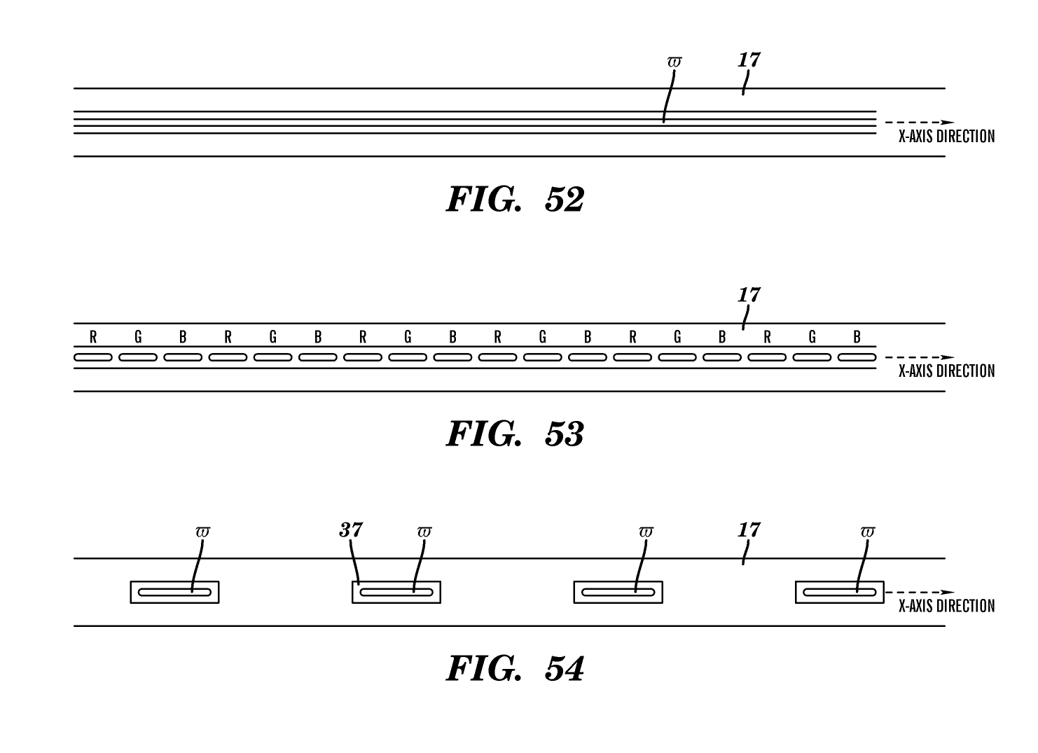

In FIGS. 13, 18, 19 and 22, the second semi-cylindrical lens is a semi-cylindrical Fresnel lens that can reduce the weight. In FIGS. 18, 19 and 22, an anisotropic diffusion function is added to the optical unit by the strip light, so as to increase the light diffusion along the direction of the x-axis, and further extend the interval of the point light sources to lower the installation cost of the point light sources. An anisotropic diffuser is used as shown in FIG. 18, and a first semi-cylindrical lens is used as shown in FIGS. 19 and 22, and an anisotropic diffusion function is added to a plane of an incident light of a semi-cylindrical lens as shown in FIG. 2. The light sources as shown in FIG. 52 are all linear light sources and thus such anisotropic diffusion function is not needed.

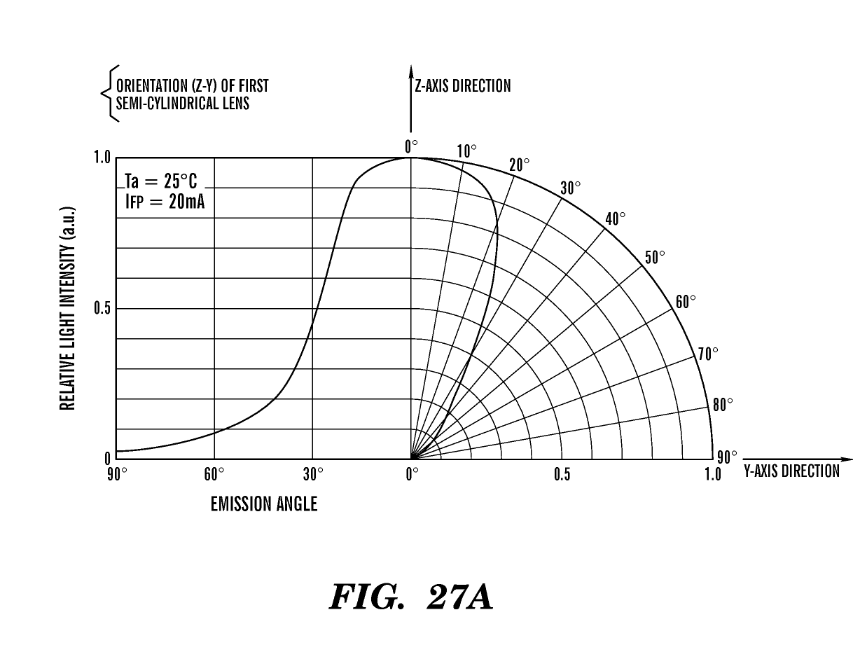

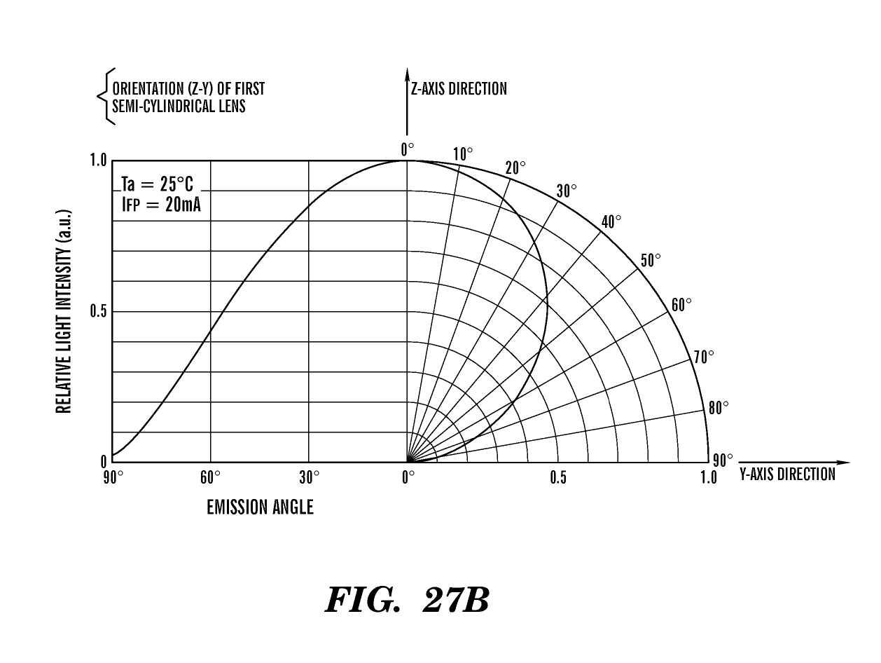

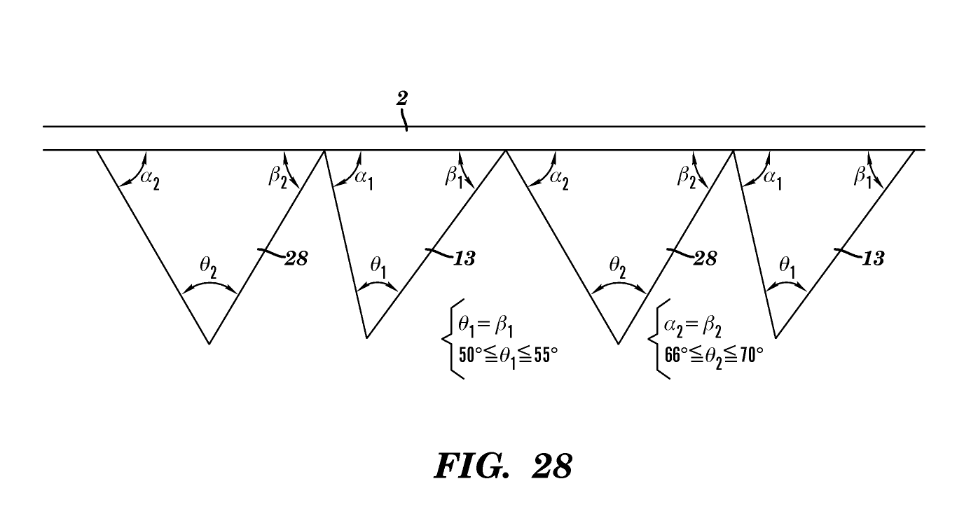

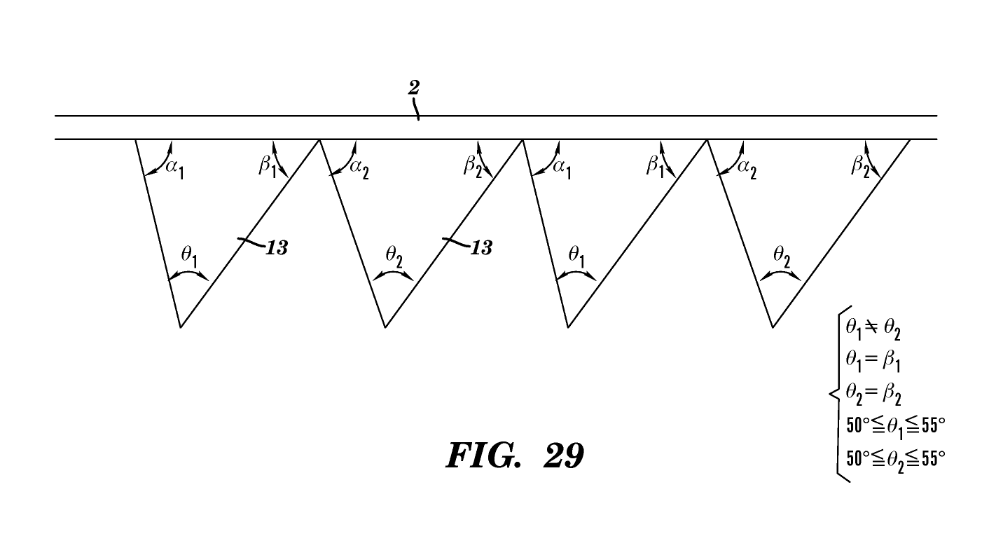

FIG. 27 shows a light emission orientation of a white color LED for calculating the value of the light source installed at the first semi-cylindrical lens, which is the value of orientation of the z, y-axes direction and the value of orientation of the z-x-axes direction. Since the present invention must produce substantially parallel strip lights along the z-axis, therefore the precision requirement of the position of the optical axis (or z-axis) for the light emitting portion and the semi-cylindrical lens is very strict. Therefore, the present invention adopts a lens keeper as shown in FIG. 31 to integrate the light source, the cooling device and the two semi-cylindrical lenses into an optical unit. The lateral side of the lens keeper is connected directly to a frame of the backlight for providing a good recurrence to form the angle of a plurality of downward prism sheets having a light deflection function, and preventing each of the optical units from being deviated. The lens keeper is made of a white color reflecting plastic. The present invention is characterized in that: the intersection angle of a surface and an optical axis (or z-axis) of the prism sheet is selected with a value falling within a range from 10 degrees to 24 degrees. Although the value of 30 degrees can be used for the same purpose, many optical units are required, which will increase the cost and the thickness of the backlight. For a value below 10 degrees, the light incident angle will be too small, which will make the precise installation of optical unit very difficult, and thus the intersection angle is preferably within a range of 15 degrees to 20 degrees.

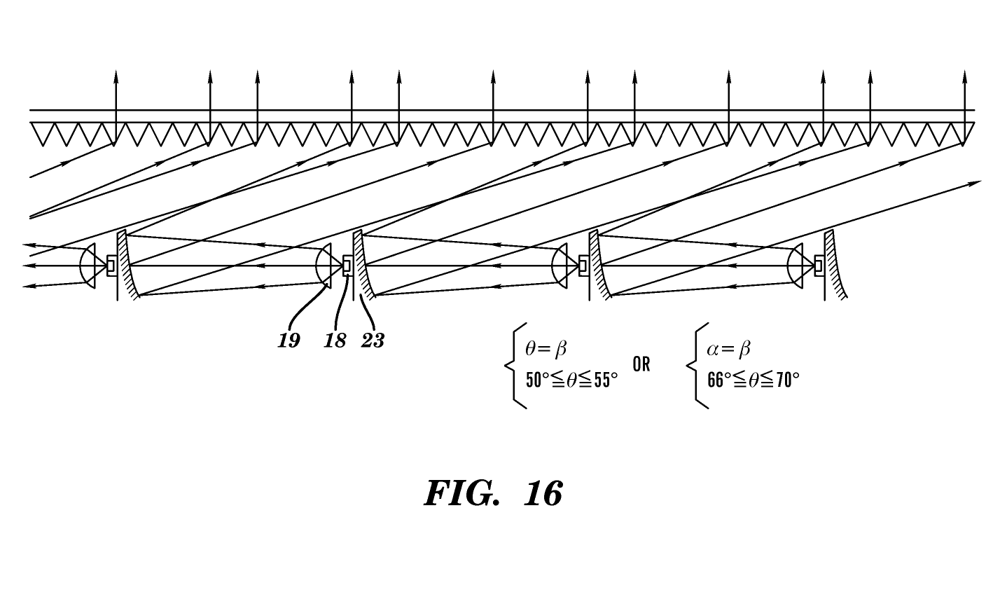

Referring to FIGS. 16, 24, 38, 39 and 58 for cross-sectional views of combining the strip lights of a semi-cylindrical lens and a curved reflective condensing lens to produce an optical unit, and a plurality of backlights installed to the optical units in accordance with Embodiment 3 of the invention, this embodiment is characterized in that: a curved reflective lens is provided for adjusting the divergent angle of the strip light. To return the strip light, a larger optical path length of the light incident from a light source to a prism sheet is adopted, and thus a larger interval between the point light sources along the x-axis is resulted. However, a reflective optical system is used, and thus it is difficult to maintain a high precision manufacturing and installation for the reflective lens. In FIG. 58, an optical system using two semi-cylindrical lenses is adopted for improving the efficiency of the light emitted from the point light source. Similarly, Embodiment 2 also selects an angle ranging from 10 degrees to 24 degrees for producing a strip light in one direction from the downward prism sheet. The incident angle is measured from the surface of a substrate film of the prism sheet, and the best selected incident angle ranging from 15 degrees to 20 degrees which is the same as Embodiment 2.

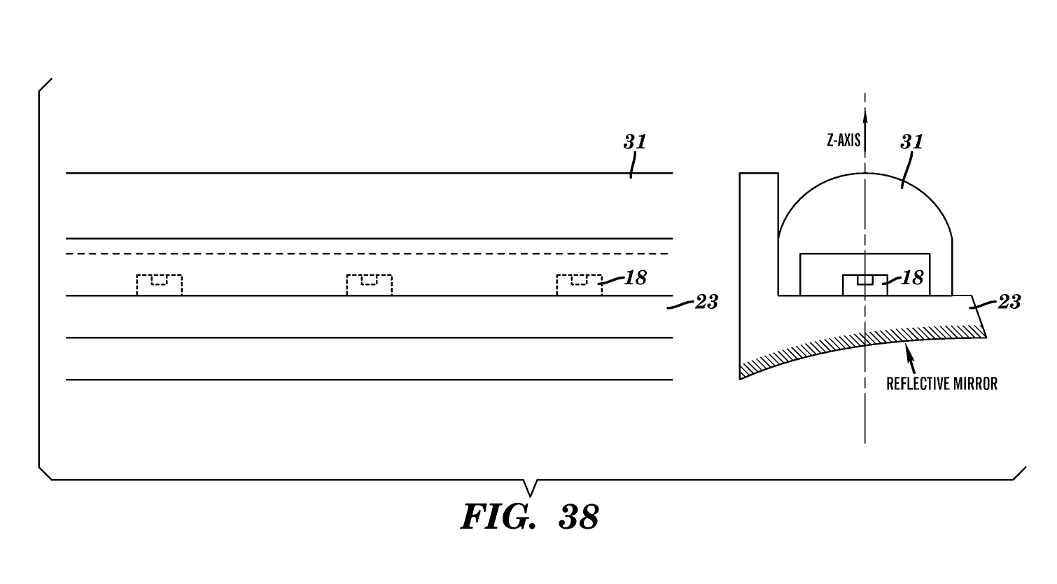

Referring to FIGS. 38 and 58 for cross-sectional views of integrating a lens keeper for a row of point light sources and a semi-cylindrical lens, a light source of a condensing lens system and a curved reflective lens system and a cooling device for cooling a light source into an optical unit, the interval between the point light sources along the x-axis direction is increased, and an anisotropic diffusion function is added to a plane at a side of the incident light of a first semi-cylindrical lens or a second semi-cylindrical lens to increase the light diffusion along the direction of the x-axis and improve the evenness of the brightness.

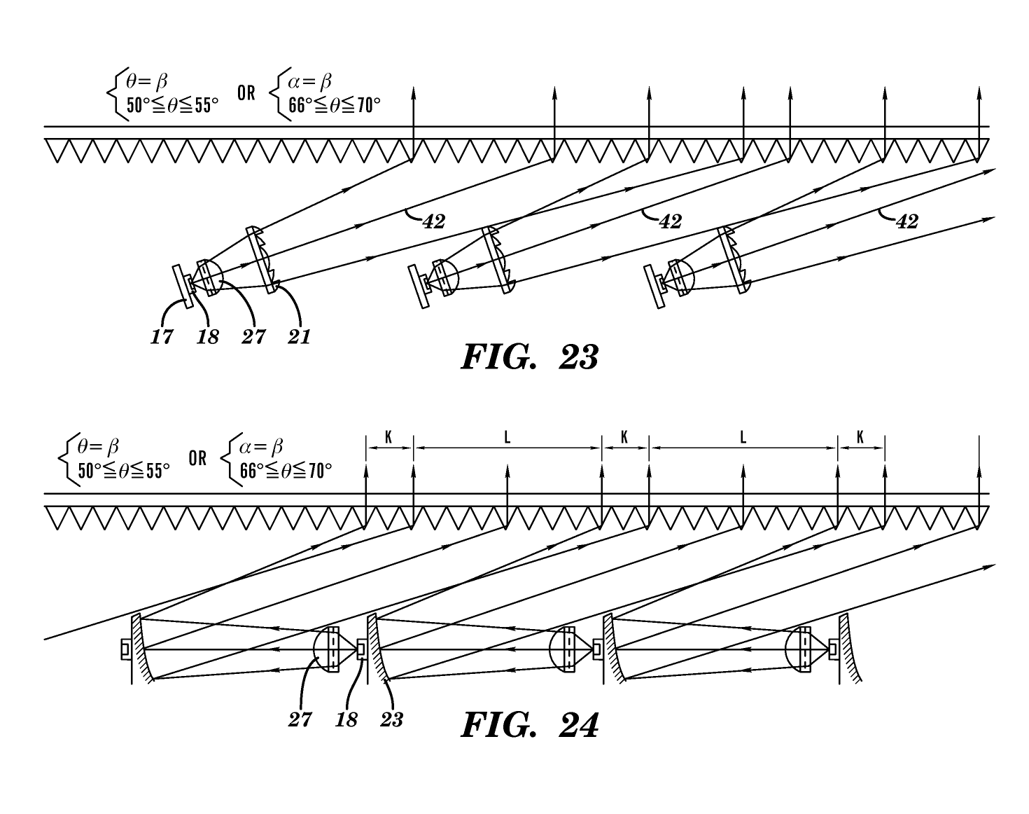

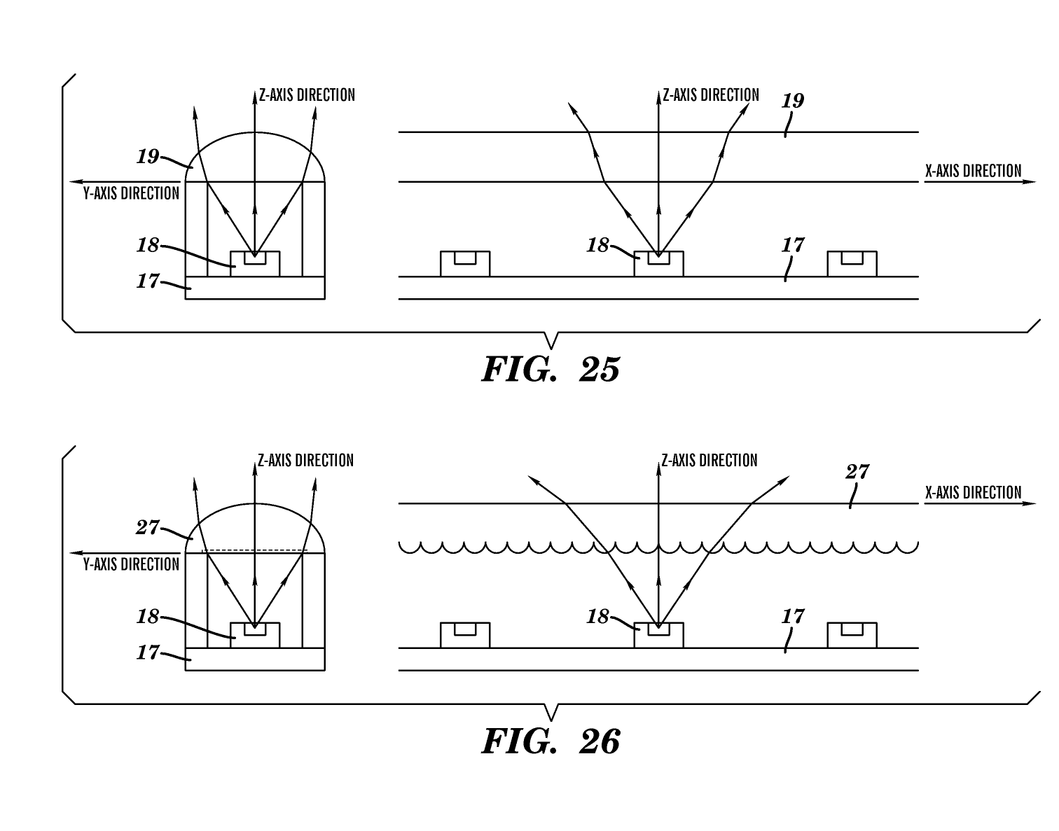

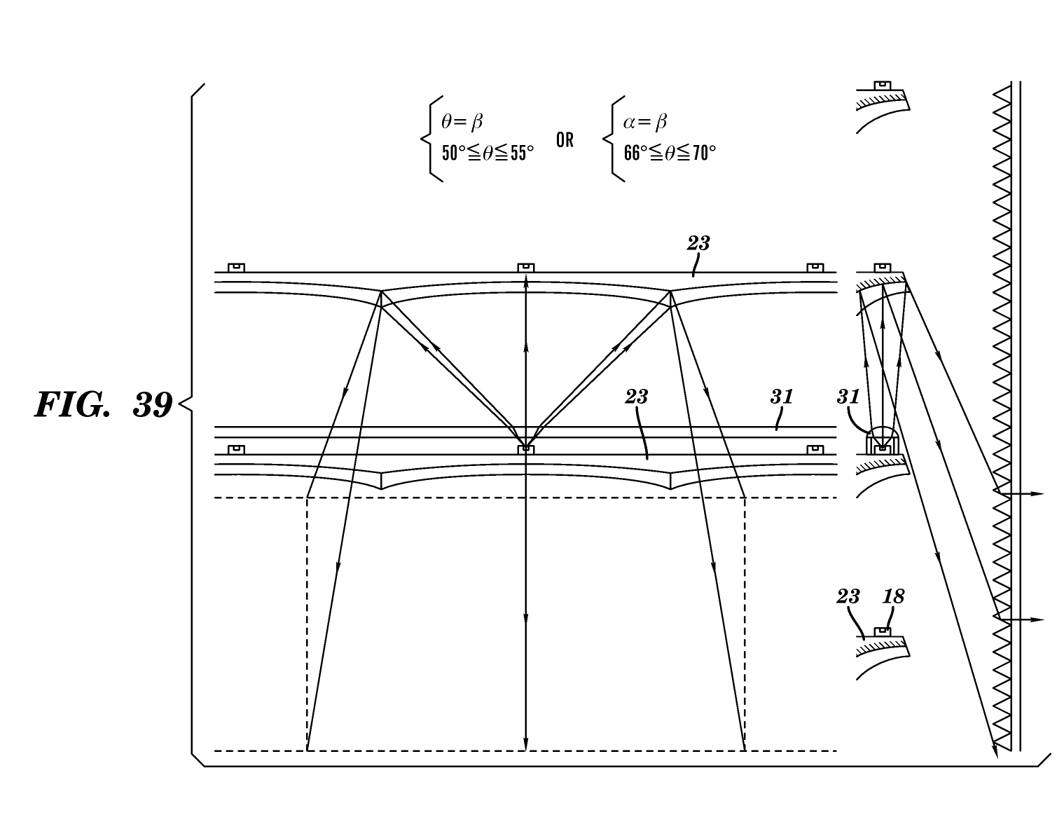

FIGS. 39 and 16 are similar to FIG. 24, except the curved reflective lens is a complicated 3D reflective lens instead of the 2D reflective lens as shown in FIGS. 16 and 24. In FIGS. 16 and 24, the limitation on the installation position along the x-axis is not as strict, if a plurality of optical units is adopted, but the installation position along the x-axis for the case as shown in FIG. 39 is limited. Since it can improve the efficiency of the strip light, therefore it is preferably to use the optical unit as shown in FIG. 39 to install the backlight in order to lower the power consumption.

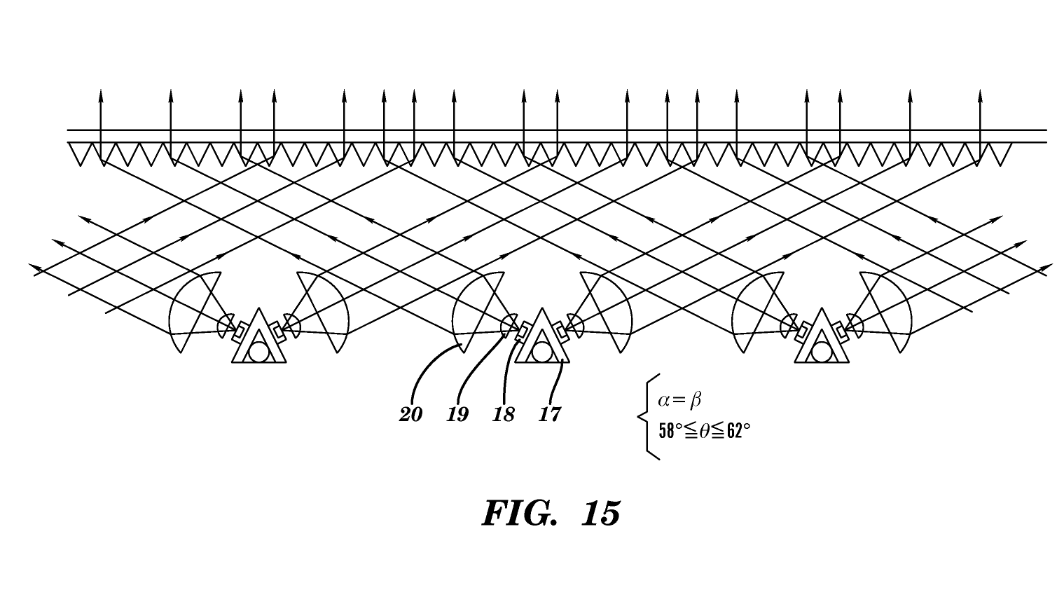

Referring to FIG. 15 for a cross-sectional view of a backlight installed separately at a plurality of optical units, the optical units are arranged on a prism of a downward prism sheet having a light deflection function for reflecting strip lights from two directions. Two sets of optical units 2 as shown in Embodiment 2 are installed alternately for changing the directions, and such optical system ignores the power consumption issue and increases the quantity of backlights. The semi-cylindrical Fresnel lens is used instead of the semi-cylindrical lens as shown in FIG. 15 to reduce the weight.

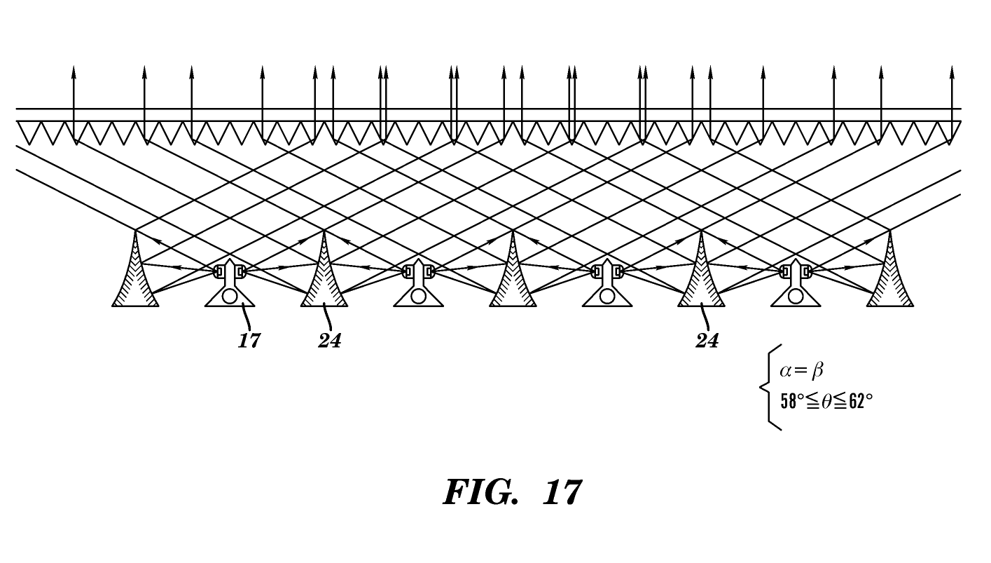

Referring to FIG. 17 for a cross-sectional view of arranging a plurality of optical units parallelly to install a backlight in accordance with Embodiment 5 of the present invention, the optical units are arranged on a downward prism sheet comprised of a plurality of prisms and having a light deflection function for projecting strip lights from two directions. Two sets of optical systems 2 that change directions with each other are installed alternately, and such arrangement is effective if the quantity of backlights is increased. Since the reflective lens system cannot be integrated with the light source system, and thus the installation of the backlight cannot be simplified easily, but the weight can be reduced, and the thickness can be thinner than that of Embodiment 4.

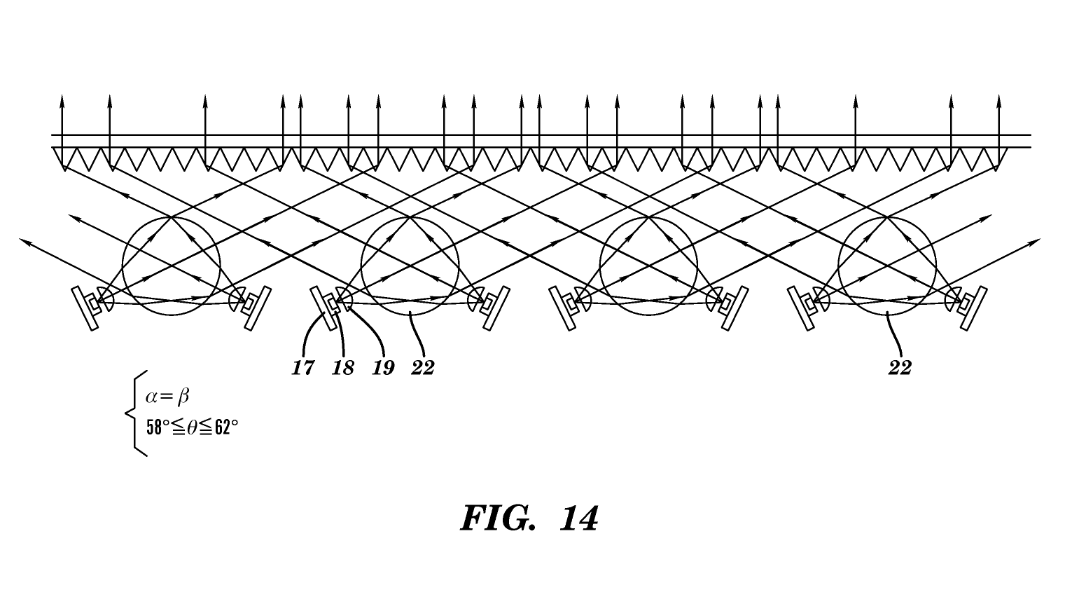

Referring to FIG. 14 for a cross-sectional view of arranging a plurality of optical units parallelly to install a backlight in accordance with Embodiment 6 of the present invention, the optical units are arranged on a downward prism sheet comprised of a plurality of prisms having a light deflection function, and strip lights are reflected from two directions. This embodiment is characterized in that: a linear light source or a row of point light sources is set at opposite sides of one cylindrical lens, and the lights in different directions are intersected in an area of the cylindrical lens. Since two sets of opposite light sources 2 of the semi-cylindrical lenses are adopted, the light is incident at one cylindrical lens. Although Embodiment 4 comes with a thinner thickness, the weight of the cylindrical lens cannot be reduced. Similar to Embodiment 5, this embodiment is effective if the quantity of backlights is increased.

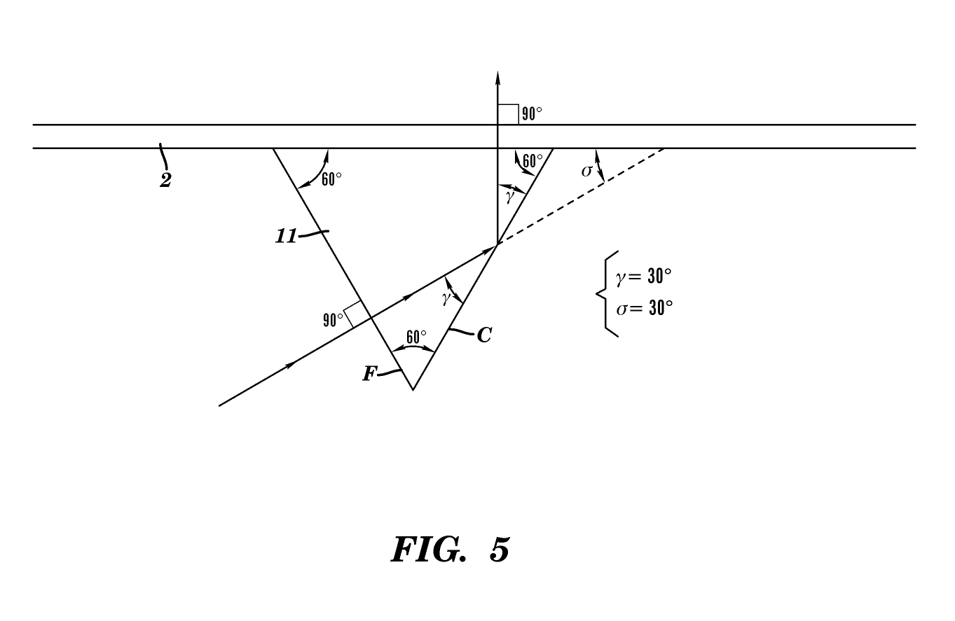

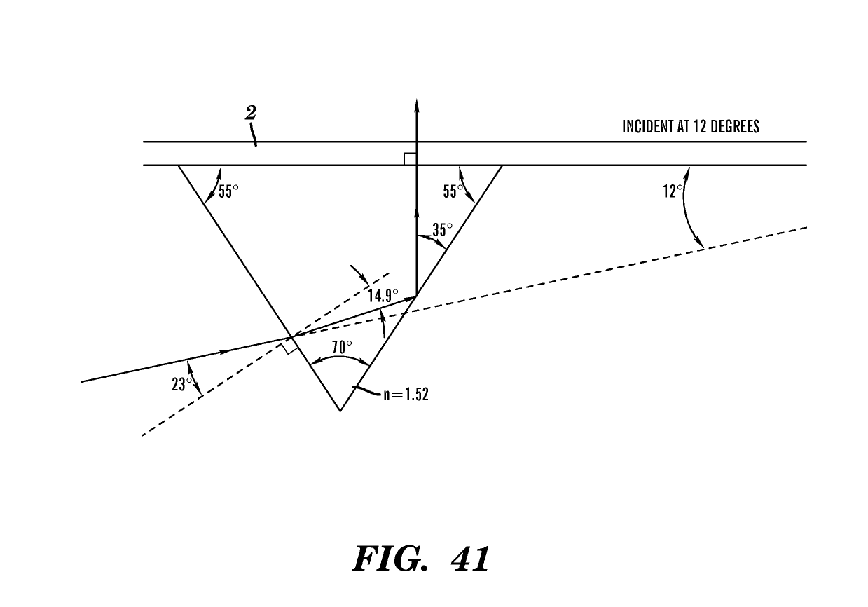

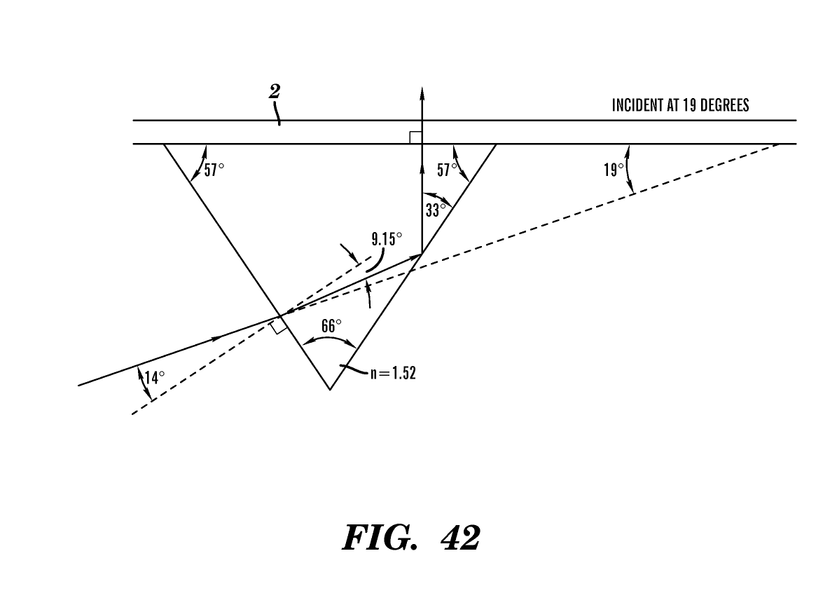

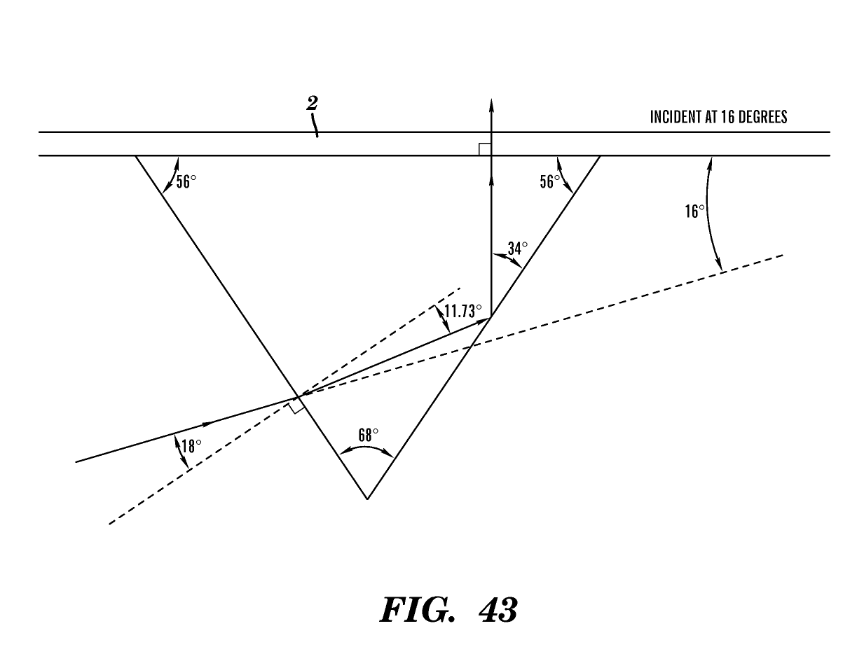

Referring to FIGS. 41 to 43 for cross-sectional views of a backlight using a prism of a basic unit of a prism sheet comprised a plurality of prism and having a light deflection function in accordance with Embodiment 7 of the present invention, FIG. 41 shows a surface of a substrate film of the prism sheet, and a light is emitted perpendicularly from the surface of the substrate film after the light is incident into a surface of the substrate film at an incident angle of 12 degrees. The light is emitted perpendicularly from the surface of the substrate film as shown in FIG. 43 after a light is incident at an incident angle of 16 degrees. The light is emitted perpendicularly from the surface of the substrate film as shown in FIG. 42 after a light is incident at an incident angle of 19 degrees. Any incident light of a prism is reflected completely from an oblique surface of a backside of the prism and opposite to the surface of the incident light, and the light is polarized in a vertical direction of the surface of a substrate film. If the optical axis (or z-axis) of a strip light is set to an angle equal to a light incident angle as shown in FIGS. 41 to 43, a vast majority of the strip light is reflected from the vertical direction of the surface of a substrate film. If the divergent angle falls within several degrees, a vast majority of the light is emitted from a direction close to the vertical direction of a surface of a substrate film. By then, the width W of the y-axis of the strip light depends on the incident angle σ, and if the width of the surface of the substrate film is amplified by 1/sinσ times, then the width W will be amplified by W/sinσ. If the incident angle of a light is equal to 19 degrees, then the light will be emitted with an amplified width of 3 times. If the incident angle is equal to 12 degrees, the width will be amplified by approximately 5 times. If a right triangular prism sheet has a vertex angle of 60 degrees as shown in FIG. 5 and the incident angle is equal to 30 degrees, the amplification is only two times. For a small amplification rate, it is necessary to increase the quantity of strip lights or increase the quantity of linear light sources or rows of point light sources, so as to incur a higher cost. Therefore the incident angle must be less than 30 degrees. For a large amplification rate, the rate of change of the brightness becomes smaller if the incident angle is decreased. If the incident angle is equal to 8 degrees, and the amplification rate is over 7 times, then it will not be easy to control a deviated precision of an incident angle. Therefore, the incident angle must be greater than 10 degrees.

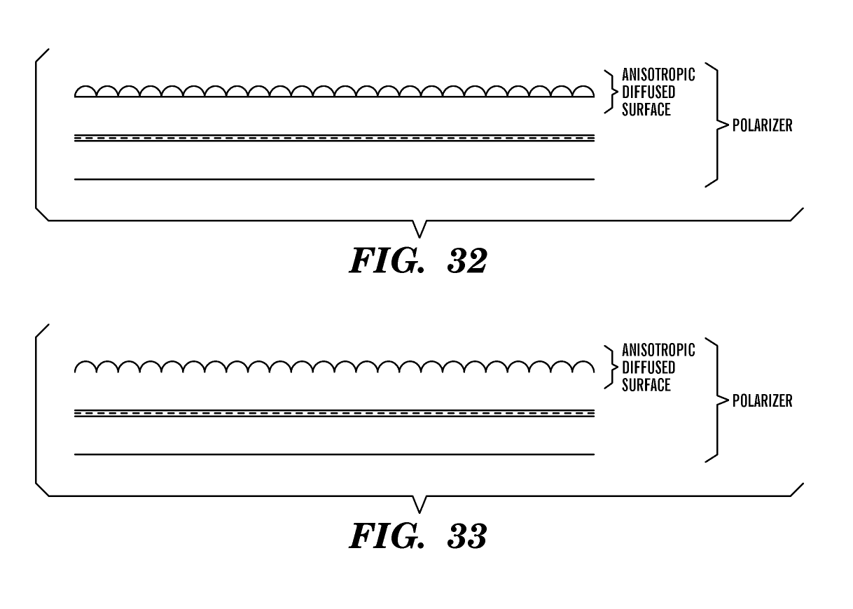

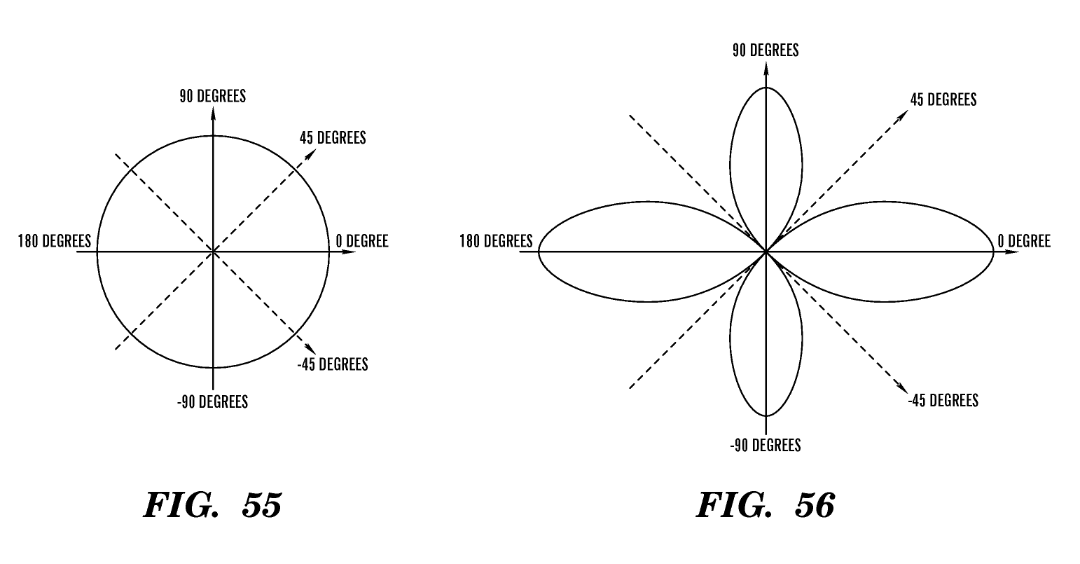

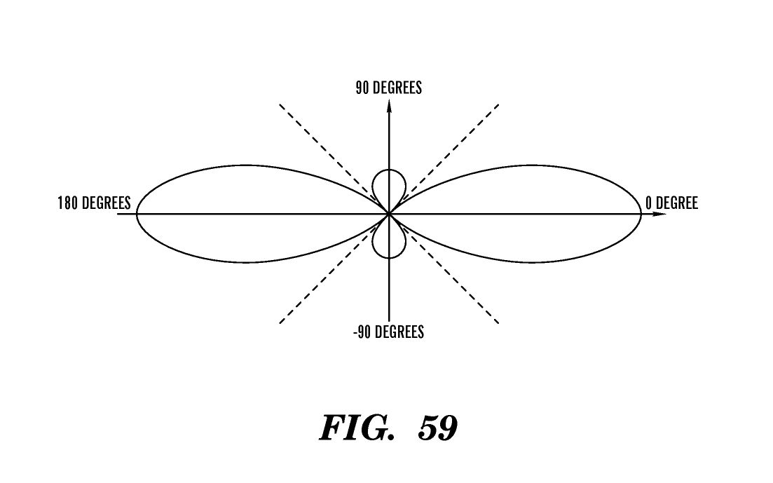

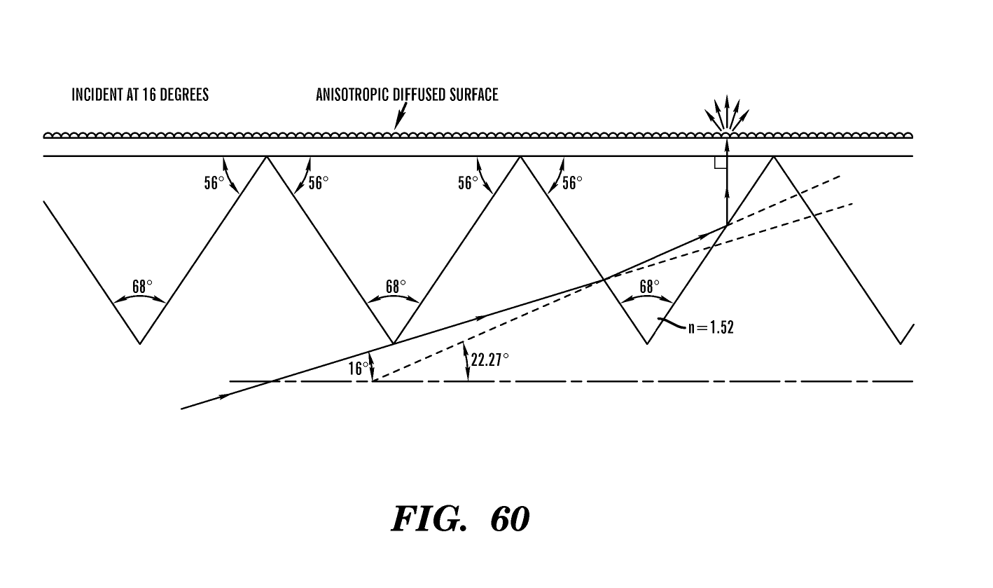

Referring to FIGS. 59 and 41 for an orientation of a strip light having a small divergent angle and incident at a downward prism sheet, the strip light is reflected completely from an oblique surface of the prism, and emitted vertically from a surface of a substrate film. Referring to FIG. 60 for an orientation when an anisotropic diffusion function is added to the backside of the substrate film as shown in FIG. 56, the downward prisms of FIGS. 41 to 43 are combined, and a polarizer added with an anisotropic diffusion function of FIGS. 32 and 33 is attached onto a protective film on the surface of the LCD panel to obtain an orientation of FIG. 56. Since the IPS and FFS modes produce a light leak in the directions of ±45 degrees, therefore the contrast in the directions of±45 degrees will be deteriorated. As a result, it is necessary to use a special optical compensation film, if a backlight has an orientation of FIG. 55, for preventing a light leak in the directions of±45 degrees. The special optical compensation film usually cannot be made in a large area and comes with a very high price, and thus the effect of lowering costs cannot be achieved.

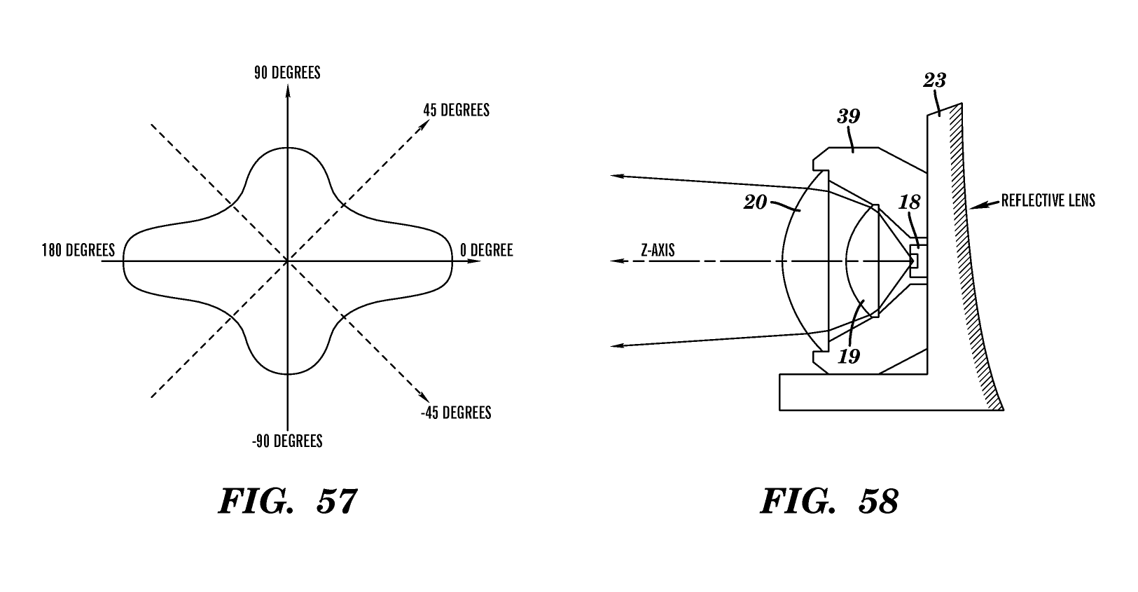

A backlight optical system in accordance with the present invention has a backlight with the orientation of FIGS. 56 or 59, and the IPS or FFS is combined with an LCD panel by a horizontal electric field method, the problem of a light leak at the directions of±45 degrees can be solved. In a backlight with the orientation as shown in FIGS. 56 and 59, no light is emitted from the directions of ±45 degrees, and thus no light leak will be produced theoretically, so that when the light passing through a polarizer on the surface of the LCD panel passes through a surface having an isotropic diffusion function, then the orientation of FIG. 57 occurs. In the case as shown in FIG. 56, it simply needs to provide an isotropic diffusion function at the surface of the polarizer. In the case of FIG. 59, an anisotropic diffusion function is added to a protective film of the polarizer, and a film having the isotropic diffusion function is stacked onto the polarizer, so as to achieve the orientation of FIG. 57. Since the backlight optical system of the present invention can achieve an orientation that is very suitable for the horizontal electric field liquid crystal mode, therefore the present invention no longer requires a special optical compensation film anymore, and thus lowers the cost greatly.

With the downward prisms of FIGS. 41 to 43, a light can be incident from any side of an oblique surface of a prism, and thus there is no particular problem for installing the backlight, and all methods as illustrated in FIGS. 14 to 17, 20 to 24, 30 and 39 are applicable. Since the vertex angle of the prism is not an acute angle, therefore the manufacturing becomes much easier, and the vertex angle will not be damaged during the manufacturing process. Thus, prisms of this sort are very suitable for the mass production of backlights.

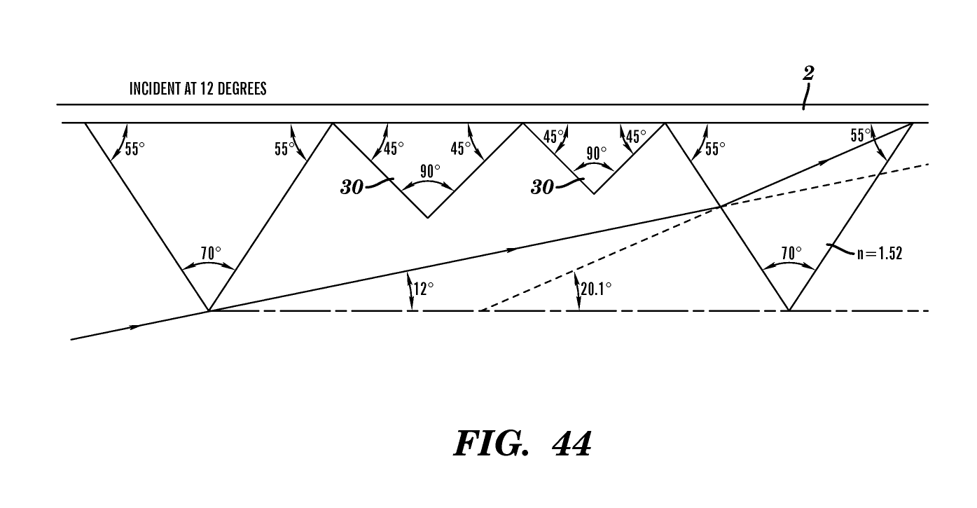

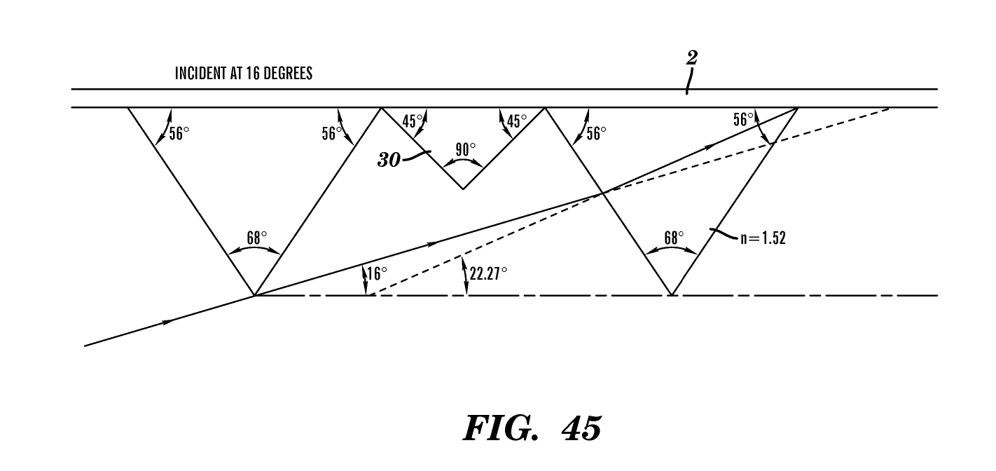

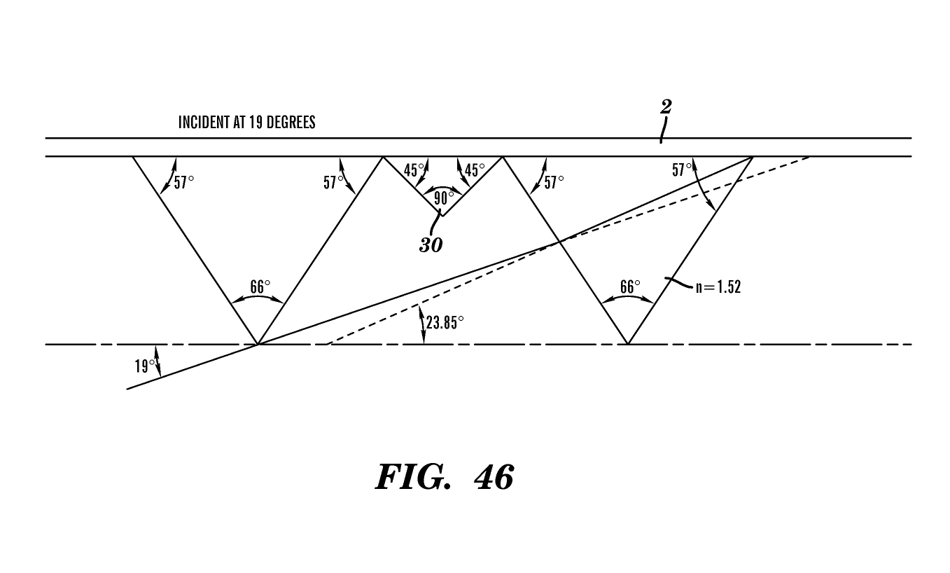

Referring to FIGS. 44 to 46 for cross-sectional views of a backlight using a downward prism sheet comprised of a plurality of prisms having a light deflection function in accordance with Embodiment 8 of the present invention, a light is incident with an angle 12 degrees measured from a surface of the substrate film of FIG. 44, the light is emitted vertically from a surface of the substrate film. In FIG. 45, the light is incident at 16 degrees and emitted vertically from a surface of the substrate film. In FIG. 46, a light is incident at 19 degrees and emitted vertically from a surface of the substrate film. Any prism can completely reflect an incident light incident from an oblique surface of the prism, and the light traveling direction is deviated from the vertical direction of a surface of the substrate film. The difference of Embodiment 7 resides on that the vertex angle Θ is constituted by two different types of prisms. In FIG. 44, two isosceles triangular prisms with a vertex angle of 90 degrees are installed between the isosceles triangular prisms with a vertex angle of 70 degrees. In FIG. 45, one isosceles triangular prism with a vertex angle of 90 degrees is installed between the isosceles triangular prisms with a vertex angle of 68 degrees. In FIG. 46, an isosceles triangular prism with a vertex angle of 90 degrees is installed between the isosceles triangular prisms with a vertex angle of 66 degrees. This embodiment is characterized in that: any composite prism should have a vertex of its vertex angle lower than the vertex of the vertex angle of a prism having a deflection function to prevent the vertex of the vertex angle of 90 degrees of a prism blocks an incident light. Compared with a prism sheet of Embodiment 7 that does not have a prism with a vertex angle of 90 degrees, there is no difference of the light deflection function.

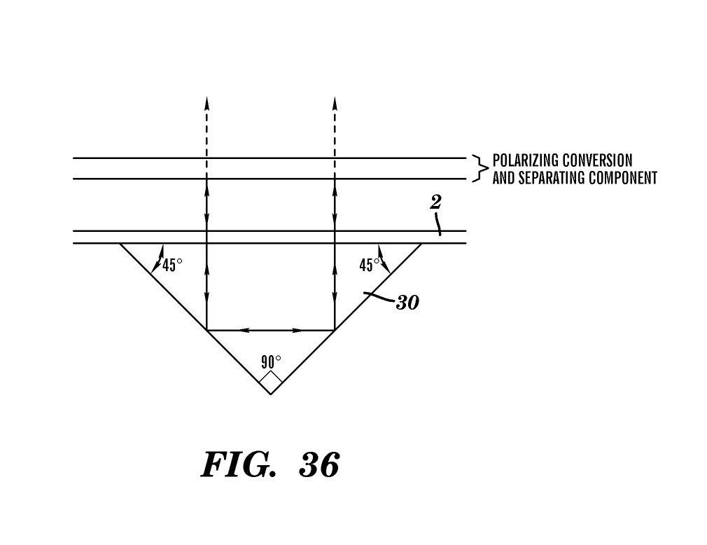

In a prism with a vertex angle of 90 degrees as shown in FIG. 36, a light incident from a lateral side of a substrate film can be reflected completed from two oblique surfaces of the prism, and returned in the same direction to the reflection function. Due to such function, the efficiency of the light of the prism can be improved over the prism sheet of Embodiment 7, when the prism sheets of FIGS. 44 to 46 are combined with a polarization converting and separating film, so as to further enhance the brightness. The prism with a vertex angle of 90 degrees has the best effect on the function of returning the reflection, but this reflection function can be found in any isosceles triangular prism with a vertex ranging from 80 to 110 degrees, such that the efficiency of the light can be improved.

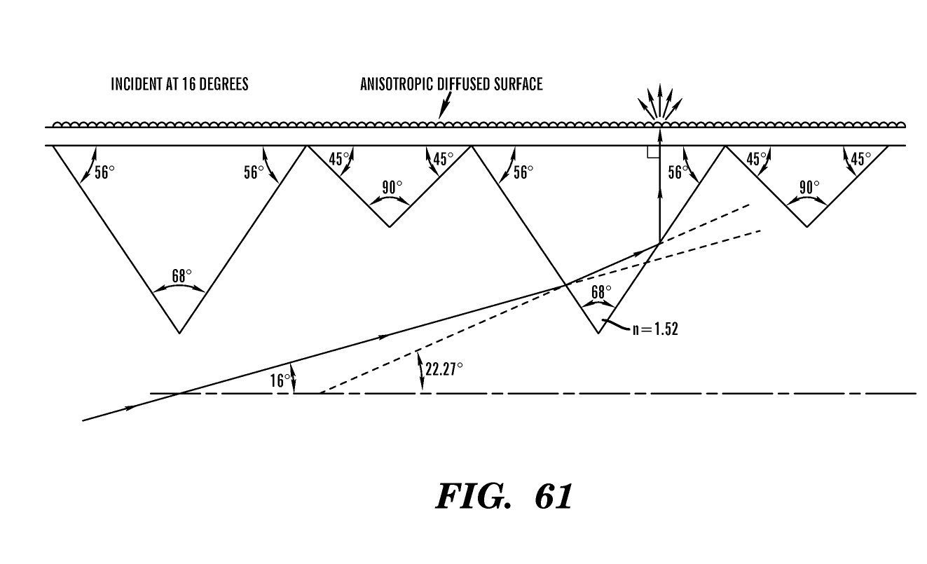

Referring to FIGS. 44 to 46 for diagrams of the orientation of downward prism sheets, a strip light with a small divergent angle can be reflected completely from an oblique surface of the prism and emitted perpendicularly from a surface of the substrate film. Like Embodiment 7, the same effect as shown in FIG. 59 can be obtained. A change of orientation is as shown in FIG. 56, and if an anisotropic diffusion function is added to a backside of a substrate film of a prism as shown in FIG. 61, the orientation as shown in FIG. 56 can be obtained. The downward prism with a vertex angle of 90 degrees has a reflection function of retuning the light. Since the light of an anisotropic diffused light is weakened, therefore the effect of enhancing the brightness is not too good. If the backside of the substrate film does not have an anisotropic diffusion function, and a light is incident at the LCD panel with an orientation as shown in FIG. 59 and passed through the LCD panel, such that a protective film of a polarizer installed at the surface of the LCD panel has the anisotropic diffusion function, then the efficiency of light for the orientation as shown in FIG. 56 will be improved to achieve a high-brightness display. To ensure the recognition of the direction of ±45 degrees, a protective film having an anisotropic diffusion function is installed on an isotropic diffusion film or an anisotropic diffusion function is added to a film in the direction of±45 degrees, so as to achieve the orientation of FIG. 57.

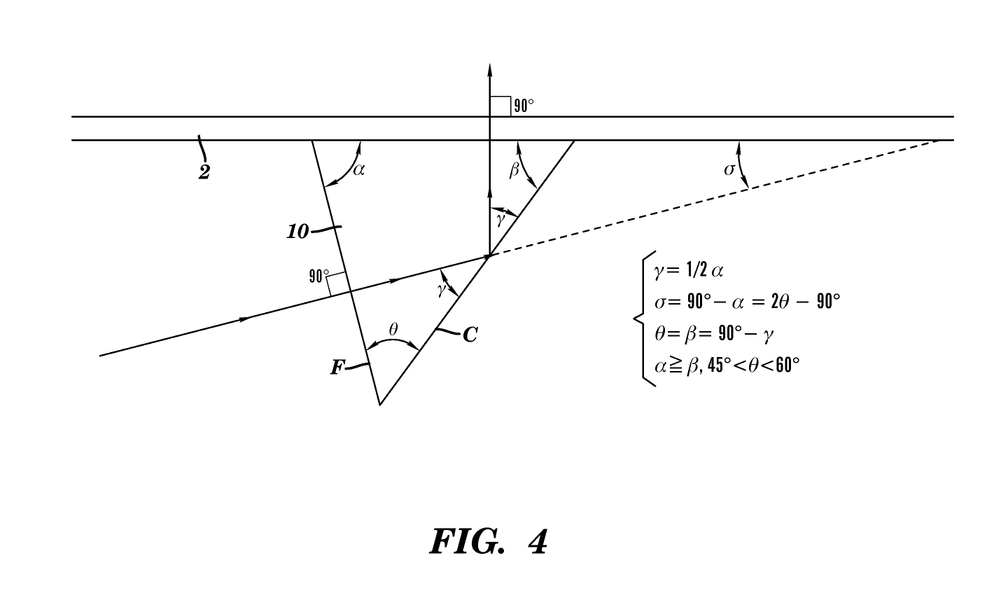

Referring to FIGS. 4, 5 and 40 for cross-sectional views of a basic unit of a prism of a downward prism sheet comprised of a plurality of prisms having a light deflection function and used by a backlight in accordance with Embodiment 9 of the present invention, any light incident at an angle of 90 degrees from a steeply oblique surface of a prism will be reflected completely from a gently oblique surface at the backside, and emitted perpendicularly from a surface of the substrate film of the prism sheet.

If a strip light of FIGS. 13, 18, 19, 22 and 31 is emitted from an optical system and the optical axis (or z-axis) of the strip light is designed to have the same light incident angle as shown in FIGS. 4, 5 and 40, then most of the strip light are emitted perpendicularly from a surface of the substrate film. If the divergent angle of the strip light is within several degrees, almost all of the light coming from a surface of the substrate film is emitted substantially in a vertical direction. By then, the width W of the y-axis of the strip light depends on the incident angle σ, and the width of the surface of the substrate film is amplified to 1/sinσ times, or the width W is amplified by W/sinσ times. For an incident angle of 10 degrees, the width will be amplified by 5.8 times. For an incident angle of 20 degrees, the light will be emitted with a width amplified to approximately 2.9 times. If the incident angle of a right triangular prism sheet with a vertex angle of 60 degrees as shown in FIG. 5 is equal to 30 degrees, then the width of the strip light will be amplified by 2 times only. For a small amplification rate, it is necessary to increase the quantity of strip lights or increase the number of units of linear light sources or rows of point light sources, and thus incurring a higher cost. Therefore, the incident angle must be maintained below 30 degrees. If the amplification rate is increased and the incident angle is decreased, it will be not easy to achieve an even brightness, and the brightness will be inconsistent. If the incident angle is equal to 8 degrees, the amplification rate will reach over 7 times, and a small change of incident angle will cause a large change of brightness. Therefore, the incident angle must be maintained below 10 degrees.

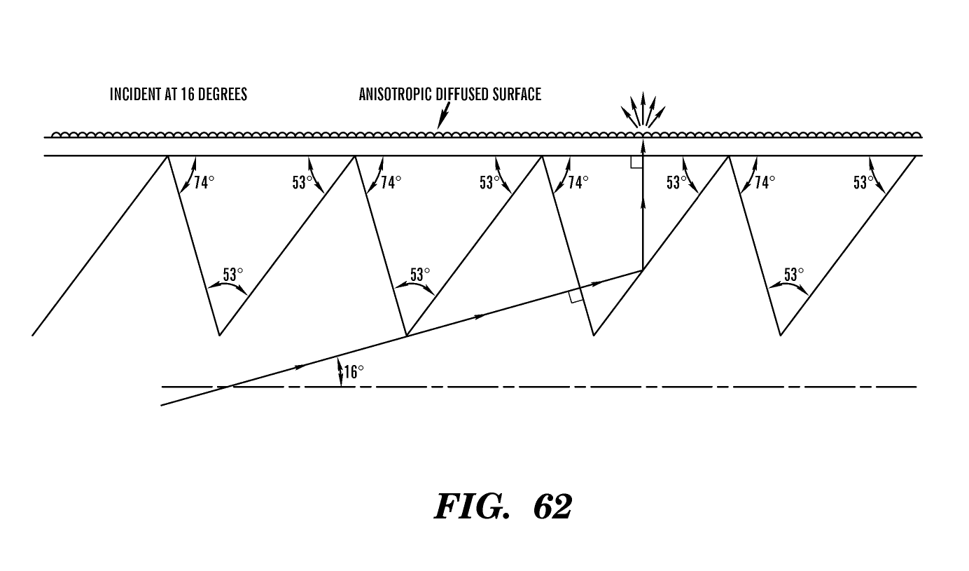

Referring to FIG. 49 for a cross-sectional view of a strip light with a small divergent angle being incident at a downward prism sheet as shown in FIGS. 4, 5, 40 and 49, the strip light is reflected completely from an oblique surface of a prism and emitted perpendicularly from a surface of a substrate film. In FIG. 62, an orientation of FIG. 56 is achieved when an anisotropic diffusion function is added to the backside of a substrate film of the prism sheet. Even if the downward prism sheets as shown in FIGS. 4, 5 and 40 are combined, and an anisotropic diffusion function is added to a protective film of a polarizer of FIGS. 32 and 33 attached onto a surface of the LCD panel, the orientation of FIG. 56 can be achieved. Since both IPS and FFS produces a light leak in the direction of ±45 degrees, therefore the contrast in the direction of ±45 degrees will be deteriorated significantly. If an isotropic backlight of FIG. 55 is used, it is necessary to use a special optical compensation film to prevent a light leak in the direction of ±45 degrees. It is not easy to produce the special optical compensation film with a large area, and thus the price will be very high, which is an obstacle for lowering costs.

If the backlight optical system of the present invention is adopted, and the backlight having an orientation of FIGS. 56 or 59 is combined with the IPS or FFS horizontal field LCD panel, the problem of having a light leak in the direction of ±45 degrees can be solved. Since there is no light emitted in the direction of ±45 degrees from the backlight having an orientation of FIGS. 56 and 59, therefore no light leak will occur theoretically. When a light passing through a polarizer at the surface of the LCD panel passes through a surface with an isotropic diffusion function, then the orientation of FIG. 57 can be achieved. For the case of FIG. 56, it simply requires an isotropic diffusion function for the surface of a protective film of a polarizer. In the case of FIG. 59, an anisotropic diffusion function is added to the protective film of the polarizer, and a film with an isotropic diffusion function is superimposed with the polarizer to achieve the orientation of FIG. 57. Since the backlight optical system of the present invention can achieve an orientation which is very suitable for horizontal field LCD mode, therefore the invention does not require a special optical compensation film, so as to lower the cost greatly. Similarly, the viewing angle of the MVA can be extended to lower the circuit cost.

For the case of a downward right triangular prism of FIG. 5, a light can be incident at any lateral sides of an oblique surface of a prism, and thus there will be no operating error or problem when the backlight is installed, and such prisms are applicable for producing a backlight optical system by using strip lights as shown in FIGS. 14 to 17, 20 to 24, 30 and 39.

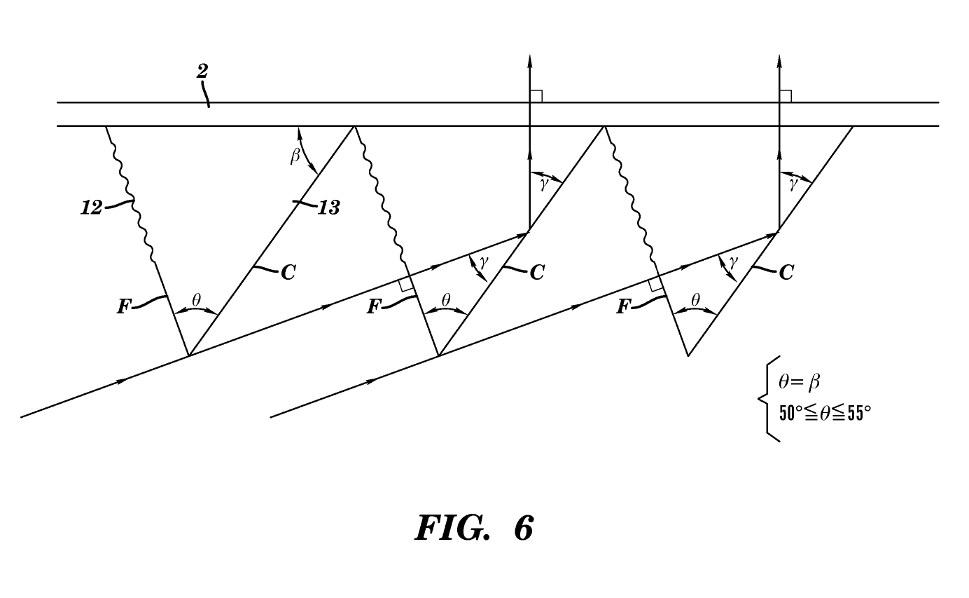

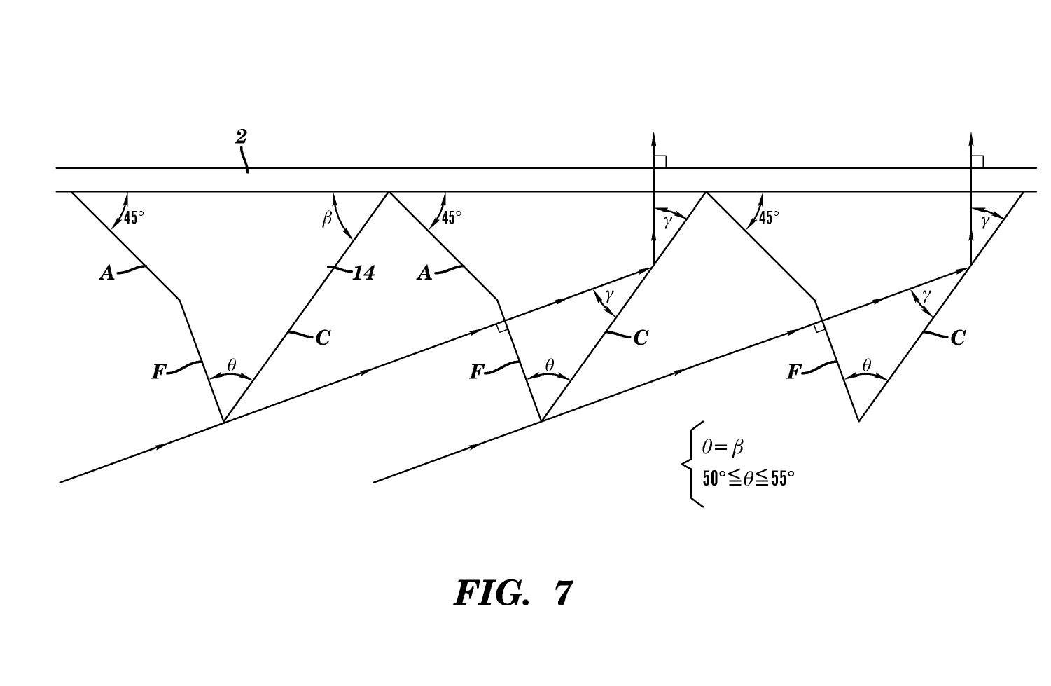

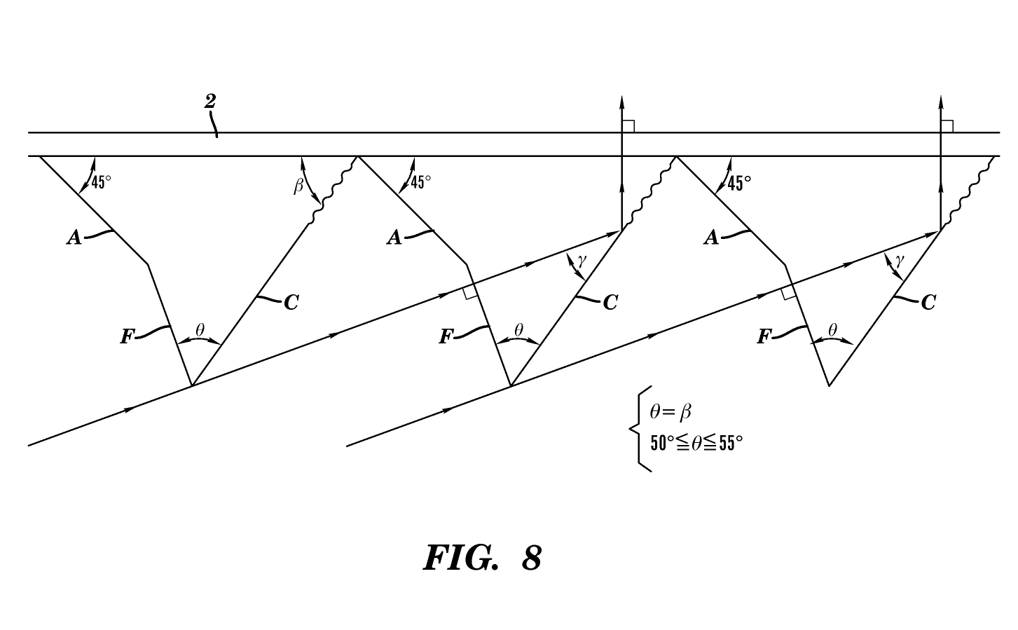

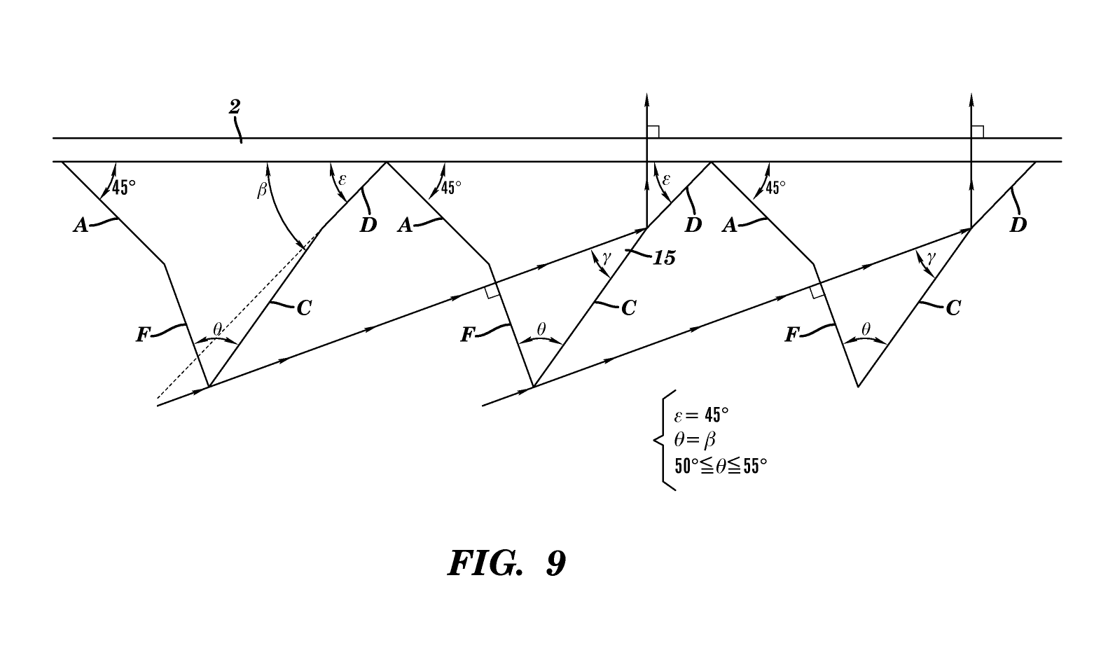

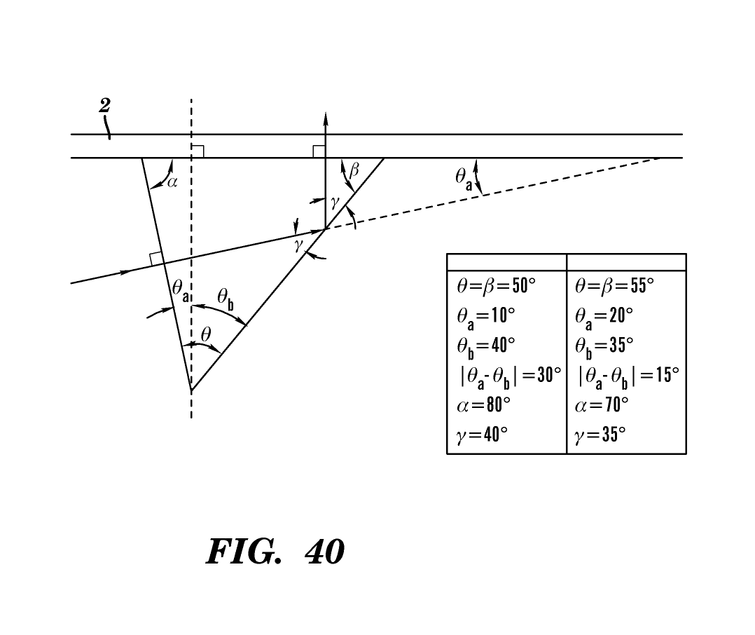

For the case of a downward isosceles triangular prism of FIGS. 4 and 40, a light must be incident perpendicularly from a steeply oblique surface of a prism, and thus such prisms are not suitable for the backlight optical systems as shown in FIGS. 14, 15 and 17. Since the light incident direction of FIGS. 4 and 40 is limited to a specific direction, therefore the deflection of the incident light will not be blocked, even if an oblique surface of a shaded portion without any direct incident light as shown in FIGS. 6 to 9 is used as a diffused surface, or the inclination is changed to 45 degrees. Particularly, in FIGS. 7 and 9, the angle of 45 degrees is formed at an oblique surface of a shaded portion without any direct incident light 45 degrees as shown in FIG. 36, and the function of returning the reflected light can be achieved to improve the brightness.

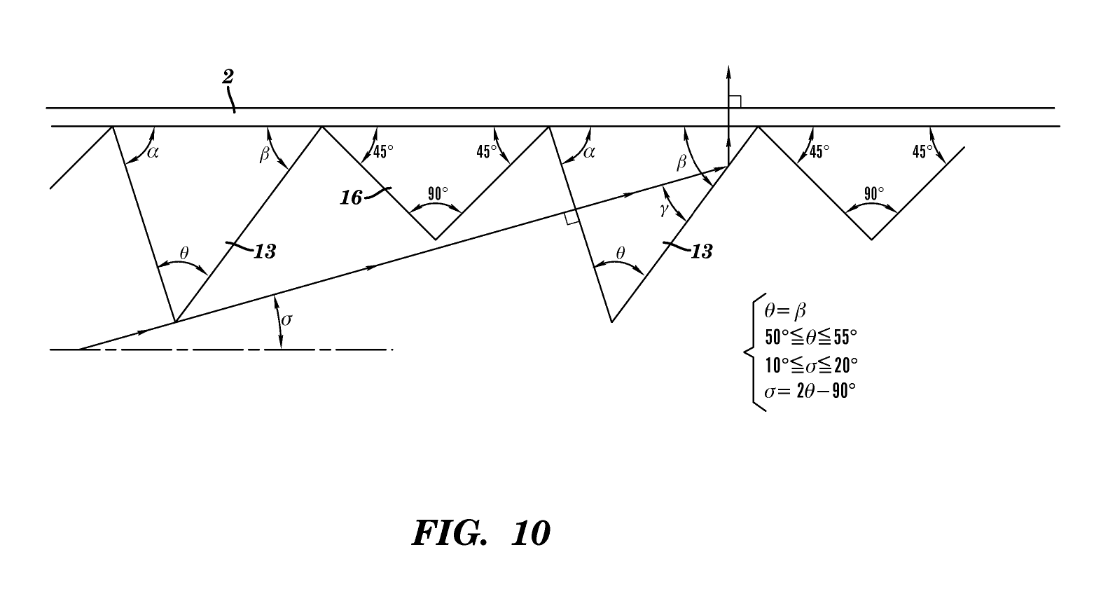

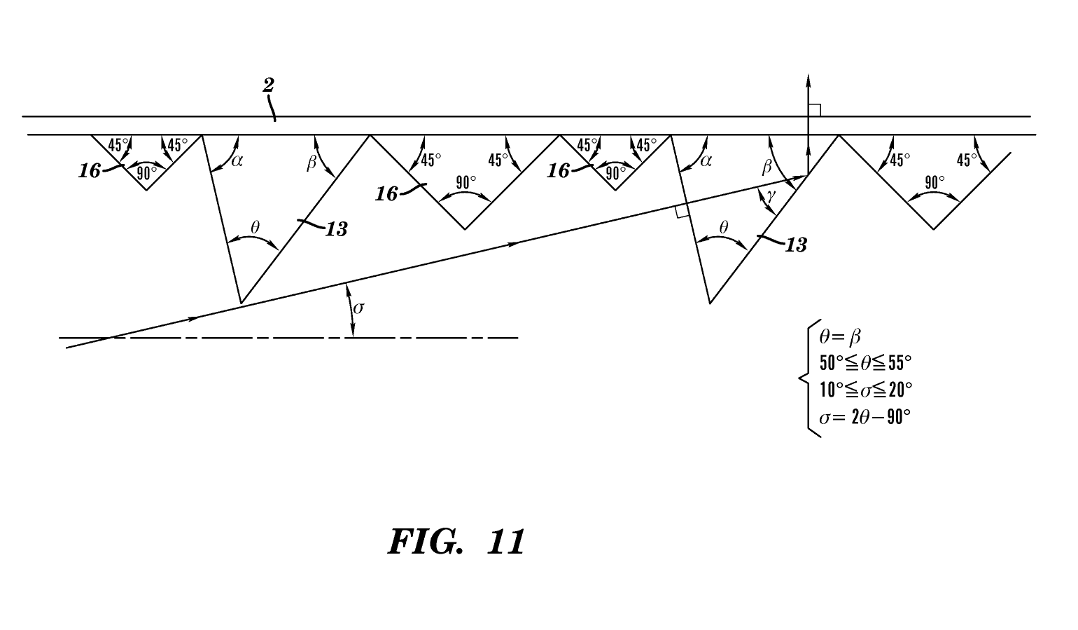

Referring to FIGS. 10 and 11 for cross-sectional views of a backlight adopting a downward prism sheet comprised of a plurality of prisms and having a light deflection function in accordance with Embodiment 10 of the present invention, the difference of this embodiment from Embodiment 9 resides on that the vertex angle Θ is formed by two different types of prisms. FIG. 10 shows an isosceles triangular prism with a vertex angle Θ from 50 degrees to 55 degrees, and a row of isosceles triangular prisms with a vertex angle of 90 degrees are arranged. FIG. 11 shows an isosceles triangular prism with a vertex angle Θ of 50 degrees to 55 degrees, and two rows of isosceles triangular prisms with a vertex angle of 90 degrees are arranged. This embodiment is characterized in that: an incident light will not be blocked by the vertex of the vertex angle of any composite prism sheet comprised of isosceles triangular prisms with a vertex angle of 90 degrees, and such vertex is lower than the vertex of a prism with a vertex angle Θ falling within a range from 50 degrees to 55 degrees and having a deflection function. Even if the prism sheet comprised of isosceles triangular prisms with a vertex angle of 90 degrees in accordance with Embodiment 9 does not exist, the light deflection function remains in this embodiment.

In an isosceles triangular prism with a vertex angle of 90 degrees as shown in FIG. 36, a light is incident at a lateral side of a substrate film in the same direction and reflected completely from two oblique surfaces of the prism, and the function of returning the reflected light in the same direction can be achieved. This function can improve the efficiency of light over the prism of Embodiment 9, provided that the prism sheet of FIGS. 10 and 11 is combined with a polarization conversion and separating film, so as to further improve the brightness. The prism with a vertex angle of 90 degrees can provide the best effect for returning the reflected light, but it is found that any isosceles triangular prism with a vertex angle ranging from 80 degrees to 110 degrees range has such reflection function that can improve the efficiency of light.

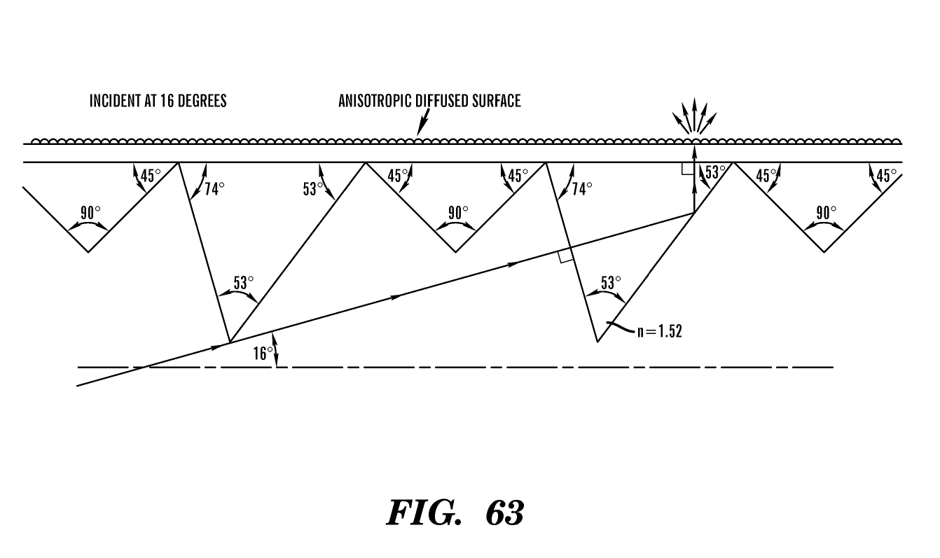

In a downward prism sheet of FIGS. 10 and 11, a strip light with a small divergent angle is incident, and reflected completely from an oblique surface of the prism, and the orientation of the light emitted perpendicularly from a surface of a substrate film is the same as that of Embodiment 9 to achieve the same effect as shown in FIG. 59. However, the orientation is changed as shown in FIG. 56. If an anisotropic diffusion function is added to the backside of a substrate film of the prism sheet as shown in FIG. 63, then an orientation as shown in FIG. 56 will be achieved, and the isosceles triangular prism with a vertex angle of 90 degrees will have the function of returning the reflected lights. Since the effect of the anisotropic diffused light will be weakened eventually, therefore the effect of improving the brightness is not good. As a result, the backside of the substrate film has the anisotropic diffusion function, and the orientation as shown in FIG. 59. After a light incident at the LCD passes through the LCD panel, a protective film of a polarizer installed at the surface of the LCD has the anisotropic diffusion function as well as the orientation of FIG. 56 for improving the efficiency of light to achieve the high-brightness display. To ensure the recognition of the direction of ±45 degrees, a film with the anisotropic diffusion function of the direction of ±45 degrees is added to the isotropic diffusion film or the orientation of FIG. 57 can be achieved when the film having the anisotropic diffusion function is added.

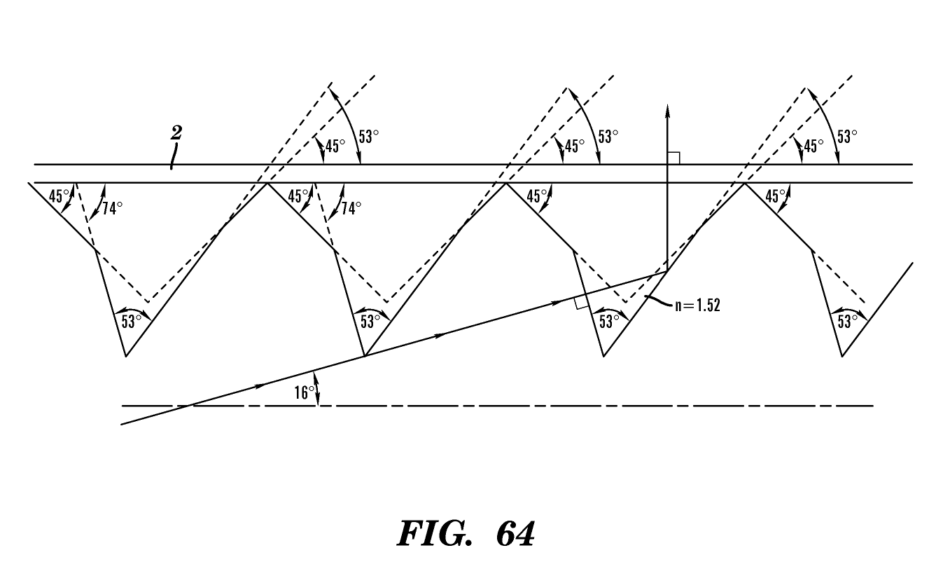

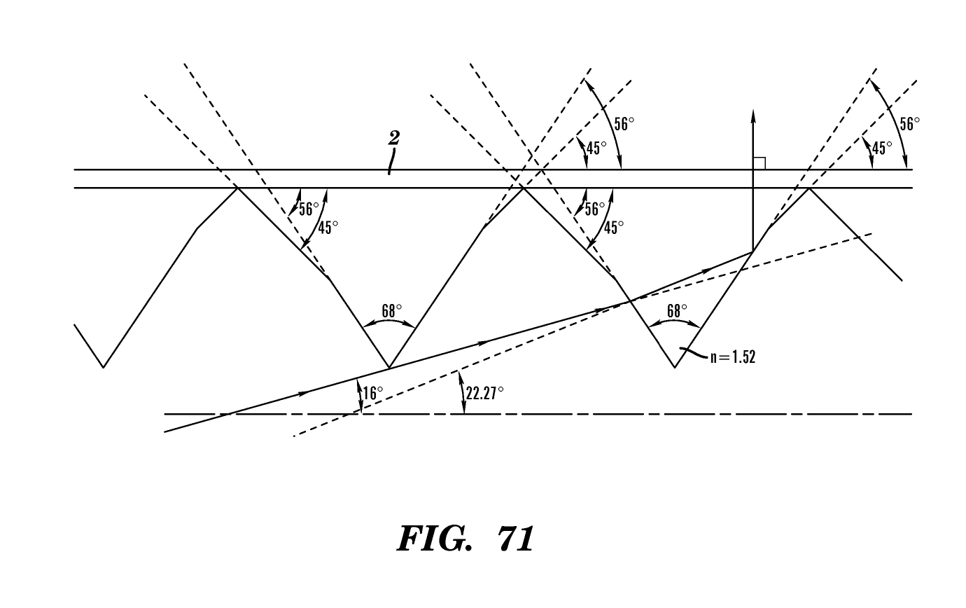

Referring to FIGS. 64 and 71 for cross-sectional views of a backlight system using downward prism sheet comprised of a plurality of pentagonal prisms and having a light deflection function in accordance with Embodiment 11 of the present invention, FIG. 64 shows a plurality of pentagonal prisms with a vertex angle of 53°, and the vertex angle is divided into two divided angles Θa=16 degrees and Θb=37 degrees wherein |Θa−Θb|=21 degrees, and the angle in contact with an oblique surface of a substrate film is equal to 45 degrees. A strip light is incident at 16 degrees to the substrate film and reflected completely from the oblique surface of the pentagonal prism and emitted perpendicularly from the substrate film. If the oblique surface of the substrate film is inclined to 45 degrees as shown in FIG. 36, the incident light at the backside of the substrate film will be completely reflected and returned in the incident direction, so as to have the same effect as illustrated in FIGS. 10 and 11. The vertex angle falls within a range from 50 degrees to 55 degrees and the absolute value of difference of the two divided angles Θa, Θb falls within a range of 15 degrees to 30 degrees, and the angle of the oblique plane of the surface of the substrate film ranges from 35 degrees to 50 degrees in the pentagonal prism. Therefore, as long as all of the strip lights incident at an angle of Θa in the substrate film and emitted perpendicularly from the substrate film, then such downward prism sheet comprised of pentagonal prisms and having the light deflection function can be used in the optical system of the present invention backlight system. The angle of an oblique plane in contact with a surface of the substrate film is preferably equal to 45 degrees. By adding the anisotropic diffused surface as shown in FIG. 63 to the backside of the substrate film, this embodiment can achieve the orientation of FIG. 56. FIG. 71 shows a plurality of pentagonal prisms with a vertex angle of 68 degrees, and the vertex angle is divided into two divided angles Θa−Θb=34 degrees, wherein |Θa−l73 Θb|=0 degree, and the angle in contact with an oblique surface of the substrate film is equal to 45 degrees. In FIG. 71, the strip light is designed to be incident in one direction, the oblique surface is not tilted to 45 degrees for the light deflection, and thus both left and right sides will not be symmetrical.

In FIGS. 64 and 71, a pair of substrate films is designed for the strip light to be incident at 16 degrees, and thus both have almost the same deflection function, but the vertex angle of FIG. 71 is large, which makes the manufacture of pentagonal prisms very easy and will not damage the vertex angle during the manufacturing process, and thus the design of FIG. 71 is used extensively for mass productions and improving the yield rate.

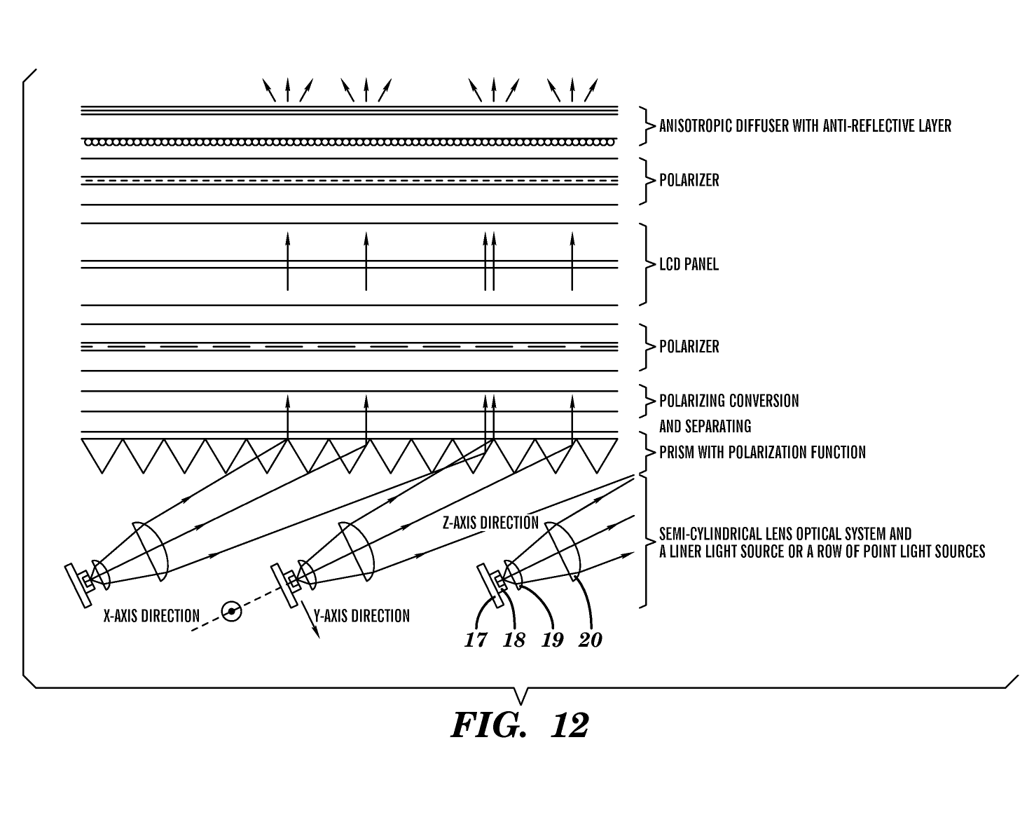

FIGS. 12, 34 and 35 are cross-sectional views of the installation of a plurality of strip lights to produce an optical system in accordance with the present invention, and the strip lights are incident at a prism sheet having a light deflection function, and the width of the strip light is amplified, and the traveling direction of the strip light towards the surface of the substrate film of the prism sheet is changed to a vertical direction, such that a plane light source is formed and used for the structure of a backlight light source of a liquid crystal display apparatus.

In FIG. 12, the prism sheet having the light deflection function changes the light traveling direction to a vertical direction of the surface of the LCD panel, and thus the orientation as shown in FIG. 59 can be achieved. As a result, an optical compensation film is no longer needed to solve the light leak problem in the direction of ±45 degrees of the viewing angle on the IPS or FFS horizontal field LCD panel. With the plate having the anisotropic diffusion function, the light diffusion of the polarizer can be equipped at the top of the LCD panel to provide the light with the orientation of FIG. 56 easily. In addition to such anisotropic diffusion function, the isotropic diffusion function can be used for changing the orientation to the orientation of FIG. 57 easily, and the anisotropic diffusion function and isotropic diffusion function are equipped on different layers, so that the direction of the viewing angle of ±90 degrees and the light quantity of the viewing angle in the direction of ±45 degrees can be adjusted freely, and the orientation of light can be designed freely according to different applications. The more powerful the anisotropic diffusion function and isotropic diffusion function, the lower is the brightness at the front of the LCD panel. Therefore, if the power consumption is minimized, a weak anisotropic diffusion function is added to the polarizer installed on the LCD panel as shown in FIGS. 32 and 33, then the cost can be lowered, and maximum brightness and contrast at the front of the LCD panel can be achieved.

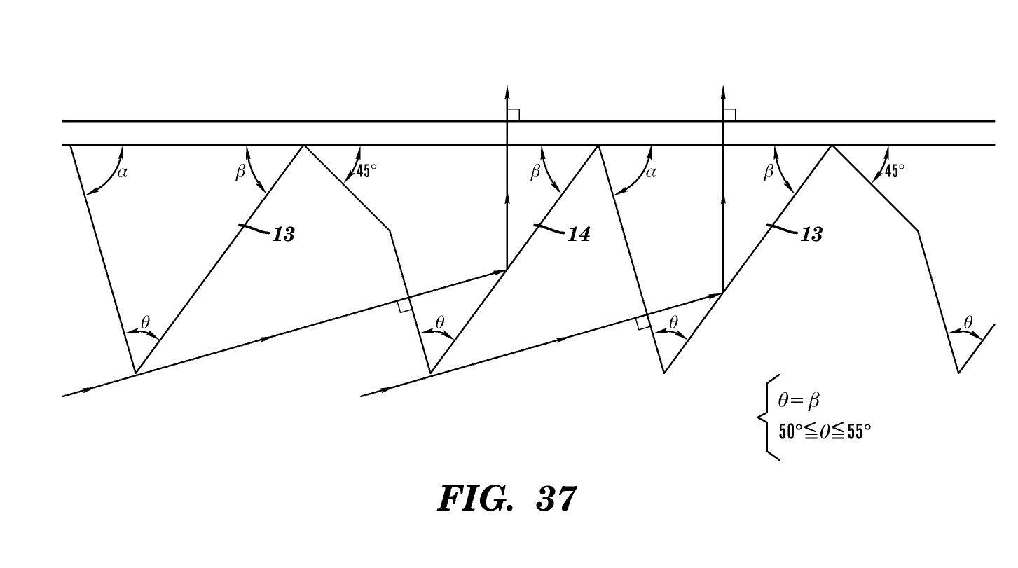

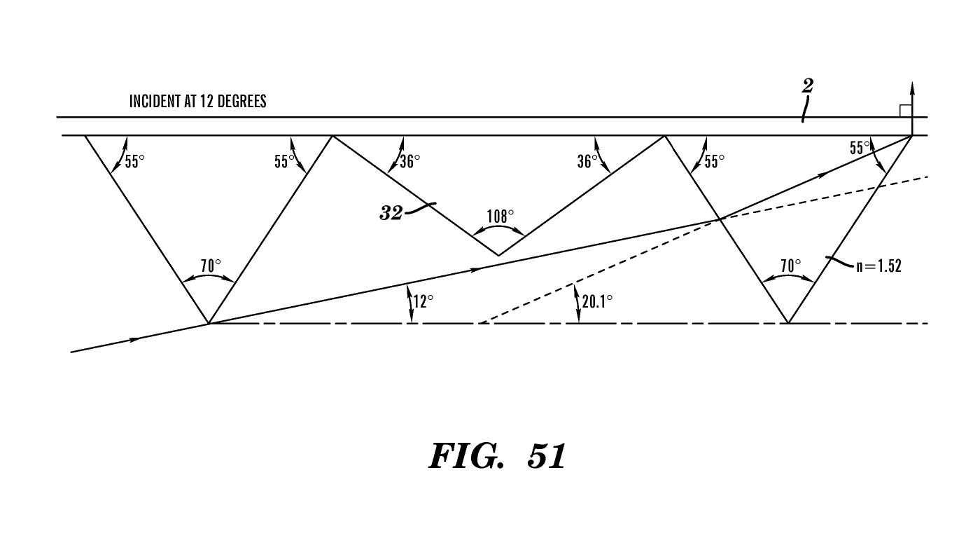

In FIG. 12, the prism sheet also comes with a structure with the function of returning the reflected light, in addition to having the light deflection function as shown in FIGS. 7 to 11, 37, 44 to 46, 51, 64 and 71, so that the chance of reusing the reflected light coming from a polarization separation film is improved. The surface of the polarization separation film is made with a mirror surface for displaying images with high brightness and contrast.

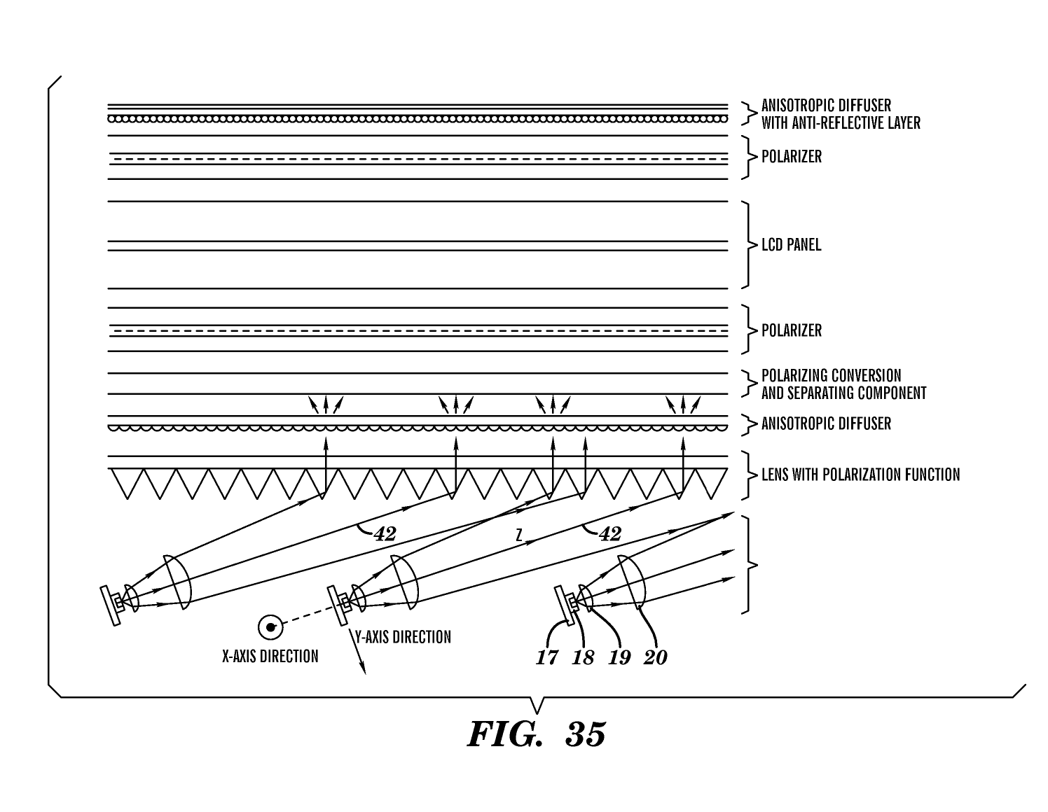

FIG. 35 shows an anisotropic diffuser installs between a prism sheet having a light deflection function and a polarization separation plate, such that the reflected light can be reflected repeatedly for many times by the polarization separation plate to improve the chance and efficiency of using the light, and provide an even brightness for each strip-like light source. The orientation of the light passing through the anisotropic diffuser is changed from the orientation of FIG. 50 to the orientation of FIG. 56. With the orientation of FIG. 56, the light in the direction of ±45 degrees will not be increased even for the IPS and FFS modes, and thus light leaks will not occur at the viewing angle in the direction of ±45 degrees or the contrast will not be lowered. After the light passing through the LCD panel and the polarizer installed on the LCD panel, the anisotropic diffuser or isotropic diffuser in the direction of ±45 degrees can achieve the orientation of FIG. 57.

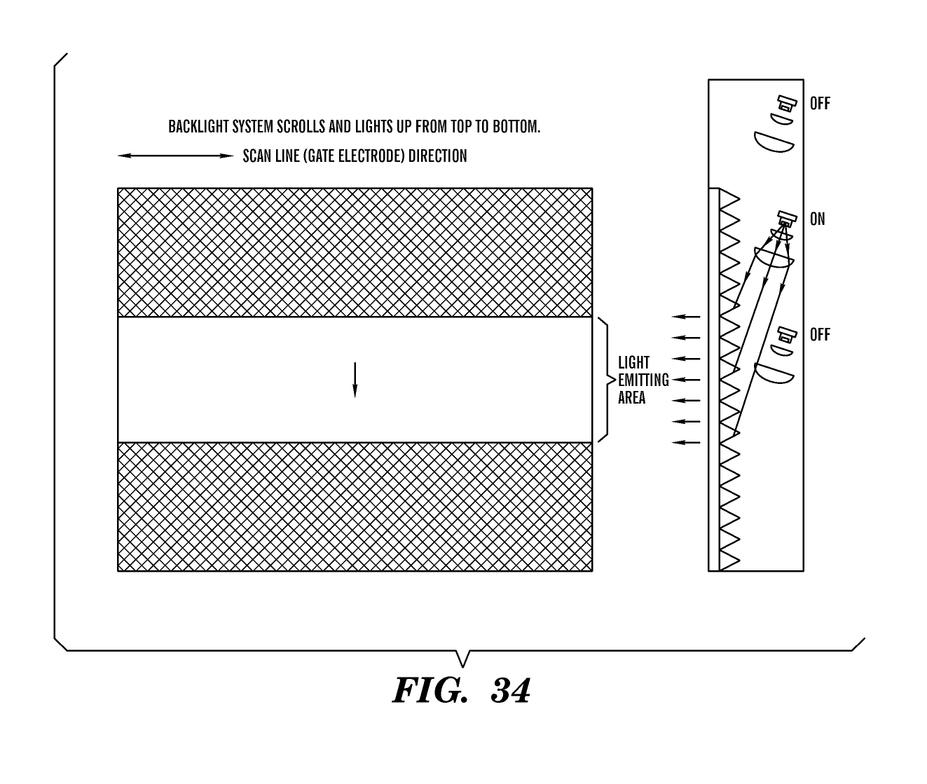

FIG. 34 shows a cross-sectional view of a linear light source or a row of point light sources coming from the top of the screen of the LCD panel towards the bottom to scroll, light up and drive the LCD panel in accordance with the present invention. Since the present invention can use a DC pulse driven LED or an inorganic EL as a light source, therefore it is very easy to use a low-cost circuit for scrolling, lighting up and driving the LCD panel. As to the delay of response time of the liquid crystal molecules, a response delay time from 2 to 10 ms usually occurs, and thus the problem of having a blurred image arises when the video image is moved quickly in a display. However, the liquid crystal molecules can complete the response delay time and give a bright backlight to improve the blurring image profile, after the present invention stops rewriting video data to the LCD panel. Since the present invention has to control the traveling direction of the light coming from the light source precisely, therefore it is important to arrange the light emitting portions of the white color LED light sources as shown in FIGS. 47 to 50 and 54 along the direction of the light source. By reducing width of the light source along the y-axis of the optical system for producing the strip light, the traveling direction on the Y-Z plane can be controlled precisely. To prevent decreasing the light intensity, an LED chip as shown in FIG. 54 is designed in a slender shape to increase the light emitting area and ensure the light intensity. Since the present invention has not adopted the completely diffused light (or isotropic diffused light) for the backlight of the prior art LCD TV or used it as the starting point of the optical system of the backlight as shown in FIG. 55, therefore unnecessary electric power consumption on invalid light can be avoided to save electric power.

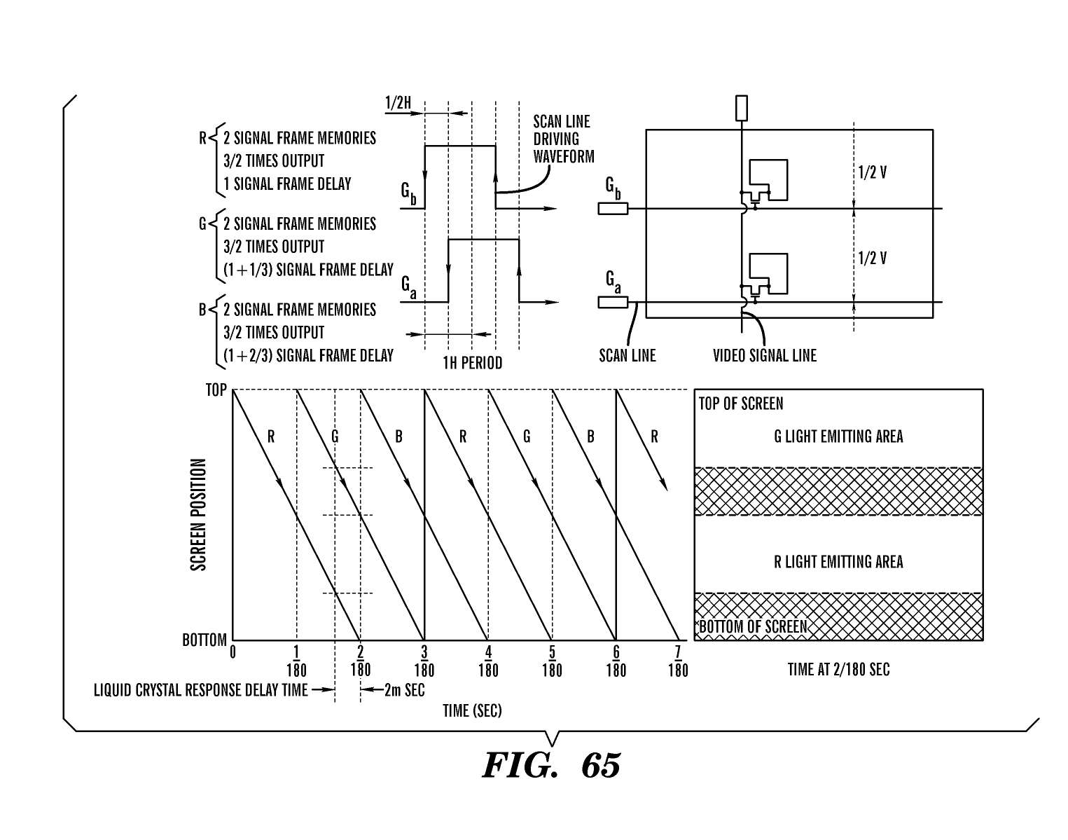

Referring to FIG. 65 for the illustration of the principle of a biplex (multiplex) driving field-order LCD panel in accordance with Embodiment 13 of the present invention, an 1H (or horizontal scan) period is divided into halves, and two separate ½V scan lines are selected to alternate the off time by ½H. During the division of the horizontal time into halves, video signals are divided into different colors, and written into a separate ½V pixel along the vertical direction (V-direction). The time for the scan lime to write in the video data can be reduced to one half by adopting this method, and the foregoing field order driving method has the problems of installing additional circuits for driving video signals, and increasing the timing frequency of a driver IC by three times. If the biplex driving method of this embodiment is adopted, the increase of the timing frequency can be reduced to 1.5 times.

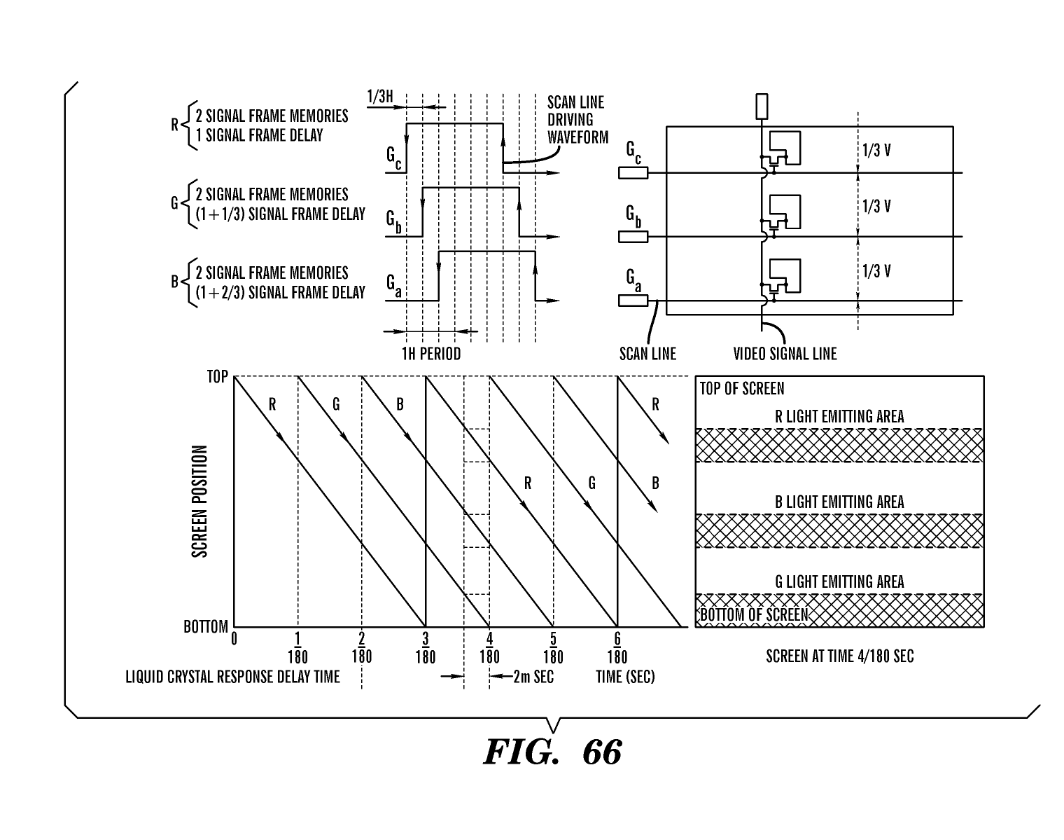

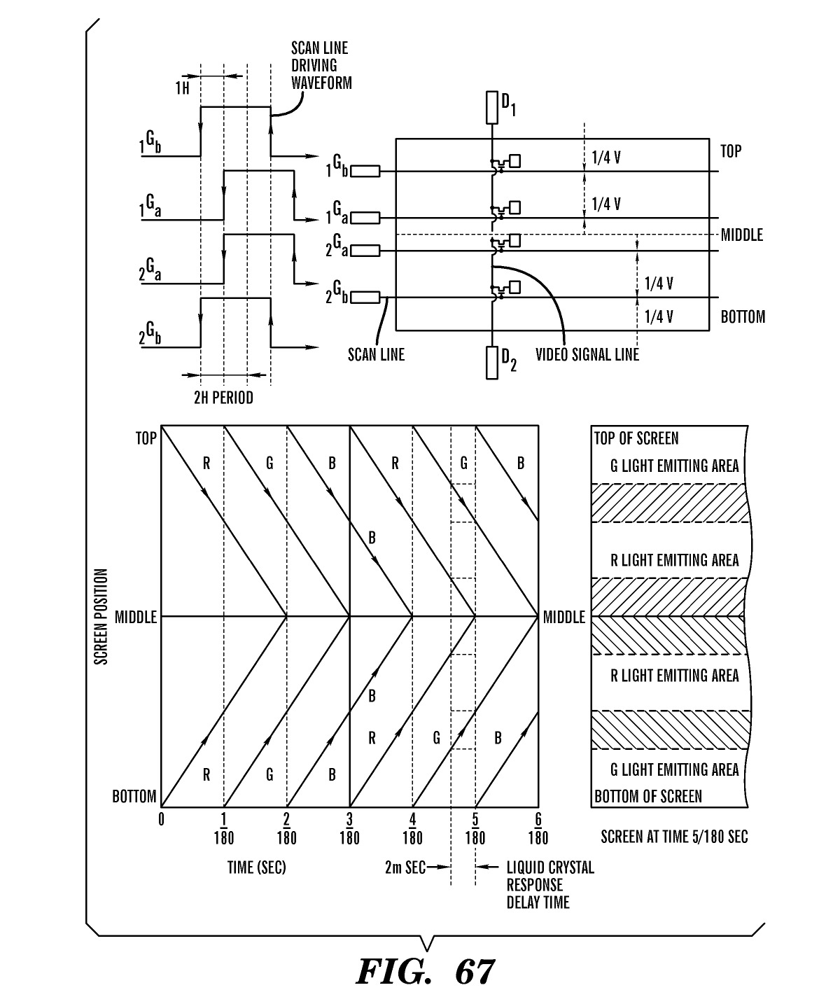

FIG. 66 illustrates the principle of a triplex (multiplex) driving field-order LCD panel of the present invention. An 1H (or horizontal scan) period is divided into ⅓, and three separate ⅓V scan lines are selected for alternating the off timing into ⅓H. During the time of dividing the horizontal period into ⅓H, video signals are divided into different colors, and written into a separate ⅓V pixel along the vertical direction (V-direction). This method is characterized in that: the time for the scan line to write in video data is reduced to one third, and the timing frequency can be equal to those used for the foregoing color filter panel.

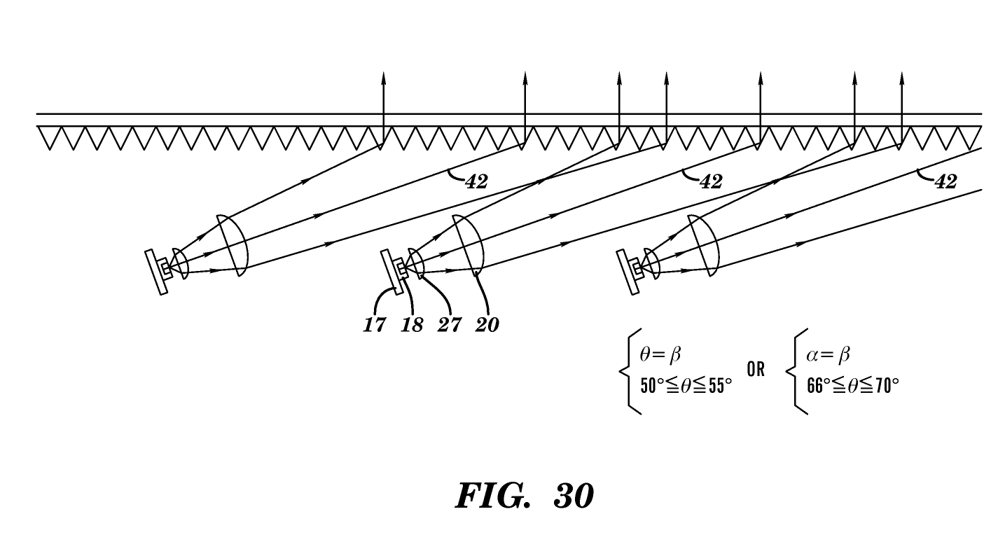

From FIGS. 65 and 66, as the quantity of multiplexes increases, the number of dividing the display screen increases. The biplex driving method can divide the screen into at most 5 sections. The triplex driving method can divide the screen into at most 7. From the timing and screen position diagram, we understand that each light emitting area of a color division is scrolled and driven from the top of the screen towards the bottom. To carry out the scroll successfully, it is necessary to divide the backlight in the V-direction (vertical direction as many as possible for the scrolling. If a cold cathode fluorescent lamp (CCFL) method is used, then the quantity of lamps has to be increased. When the scrolling or driving process is conducted, it is necessary to drive all lamps separately and light up each of the three primary colors individually. As a result, the quantity of the lamps must be increased and a very high cost of the backlight system will be incurred. If a field order driven backlight light source adopts the scrolling method, it is most appropriate to use the three primary colors R, G, B for the LED light source. To maintain the number of LEDs constant, the number of divided portions in the V-direction (vertical direction) is increased, provided that the density of the LEDs along the horizontal direction is decreased. The best optical system for providing a light source is an optical system produced by strip lights from a curved reflective lens system as shown in FIGS. 16, 24 and 39, and the row of point light sources is shown in FIGS. 30 and 58.

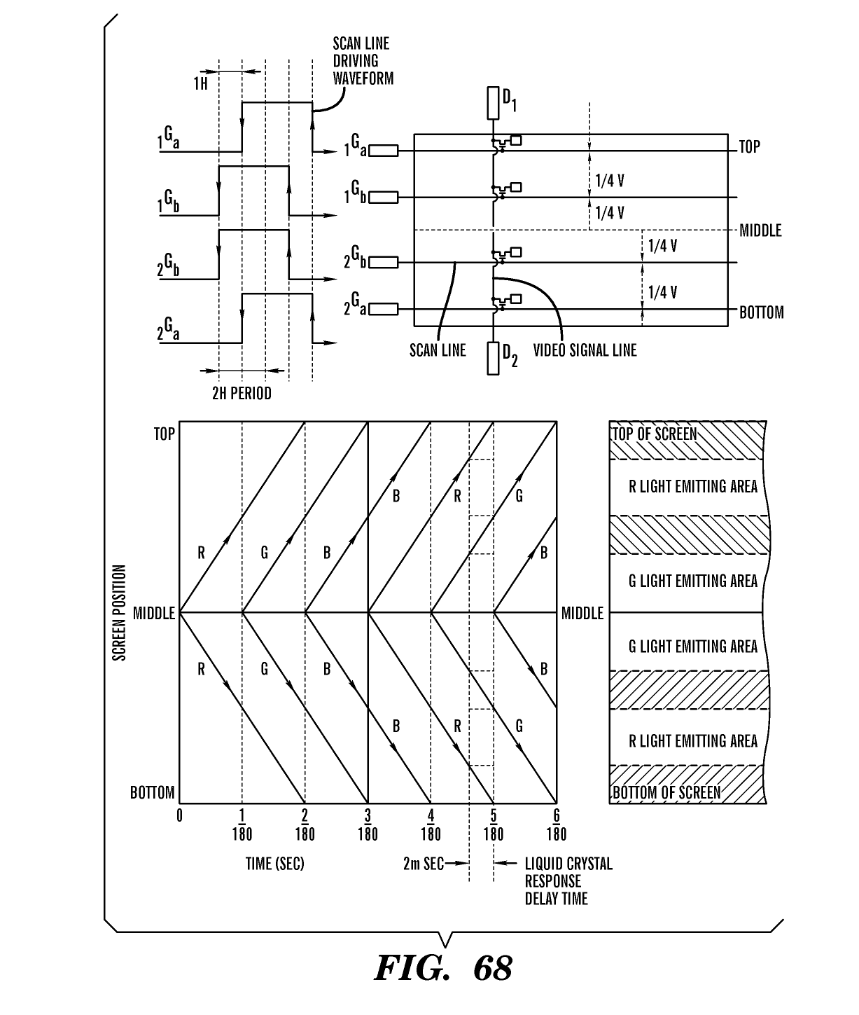

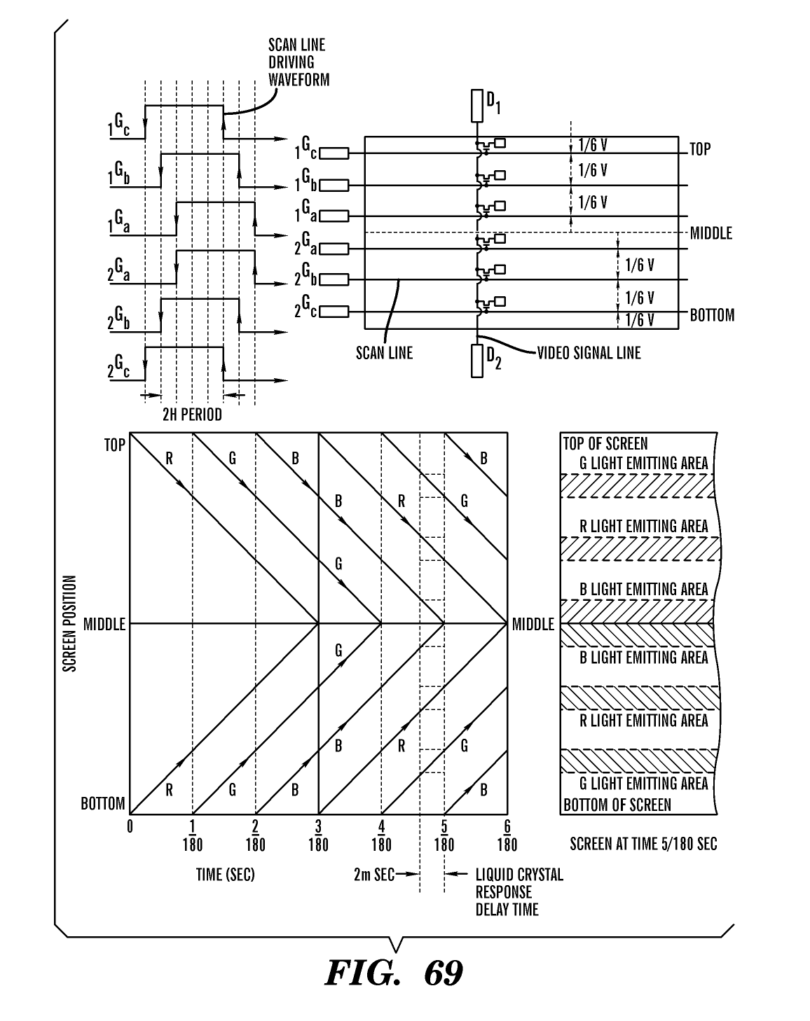

FIGS. 67 and 68 illustrate the principle of a biplex (or multiplex) driving field-order LCD panel in accordance with Embodiment 14 of the present invention, and a screen is divided into top and bottom of the screen, which are used for a high-resolution with a large number of scan lines. There are 1080 high-resolution scan lines, and thus its 1H (or horizontal scan) period is as short as 15.4 μsec. If the scan period is divided into ½ by the method as illustrated in FIG. 65, the time allowed for rewriting data is equal to 7.7 μsec. The major problem resides on the signal delay time of the video signal lines. If the scan period is divided into ⅓ by the method as illustrated in FIG. 66, he time allowed for rewriting data is equal to 5.1 μsec. For a large 100-inch LCD TV, both capacitance and resistance of its video signal line are large, and thus the method as illustrated in FIGS. 65 and 66 cannot achieve the expected performance. In FIGS. 67 and 68, the horizontal scan period of the scan line is doubled, and thus it should be divided into ½, and the time allowed for rewriting data is equal to 15.4 μsec. From the figures, it is understood that the length of the video signal line is halved, and the capacitance and resistance are also halved, and thus all these parameters fall within a sufficiently driven range.

To divide the video signal line divided into top and bottom, the quantity of video signal line as shown in FIGS. 67 and 68 must be two times of that of FIGS. 65 and 66. Therefore, the number of ICs used for driving the video signal line as shown in FIGS. 67 and 68 must be two times of that of FIGS. 65 and 66. An increase of cost is inevitable. If the foregoing color filter LCD panel is adopted, three group sets of (R, G, B) video signal lines are needed. Therefore, the number of video signals required for the panel as shown in FIGS. 65 and 66 will be three times, even if the quantity of video signal lines of FIGS. 67 and 68 is two times of that of FIGS. 65 and 66, and the increase of video signal lines is not as serious as the aforementioned case.

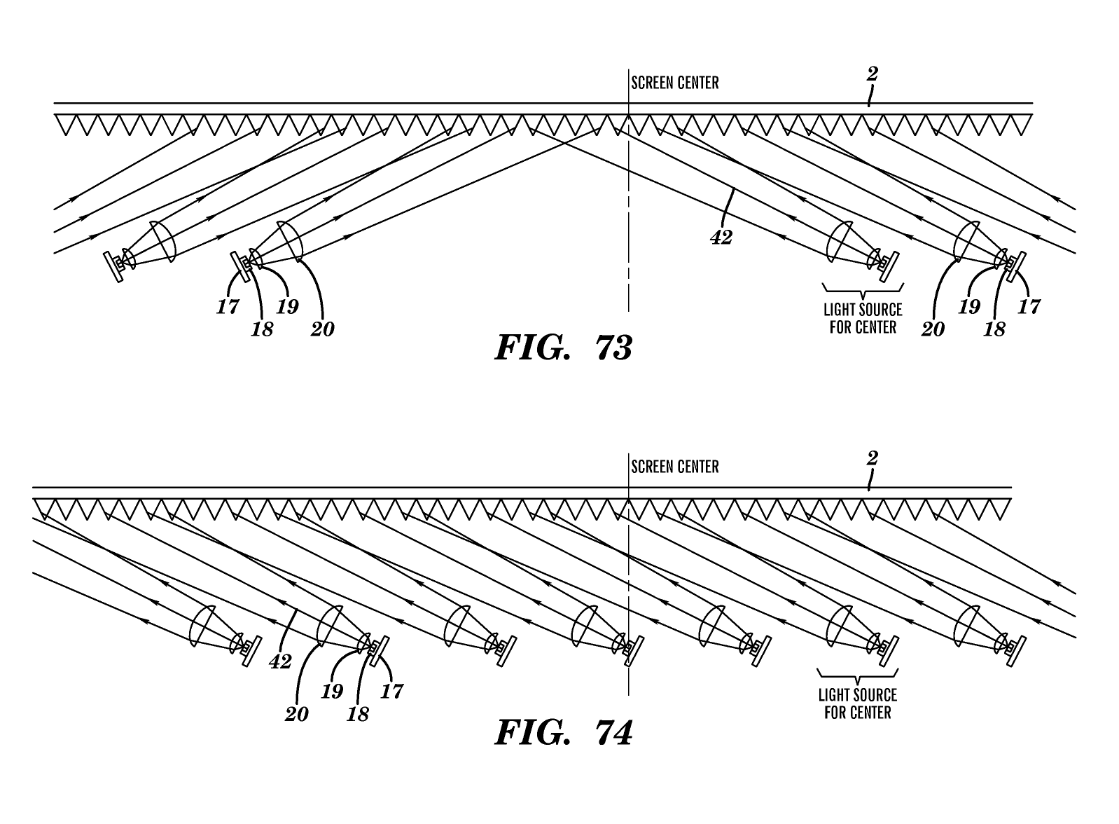

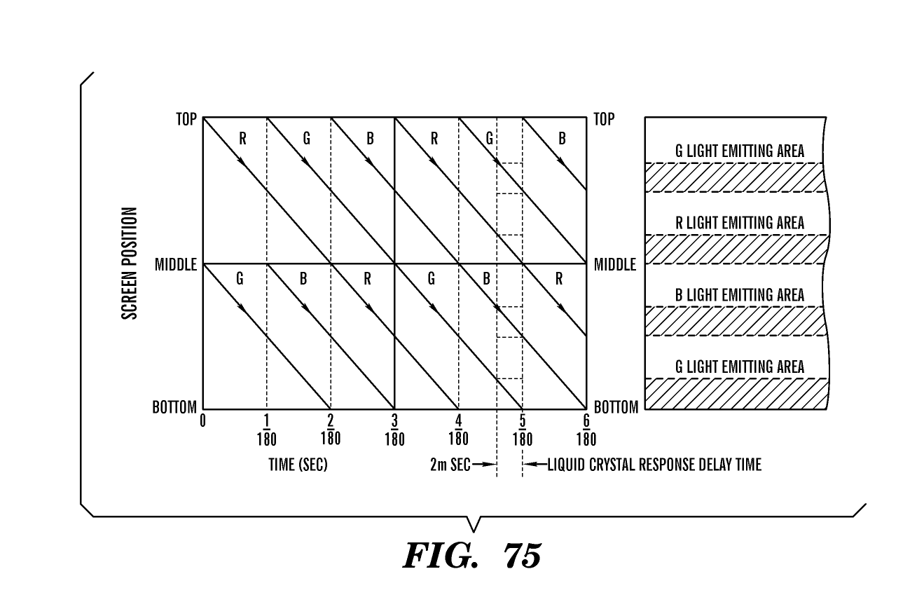

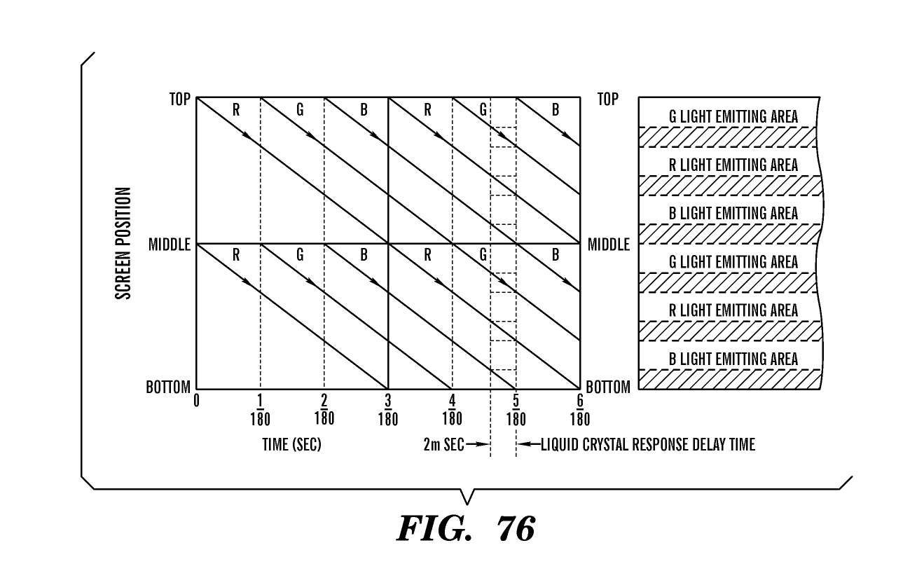

From the key points of FIGS. 67 and 68, and the diagrams of screen position and timing, it is understood that the center of the screen is selected for driving the scan line linearly and symmetrically. Such method centralizes the light emitting areas of the same color at the center of the screen center as shown in FIGS. 73 and 75, and a light source can be installed for emitting light at the center of the screen to prevent any mixed color at the center of the screen.

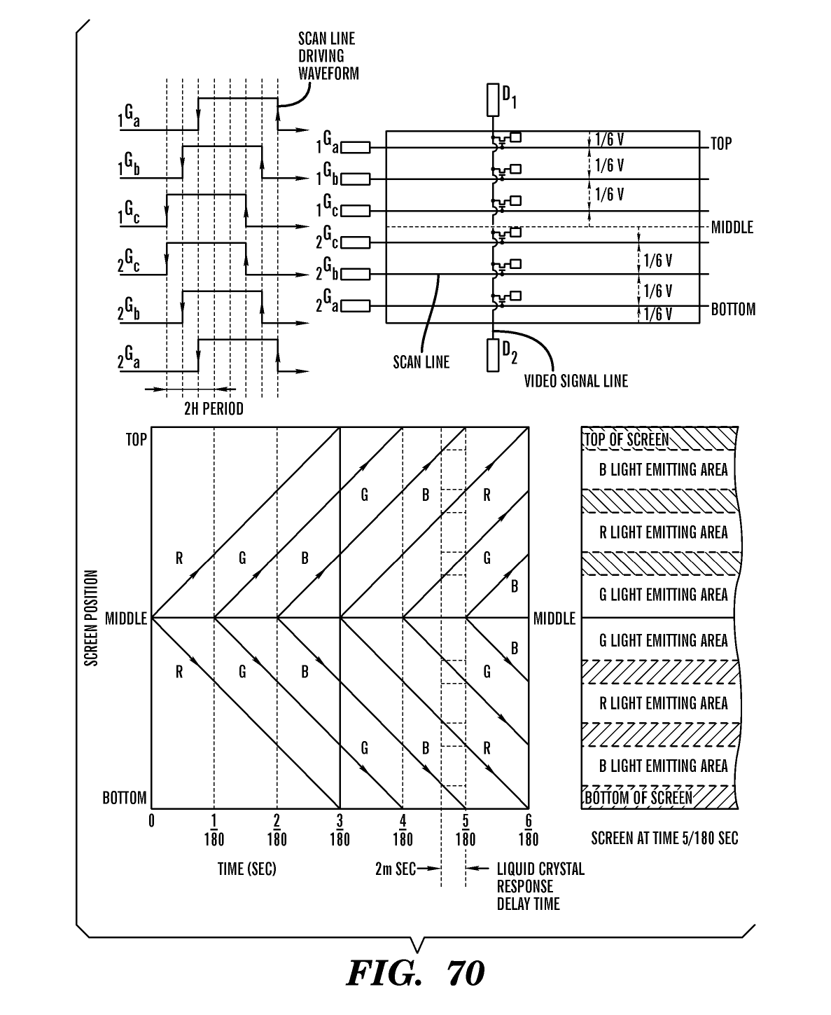

FIGS. 69 and 70 illustrate the principle of dividing a screen into top and bottom for a triplex (multiplex) driven field-order LCD panel in accordance with the present invention. In FIGS. 69 and 70, the horizontal scan period of the scan line is doubled, and thus the scan period is divided into ⅓, the time allowed for rewriting data is equal to 10.21 μsec. From the figures, it is understood that the length of the video signal line is halved, and thus the capacitance and resistance are also halved for maintaining these parameters within a sufficiently driven range. The overall light emission of the screen can be divided into at most 13 emissions, which is larger than an increase of 9 as illustrated in FIGS. 67 and 68. The light emitting areas can be scrolled and driven from the top to the bottom of the screen for a comprehensive scroll by the method as illustrated by the diagrams of FIGS. 75 and 76. For cases of FIGS. 75 and 76, even if the light emitting portions of the backlight can be scrolled and driven successfully, the phenomenon of block divisions may occur easily at the center of the screen, and thus such method is not suitable for evenly driving a large screen display. If the screen display is driven by the method as shown in the diagrams of FIGS. 67 to 70, no block division will occur at the center of the screen theoretically. Therefore, the field order driven method can be used for an even large screen display.

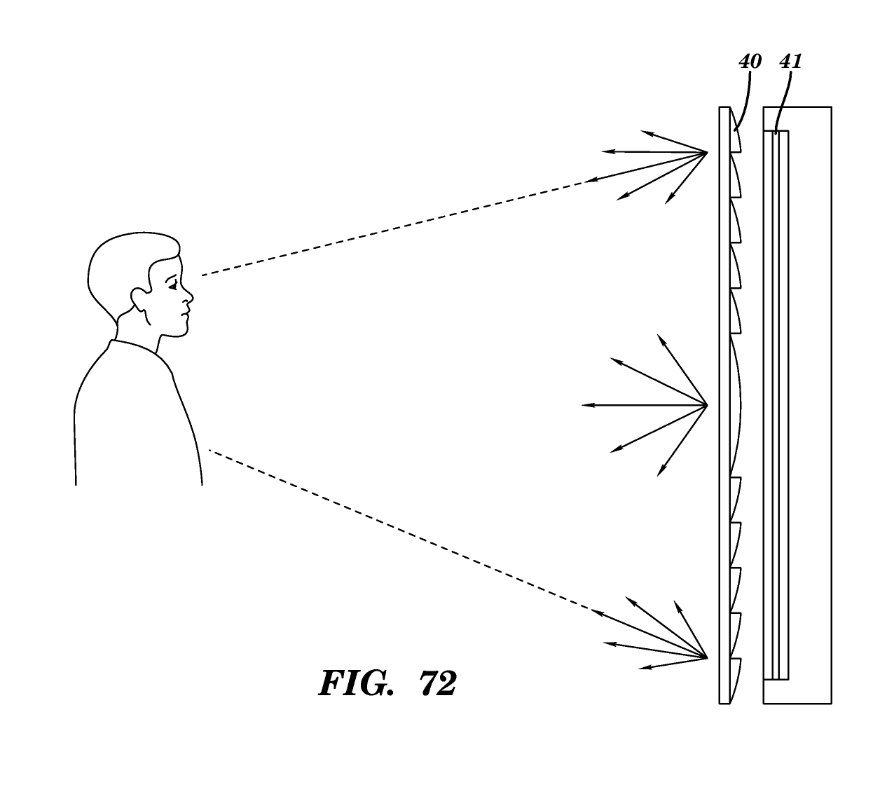

If the backlight light source of the present invention is adopted, the z-axis of a light source unit can be adjusted precisely from the top of the screen to the center of the screen, or from the bottom of the screen to the center of the screen as shown in FIG. 72, without using a Fresnel lens to achieve the effect of adjusting the orientation of lights for the aforementioned large Fresnel Lens. For large 100-inch screen display apparatus, the light must be gathered in the direction of the viewer, so as to achieve the function of adjusting the overall brightness of the screen.

The claims are as follows:

1. A backlight optical system for a large liquid crystal display apparatus, characterized in that: a plurality of strip lights are set in parallel with each other to produce an optical unit comprising a linear light source or one row of point light sources, and a plurality of semi-cylindrical lenses, and the divergent angle of a light along the direction of an optical axis (or z-axis) of said semi-cylindrical lens is controlled within a range from 2 degrees to 8 degrees, and the reflecting direction of said plurality strip lights is arranged in the same direction and set on a prism sheet comprised of a plurality of prisms with a light deflection function of said LCD panel, and said strip lights are incident at an incident angle from 10 degrees to 24 degrees measured from a plane of said LCD panel, and an oblique surface of said prism of said prism sheet reflects said strip lights completely in a direction substantially perpendicular to a plane of said LCD panel.

2. A backlight optical system for a large liquid crystal display apparatus, characterized in that: the directions of reflection of a light coming from a curved reflective condensing lens is the same, and a plurality of strip lights are set in parallel with each other to produce an optical unit comprising a linear light source or a row of point light sources, more than one semi-cylindrical lens and one curved reflective condensing lens, and the divergent angle of the light is controlled within a range from 2 degrees to 8 degrees, and installed parallelly on a prism sheet comprised of a plurality of prisms with a light deflection function of an LCD panel, and said strip lights are incident at an incident angle from 10 degrees to 24 degrees measured from a plane of said LCD panel, and an oblique surface of said prism of said prism sheet reflects said strip lights completely in a direction substantially perpendicular to a plane of said LCD panel.

3. A backlight optical system for a large liquid crystal display apparatus, characterized in that: the directions of reflection of a light are opposite to each other and a plurality of strip lights are alternately and parallelly arranged to produce an optical unit comprising a linear light source or a row of point light sources, and a plurality of semi-cylindrical lenses, and the divergent angle of a light along the direction of an optical axis (or z-axis) of said semi-cylindrical lens is controlled within a range from 2 degrees to 8 degrees, and installed parallelly on a prism sheet comprised of a plurality of prisms with a light deflection function of an LCD panel, and said strip lights are incident from a strip light source at an end with an incident angle from +10 degrees to +24 degrees and from a strip light source at another end with an incident angle from −10 degrees to −24 degrees measured from a plane of said LCD panel, and an oblique surface of said prism of said prism sheet reflects said strip lights completely in a direction substantially perpendicular to a plane of said LCD panel.

4. A backlight optical system for a large liquid crystal display apparatus, characterized in that: the directions of reflection of a light are opposite to each other and a plurality of strip lights are alternately and parallelly arranged to produce an optical unit comprising a linear light source or a row of point light sources, a semi-cylindrical lens and a curved reflective condensing lens, and the divergent angle of a light is controlled within a range from 2 degrees to 8 degrees, and installed parallelly on a prism sheet comprised of a plurality of prisms with a light deflection function of an LCD panel, and said strip lights are incident from a strip light source at an end with an incident angle from +10 degrees to +24 degrees and from a strip light source at another end with an incident angle from −10 degrees to −24 degrees measured from a plane of said LCD panel, and an oblique surface of said both prisms of said prism sheet reflects said strip lights of opposite directions completely in a direction substantially perpendicular to a plane of said LCD panel.

5. A backlight optical system for a large liquid crystal display apparatus, characterized in that: a plurality of optical units are installed in parallel with each other and comprised of two opposite linear light sources or two rows of opposite point light sources, and two semi-cylindrical lenses and one cylindrical lens corresponding to said each light source, and the divergent angle of a light along the direction of an optical axis (or z-axis) produced by said semi-cylindrical lenses is controlled to pass through said cylindrical lenses and limited within a range of 2 degrees to 8 degrees, and said two strip lights are intersected at an area of said cylindrical lens and installed parallelly on a prism sheet comprised of a plurality of prisms with a light deflection function of an LCD panel, and said strip lights are incident from a strip light source at an end with an incident angle from +10 degrees to +24 degrees and from a strip light source at another end with an incident angle from −10 degrees to −24 degrees measured from a plane of said LCD panel, and an oblique surface of said both prisms of said prism sheet reflects said strip lights of opposite directions completely in a direction substantially perpendicular to a plane of said LCD panel.

6. The backlight optical system of claims 1, 2, 3, 4 or 5, wherein said linear light source or said row of point light sources is comprised of an inorganic EL or an organic EL that generates a white light or three primary color (R, G, B) lights, and a light emitting portion is in a strip-like shape, and a strip-like light emitting area is installed parallelly with the lengthwise direction (or x-axis direction) of said semi-cylindrical lens.

7. The backlight optical system of claims 1, 2, 3, 4 or 5, wherein said row of point light sources is comprised of an LED that generates a white light or three primary color (R, G, B) lights, and a light emitting portion of said LED is in a strip-like shape, and said strip-like light emitting area is installed parallelly with the lengthwise direction (or x-axis direction) of said semi-cylindrical lens.

8. The backlight optical system of claims 1, 2, 3, 4 or 5, further comprising an anisotropic diffusion function for diffusing a light comes from said linear light source or said row of point light sources and incident to a plane of said semi-cylindrical lens at a lengthwise direction of said semi-cylindrical lens.

9. The backlight optical system of claim 2, wherein said curved reflective condensing lens is integrated with a cooling device for cooling a light source of said linear light source or said row of point light sources.

10. The backlight optical system of claim 2, wherein said curved reflective condensing lens, a cooling device for cooling a light source of said linear light source or said row of point light sources and said semi-cylindrical lens are integrated.

11. The backlight optical system of claims 1 or 3, wherein said plurality of semi-cylindrical lenses are integrated with a cooling device for cooling a light source of said linear light source or said row of point light sources, and a lateral side of a semi-cylindrical lens keeper for the interstate is connected to a backlight frame for determining an incident angle of the light of said semi-cylindrical lens incident to said prism sheet with respect to a central axis (or z-axis).

12. The backlight optical system of claims 1, 2, 3, 4 or 5, wherein said row of prisms is formed at a lateral surface of said light source by a prism sheet comprised of a plurality of prisms having a light deflection function, and the vertex angle Θ of said prisms falls within a range from 60 degrees to 70 degrees, and the vertex angle of said prism is divided into two divided angles Θa and Θb such that |Θa−Θb|=0 degree for said isosceles triangular prism.

13. The backlight optical system of claims 1 or 2, wherein said row of prisms is formed at a lateral surface of said light source by a prism sheet comprised of a plurality of prisms having a light deflection function, and the vertex angle Θ of said prism falls within a range from 50 degrees to 55 degrees, and the absolute value of the difference between two divided angles Θa and Θb of the vertex angle of said isosceles triangular prism falls within a range from 15 degrees to 30 degrees.

14. The backlight optical system of claim 1, 2, 3, 4 or 5, further comprising a row of prisms formed at a lateral surface of said light source by a prism sheet comprised of a plurality of different prisms having a light deflection function, and alternately installing said prisms with the vertex angle Θ falling within a range from 60 degrees to 70 degrees, and said isosceles triangular prisms with the vertex angle divided into two divided angles Θa, Θb and |Θa−Θb|=0 degree; and the vertex angle Θ of said isosceles triangular prism falls within a range from 80 degrees to 110 degrees, and the vertex of the vertex angle Θ ranging from 80 degrees to 110 degrees of said isosceles triangular prism is lower than the vertex of the vertex angle Θ ranging from 60 degrees to 70 degrees of said isosceles triangular prism.

15. The backlight optical system of claims 1 or 2, wherein said row of prisms is formed at a lateral surface of said light source by a prism sheet comprised of a plurality of rows of different prisms having a light deflection function, for alternately installing said prisms with the vertex angle Θ falling within a range from 50 degrees to 55 degrees, and said isosceles triangular prisms with the vertex angle divided into two divided angles Θa, Θb and the absolute value of the difference between said two divided angles Θa, Θb falls within a range from 15 degrees to 30 degrees; and the vertex angle Θ of said isosceles triangular prism falls within a range from 80 degrees to 110 degrees, and the vertex of the vertex angle Θ ranging from 80 degrees to 110 degrees of said isosceles triangular prism is lower than the vertex of the vertex angle Θ ranging from 50 degrees to 55 degrees of said isosceles triangular prism.

16. The backlight optical system of claims 1, 2, 3, 4 or 5, wherein said row of prisms is formed at a lateral surface of said light source by a prism sheet comprised of a plurality of rows of prisms having a light deflection function, and an anisotropic diffusion function is added to the surface of the backside of said LCD, such that the light can be diffused along an orthogonal direction extended from a prism of said rows of prisms.

17. The backlight optical system of claims 1, 2, 3, 4 or 5, wherein said linear light source or said row of point light sources is set parallelly in the same direction of the lengthwise direction of a scan line (or gate electrode) of said LCD panel.

18. The backlight optical system of claims 1, 2, 3, 4 or 5, wherein said linear light source or said row of point light sources is set parallelly in the same direction of the lengthwise direction of a scan line (or gate electrode) of said LCD panel, and a prism sheet comprised of a plurality of rows of prisms having a light deflection function is set substantially in the same direction of a scan line (or gate electrode) of said LCD panel, such that the vertex of the vertex angle of said prism can be extended.

19. The backlight optical system of claims 1, 2, 3, 4 or 5, wherein said linear light source or said row of point light sources is arranged parallelly along the same direction with an absorption axis or a transmission axis of a polarizer of said LCD panel.

20. The backlight optical system of claims 1, 2, 3, 4 or 5, said linear light source or said row of point light sources is arranged parallelly along the same direction with an absorption axis or a transmission axis of a polarizer of said LCD panel, and a prism sheet comprised of a plurality of rows of prisms having a light deflection function is arranged parallelly in the same direction of said linear light source or said row of point light sources, such that the vertex of the vertex angle of said prism can be extended.

21. The backlight optical system of claims 1, 2, 3, 4 or 5, wherein said linear light source or said row of point light sources is set parallelly in the same direction of a transmission axis or reflection axis of a polarization conversion and separation plate.

22. The backlight optical system of claims 1, 2, 3, 4 or 5, wherein said linear light source or said row of point light sources is set parallelly in the same direction of a transmission axis or reflection axis of a polarization conversion and separation plate, and a prism sheet comprised of a plurality of rows of prisms having a light deflection function is arranged parallelly in the same direction of said linear light source or said row of point light sources, such that the vertex of the vertex angle of said prism can be extended.

23. The backlight optical system of claims 1, 2, 3, 4 or 5, wherein said polarizer includes a protective plate disposed on the surface of said LCD panel and in a direction intersecting the direction of the light at an anisotropic diffused surface, such that the vertex of the vertex angle of a prism of said plurality of rows of prisms having a light deflection function can be extended.

24. The backlight optical system of claims 1, 2, 3, 4 or 5, wherein said backlight optical system starts lighting up a scroll portion at the time when said scan line (or gate electrode) of said LCD panel is off, and emits light from a backlight area corresponding to the position of said scan line after a liquid crystal response delay time, and uses a substrate unit to light up a unit of said light emitting optical system of said linear light source or said row of point light sources, and then writes in new data into a pixel of said LCD panel when said scan line (or gate electrode) at the same position is on again, and after the scan line is off and said liquid crystal response delay time starting from the time of disconnecting said linear light source or said row of point light sources of said backlight at a position corresponding to said scan line, a light is reflected from a backlight area at a position corresponding to said scan line again for using said basic unit to light up a unit of said light emitting optical system of said linear light source or said row of point light sources.

25. The backlight optical system of claims 1, 2, 3, 4 or 5, wherein said backlight optical system lights up a scroll portion at the time by selecting a color from the three primary colors (R, G, B) in said linear light source or said row of point light sources, such that if a scan line (or gate electrode) of said LCD panel is on, new data will be written into a pixel of said LCD panel, and if said scan line is off for a liquid crystal response delay time, a light of the selected color will be reflected from a backlight area at the position corresponding to said scan line, and said basic unit partially and selectively lights up a unit of said light emitting optical system of said linear light source or row of point light sources with three primary colors (R, G, B), and then if said scan line (or gate electrode) at the same position is on again, new data will be written into a pixel of said LCD panel, and after said scan line is off for turning off a light with the selected color reflecting from a backlight area at a position corresponding to said scan line, said basic unit partially and selectively turns off a unit of said light emitting optical system of said linear light source or said row of point light sources having the three primary colors (R, G, B); and after a liquid crystal response delay time starting from the time when said scan line is off, a color other than the previously selected color from said linear light source or said row of point light sources having the three primary colors (R, G, B) at a position corresponding to said scan line is selected, and reflected from a backlight area at a position corresponding to said scan line, and said basic unit partially and selectively lights up a unit of said light emitting optical system of said linear light source or said row of point light sources having the three primary colors (R, G, B); and the foregoing operations are performed repeatedly to emit different lights in the three primary colors (R, G, B) sequentially.

26. A prism sheet, applied in a backlight of a liquid crystal display apparatus and having a plurality of different prisms having a light deflection function, characterized in that: said prisms with a vertex angle Θ ranging from 60 degrees to 70 degrees and the vertex angle of isosceles triangular prism being divided into two divided angles Θa, Θb, such that |Θa−Θb|=0 degree; and said isosceles triangular prisms with a vertex angle ranging from 80 degrees to 110 degrees are installed alternately; and the vertex of the vertex angle ranging from 80 degrees to 110 degrees range of said isosceles triangular prism is lower than the vertex of other prisms.

27. A prism sheet, applied for a backlight of a liquid crystal display apparatus and comprising a plurality of different prisms arranged in parallel with each other and having a light deflection function, characterized in that: a prism having a vertex angle Θ falling within a range from 50 degrees to 55 degrees, and a prisms having a vertex angle divided into two divided angles Θa, Θb such that the absolute value of the difference of said divided angles of said isosceles triangular prism falls within a range from 15 degrees to 30 degrees range are arranged alternately; and the vertex angle Θ of said isosceles triangular prism falls within a range from 80 degrees to 110 degrees range; and the vertex of the vertex angle ranging from 80 degrees to 110 degrees of said isosceles triangular prism is lower than the vertex of the vertex angle of other prisms.

28. The prism sheet of claims 26 or 27, further comprising an anisotropic diffusion function implemented on the backside of a surface of a row of prisms having different vertex angles for diffusing a light in an orthogonal direction extended from the vertex of said vertex angle of said row of prisms.

29. The backlight optical system of claims 1, 2, 3, 4 or 5, wherein said row of point light sources is comprised of LEDs of a white light or three primary color (R, G, B) lights, and the aspect ratio of a light emitting portion of said LED is over 1:3, and the lengthwise direction of said light emitting portion of said LED is parallel to the lengthwise direction (or x-axis direction) of said semi-cylindrical lens.

30. A prism sheet, applied for a backlight of a liquid crystal display apparatus and comprising a plurality of prisms arranged in parallel with each other and having a light deflection function, characterized in that: a plurality of polygonal prisms having a light deflection function are arranged in parallel with each other, characterized in that: a plurality of pentagonal prisms are arranged in parallel with each other and the vertex angle Θ of said prism ranges from 60 degrees to 70 degrees, and the vertex angle of said prism is divided into two divided angles Θa, Θb and |Θa−Θb|=0, and an angle of an oblique plane in contact with a surface of a substrate film falls within a range from 35 degrees to 50 degrees.

31. A prism sheet, applied for a backlight of a liquid crystal display apparatus and comprising a plurality of polygonal prisms arranged in parallel with each other and having a light deflection function, characterized in that: said plurality of polygonal prisms are arranged in parallel with each other and have a vertex angle Θ falling within a range from 50 degrees to 55 degrees, and the absolute value of the difference of said divided angles Θa, Θb of said isosceles triangular prism falls within a range from 15 degrees to 30 degrees, and an angle of an oblique plane in contact with a surface of said substrate film falls within a range from 35 degrees to 50 degrees.

32. The prism sheet of claims 30 or 31, wherein an anisotropic diffusion function implemented on the backside of a prism on a surface having a plurality of pentagonal prisms, for diffusing a light in an orthogonal direction extended from the vertex of the vertex angle of said prism.

33. A field order driving method active matrix liquid crystal display apparatus, characterized in that: within one 1H period (or a horizontal scan period), a data line (or a video signal line) is alternated by ½H time, and the time is divided and sent to two different color data of the three primary colors (R, G, B) of a gate electrode line (or a scan line), such that two separate rows of ½V gate electrode lines can be operated in the vertical direction (V-direction) of a screen, and the timing is alternated in ½H to turn off each gate electrode line, and write in signal data of each different color signal data on said two different rows of ½V pixels; and said operation of writing data is performed from the top to the bottom of said screen or from the bottom to the top of said screen, and the time is divided and written sequentially into the color data of the three primary colors (R, G, B) for a display, and a color signal having two or more different colors is written into a field or a signal frame of said display screen.

34. A field order driving method active matrix liquid crystal display apparatus, characterized in that: within one 1H (or horizontal scan) period, a data line (or a video signal line) is alternated by ⅓H time, and the time is divided and sent to three different color data of the three primary colors (R, G, B) of a gate electrode line (or a scan line), such that three separate rows of ⅓V gate electrode lines can be operated in the vertical direction (V-direction) of a screen, and the timing is alternated in ⅓H to turn off each gate electrode line, and write in signal data of each different color signal data on said three different rows of ⅓V pixels; and said operation of writing data is performed from the top to the bottom of said screen or from the bottom to the top of said screen, and the time is divided and written sequentially into the color data of the three primary colors (R, G, B) for a display, and a color signal having two or more different colors is written into a field or a signal frame of said display screen.

35. A field order driving method active matrix liquid crystal display apparatus, characterized in that: a row of data lines connected to each external driving circuit and the top of a screen area is divided into top and bottom in order to divide a whole display screen into upper and lower screens, and the timing is divided into ½H from a data line within 1H (or a horizontal scan) period, and the timing is divided and sent to two different color data of three primary colors (R, G, B) and said gate electrode line, and the vertical direction (or V-direction) of said screen drives said two separate ¼V rows of gate electrode lines to operate and alternate the timing of ½H to turn off each gate electrode line, and write each color signal data with two different colors into two separate rows of ¼V pixels; and said operation is performed repeatedly from the top of said screen towards the center of said screen, or from the center of said screen towards the top of said screen sequentially, while a screen area at the bottom of said screen is alternated by ½H within said 1H (or horizontal scan) period from a data line, and divided into a top screen area with the same color series, and said timing is divided and sent to said top screen area for selecting a different signal data from the colors of the same system and said gate electrode line, so that the vertical direction (V-direction) of said screen drives two separate rows of ¼V gate electrode lines to select a gate electrode line from said top area of said screen, and uses a horizontal center line of said screen for operating two different gate electrode lines at positions along a linear symmetric axis, and the timing is alternated into ½H to turn off said each gate electrode line, and writing color signal data of the same system selected from said screen area into two separate rows of ¼V pixels; and said operation is performed repeatedly from the bottom of said screen towards the center of said screen or from the center of said screen towards the bottom of said screen and said pixel area at the top of said screen sequentially for performing said operation synchronously.

36. A field order driving method active matrix liquid crystal display apparatus, characterized in that: a row of data lines is divided into top and bottom in order to divide a whole display screen into upper and lower screens, and connected to each external driving circuit, and the top of a pixel area alternates the timing of a data line into ⅓H within one H (or a horizontal scan) period, and the timing is divided and sent to three different color data of three different colors and said gate electrode line, and the vertical direction (or V-direction) of said screen drives said three separate rows of ⅙V gate electrode lines to operate and alternate the timing of ⅓H to turn off said each gate electrode line, and write in each color signal data of three different colors to three separate rows of ⅙V pixels; and said operation is performed repeatedly from the top of said screen to the center of said screen, while a screen area at the bottom of said screen is alternated by ⅓H in said 1H (or horizontal scan) period from a data line and divided into a top screen area with the same color series, and said time is divided and sent to said top screen area for selecting a different signal data from the colors of a same system and said gate electrode line, so that the vertical direction (V-direction) of said screen drives three separate rows of ⅙V gate electrode lines to select a gate electrode line from said top area of said screen, and uses a horizontal center line of said screen for operating said three different gate electrode lines at the positions on a linear symmetric axis, and the timing is alternated into ⅓H to turn off said each gate electrode line and write color signal data of the same system selected from said screen area to three separate rows of ⅙V pixels; and said operation is performed repeatedly from the bottom of said screen towards the center of said screen sequentially, and said pixel area at the top of said screen performs said operation in a sequence synchronously.

37. (canceled)

38. The field order driving method active matrix liquid crystal display apparatus, characterized in that: a row of data lines connected to each external driving circuit and the top of a screen area is divided into top and bottom in order to divide a whole display screen into upper and lower screens, and the timing is divided into ½H from a data line within 1H (or a horizontal scan) period, and the timing is divided and sent to two different color data of three primary colors (R, G, B) and said gate electrode line, and the vertical direction (or V-direction) of said screen drives said two separate ¼V rows of gate electrode lines to operate and alternate the timing of ½H to turn off each gate electrode line, and write each color signal data with two different colors into two separate rows of ¼V pixels; and said operation is performed repeatedly from the top of said screen towards the center of said screen, or from the center of said screen towards the top of said screen sequentially, while a screen area at the bottom of said screen is alternated by ½H within said 1H (or horizontal scan) period from a data line, and divided into a top screen area with the same color series, and said timing is divided and sent to said top screen area for selecting a different signal data from the colors of the same system and said gate electrode line, so that the vertical direction (V-direction) of said screen drives two separate rows of ¼V gate electrode lines to select a gate electrode line from said top area of said screen, and uses a horizontal center line of said screen for operating two different gate electrode lines at positions along a linear symmetric axis, and the timing is alternated into ½H to turn off said each gate electrode line, and writing color signal data of the same system selected from said screen area into two separate rows of ¼V pixels; and said operation is performed repeatedly from the bottom of said screen towards the center of said screen or from the center of said screen towards the bottom of said screen and said pixel area at the top of said screen sequentially for performing said operation synchronously, wherein said backlight plane light source of said liquid crystal display apparatus uses an optical system of claims 1, 2, 3, 4 or 5 for producing strip lights, and only one basic unit of said optical system is disposed at a position corresponding to the center of liquid crystal display screen for producing said strip lights, such that a light at an optical axis (or z-axis) of said basic unit of said optical system for producing said strip lights is polarized by said prism sheet having a light deflection function, and reflected vertically towards the center of a screen of said liquid crystal display apparatus.

39. A field order driving method active matrix liquid crystal display apparatus, characterized in that: a row of data lines is divided into top and bottom in order to divide a whole display screen into upper and lower screens, and connected to each external driving circuit, and the top of a pixel area alternates the timing of a data line into ⅓H within one H (or a horizontal scan) period, and the timing is divided and sent to three different color data of three different colors and said gate electrode line, and the vertical direction (or V-direction) of said screen drives said three separate rows of ⅙V gate electrode lines to operate and alternate the timing of ⅓H to turn off said each gate electrode line, and write in each color signal data of three different colors to three separate rows of ⅙V pixels; and said operation is performed repeatedly from the top of said screen to the center of said screen, while a screen area at the bottom of said screen is alternated by ⅓H in said 1H (or horizontal scan) period from a data line and divided into a top screen area with the same color series, and said time is divided and sent to said top screen area for selecting a different signal data from the colors of a same system and said gate electrode line, so that the vertical direction (V-direction) of said screen drives three separate rows of ⅙V gate electrode lines to select a gate electrode line from said top area of said screen, and uses a horizontal center line of said screen for operating said three different gate electrode lines at the positions on a linear symmetric axis, and the timing is alternated into ⅓H to turn off said each gate electrode line and write color signal data of the same system selected from said screen area to three separate rows of ⅙V pixels; and said operation is performed repeatedly from the bottom of said screen towards the center of said screen sequentially, and said pixel area at the top of said screen performs said operation in a sequence synchronously, wherein said backlight plane light source of said liquid crystal display apparatus uses an optical system of claims 1, 2, 3, 4 or 5 for producing strip lights, and only one basic unit of said optical system is disposed at a position corresponding to the center of liquid crystal display screen for producing said strip lights, such that a light at an optical axis (or z-axis) of said basic unit of said optical system for producing said strip lights is polarized by said prism sheet having a light deflection function, and reflected vertically towards the center of a screen of said liquid crystal display apparatus.
